(19) United States
(12) Patent Application Publication
(10) Pub. No.: US 2022/0147962 A1
(43) Pub. Date: May 12, 2022

(54) ARTICLE HOUSING SYSTEM FOR MANAGING ARTICLE HOUSED IN STORAGE BODY

(71) Applicant: Nomura Research Institute, Ltd., Tokyo (JP)

(72) Inventors: Takumi GOMPEI, Tokyo (JP); Hiroyoshi TAKAHASHI, Tokyo (JP); Jun EIJIMA, Tokyo (JP); Daiki IHARA, Tokyo (JP); Eiji GOTO, Tokyo (JP)

(21) Appl. No.: 17/221,459

(22) Filed: Apr. 2, 2021

Related U.S. Application Data
(63) Continuation of application No. PCT/JP2021/003629, filed on Feb. 2, 2021.

(30) Foreign Application Priority Data
Nov. 10, 2020 (JP) 2020-187038

(51) Int. Cl. G06Q 20/18; G06K 7/14

(52) U.S. Cl. CPC G06Q 20/18; G06K 7/1413

(57) ABSTRACT

To simply promote a commodity transaction by a transaction of an article, an article housing system includes a storage body that houses articles and an information processing device that is connected to the storage body, in which the storage body includes a notification unit that notifies the information processing device of link information of an article collected by a user and the user, and the information processing device includes a recording unit that records that the user picks up the article on the link information, and a settlement unit that executes settlement processing of allowing a payer linked with the user to pay for the article.

### TECHNICAL FIELD

The present invention relates to a technique for managing housing of articles.

### BACKGROUND ART

In order to deliver articles such as commodities and luggage to a specific user, a method for allowing the user to go to a storage location such as a store or an agency to receive the articles, or a method for allowing a trader to deliver articles to home or work is used.

### CITATION LIST

### Patent Literature

Patent Literature 1: WO 2018/042668 A
Patent Literature 2: JP 2011-022791 A

### SUMMARY OF INVENTION

### Technical Problem

However, it requires great effort for a user to go to the storage location. In addition, the method of delivering articles to home or work also places a heavy burden on traders.

The present invention is an invention completed based on the above-mentioned problem recognition, and a main purpose of the present invention is to simply deliver articles.

### Solution to Problem

According to an aspect of the present invention, an article housing system includes a storage body that houses articles and an information processing device that is connected to the storage body, in which the storage body includes a notification unit that notifies the information processing device of link information of an article collected by a user and the user who has collected the article, and the information processing device includes a recording unit that records that the user collects the article from the storage body based on the link information and a settlement unit that executes settlement processing of allowing a payer linked with the user to pay for the article.

According to another aspect of the present invention, an article housing system includes a storage body that houses articles and an information processing device that is connected to the storage body, in which the storage body includes a notification unit that notifies the information processing device of link information of an article collected by a user and the user who has collected the article, the information processing device includes a recording unit that records that the user collects the article from the storage body based on the link information, and the storage body further includes a lighting device that separately illuminates the housed articles.

According to another aspect of the present invention, an article housing system includes a stationary storage body that houses articles, a mobile storage body that houses articles, and an information processing device that is connected to the stationary storage body and the mobile storage body, in which the stationary storage body and the mobile storage body include a notification unit that notifies the information processing device of link information of an article collected by a user and the user who has collected the article, and the information processing device includes a recording unit that records that the user collects the article from the stationary storage body and collects the article from the mobile storage body based on the link information, and an inventory management unit that manages an inventory of the articles housed in the stationary storage body and an inventory of the articles housed in the mobile storage body.

According to another aspect of the present invention, an article housing system includes a storage body that houses articles and an information processing device that is connected to the storage body, in which the storage body includes a notification unit that notifies the information processing device of link information of an article collected by a user and the user who has collected the article, and the information processing device includes a recording unit that records that the user collects the article from the storage body based on the link information, and a rental management unit that manages rental of an article housing space of the storage body.

### Advantageous Effects of Invention

According to the present invention, the article can be simply delivered.

### BRIEF DESCRIPTION OF DRAWINGS

FIG. 1 is a configuration diagram of a storage device.

FIG. 2 is a diagram illustrating an example of a captured image of the storage device.

FIG. 3 is a functional block diagram of a computer included in the storage device.

FIG. 4 is a flowchart illustrating an operation process of the storage device.

FIG. 5 is an arrangement diagram of the storage device.

FIG. 6 is a network configuration diagram.

FIG. 7 is a schematic diagram illustrating a pre-purchase method of an in-storage commodity.

FIG. 8 is a functional block diagram of a user terminal.

FIG. 9 is a functional block diagram of a server.

FIG. 10 is a diagram illustrating an example of a storage arrangement screen.

FIG. 11 is a diagram illustrating an example of a storage confirmation screen.

FIG. 12 is a diagram illustrating an example of a commodity purchase screen.

FIG. 13 is a diagram illustrating an example of a route navigation screen.

FIG. 14 is a data structure diagram of an in-storage commodity list.

FIG. 15 is a data structure diagram of a ticket table.

FIG. 16 is a data structure diagram of a sales table.

FIG. 17 is a functional block diagram of a clerk terminal.

FIG. 18 is a sequence diagram when a clerk stores a commodity in the storage device.

FIG. 19 is a sequence diagram when a user accesses a site of a server from a user terminal and purchases the commodity present in the storage device.

FIG. 20 is a sequence diagram when a user accesses the site of the server from the user terminal and purchases the commodity present in the storage device.

FIG. 21 is a sequence diagram when a user takes out the purchased commodity from the storage device.

FIG. 22 is a schematic diagram illustrating a reservation purchase method of the in-storage commodity.

FIG. 23 is a schematic diagram illustrating an arbitrary purchase method of the in-storage commodity.

FIG. 24 is an arrangement diagram of the storage device.

FIG. 25 is a schematic diagram illustrating a pre-purchase method of a store inventory commodity.

FIG. 26 is a functional block diagram of a store terminal.

FIG. 27 is a sequence diagram when a user accesses the site of the server from the user terminal and purchases the commodity in the store.

FIG. 28 is a schematic diagram illustrating the reservation purchase method of the store inventory commodity.

FIG. 29 is a schematic diagram illustrating a pre-settlement method using a paper ticket.

FIG. 30 is a functional block diagram of a cash register.

FIG. 31 is a sequence diagram of an exchange at the cash register.

FIG. 32 is a sequence diagram of a take-out of a commodity.

FIG. 33 is a schematic diagram illustrating a post-settlement method using a paper ticket.

FIG. 34 is a sequence diagram of an issuance of the paper ticket.

FIG. 35 is a sequence diagram of a take-out and a settlement of a commodity.

FIG. 36 is a schematic diagram illustrating a reservation purchase method of a store commodity.

FIG. 37 is a sequence diagram when a user accesses the site of the server from the user terminal and reserves the commodity (hot snack) in the store.

FIG. 38 is a sequence diagram when a user takes out the purchased commodity from the storage device.

FIG. 39 is a schematic diagram illustrating a pre-purchase method of a store commodity.

FIG. 40A is a diagram illustrating an example of a portal screen. FIG. 40B is a diagram illustrating an example of a payment amount setting screen. FIG. 40C is a diagram illustrating an example of a payment amount setting notification.

FIG. 41 is a data structure diagram of a payment amount setting table.

FIG. 42 is a flowchart illustrating a process of settlement processing.

FIG. 43A is a diagram illustrating an example of a portal screen. FIG. 43B is a diagram illustrating an example of a purchase record screen. FIG. 43C is a diagram illustrating an example of a payment request notification. FIG. 43D is a diagram illustrating an example of a payment approval/disapproval screen.

FIG. 44 is a data structure diagram of a sales table.

FIG. 45 is a flowchart illustrating the process of settlement processing.

FIG. 46A is a diagram illustrating an example of a portal screen. FIG. 46B is a diagram illustrating an example of the purchase record screen. FIG. 46C is a diagram illustrating an example of a recommended payment notification. FIG. 46D is a diagram illustrating an example of a recommended payment guidance screen.

FIG. 47 is a data structure diagram of a recommended payment table.

FIG. 48 is a flowchart illustrating the process of settlement processing.

FIG. 49 is a configuration diagram of a shelf of the storage device.

FIG. 50 is a data structure diagram of a commodity arrangement table.

FIG. 51 is a sequence diagram including a step of transmitting a purchased commodity ID from a server to a storage device.

FIG. 52 is a data structure diagram of a ticket list in Modification 13.

FIG. 53 is a flowchart illustrating an operation process of a storage device in the Modification 13.

FIG. 54 is a configuration diagram of a storage-equipped vehicle in Modification 14.

FIG. 55A is a diagram illustrating a state in which a vehicle stops and a commodity is delivered. FIG. 55B is a diagram illustrating a state in which a commodity is supplied to a stationary storage device. FIG. 55C is a diagram illustrating a state in which a commodity is moved between the stationary storage devices.

FIG. 56A is a diagram illustrating a reservation application screen of a rental shelf. FIG. 56B is a data structure diagram of a rental shelf reservation table.

FIG. 57 is diagram illustrating a use application screen of a rental area.

FIG. 58 is a data structure diagram of a use history of the rental area.

### DESCRIPTION OF EMBODIMENTS

In this embodiment, a storage device is used for delivery of commodities. The storage device has substantially the same size as a vending machine, a refrigerator, or the like, and therefore, can be installed in a narrow space.

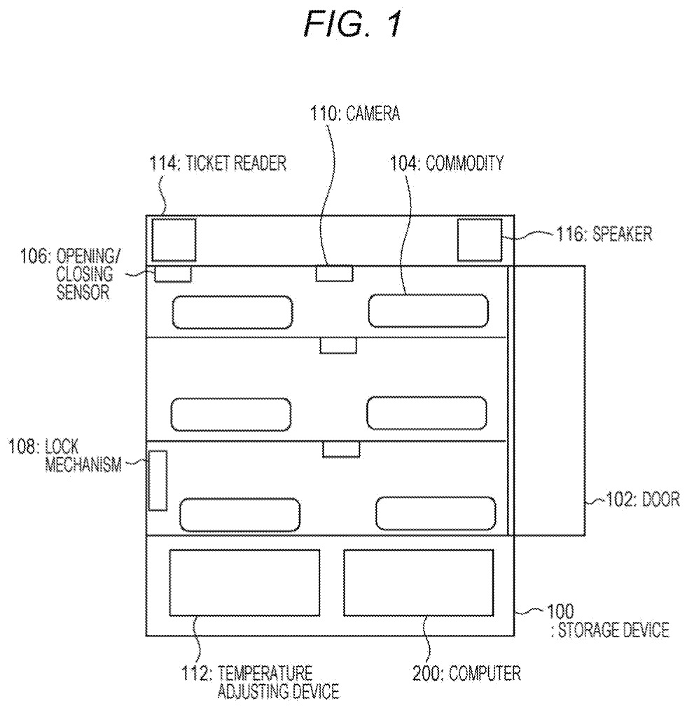

FIG. 1 is a configuration diagram of a storage device 100.

The storage device 100 is equipped with a hinged door 102, and accommodates a commodity 104 in a multi-stage shelf. The opened/closed state of the door 102 is detected by an opening/closing sensor 106. Further, the door 102 is locked by a lock mechanism 108. The commodity 104 installed on the shelf photographed by a camera 110. The housed commodity 104 identified by the captured image. The storage device 100 is equipped with a temperature adjusting device 112, and can adjust the internal temperature and humidity. In addition, the storage device 100 includes a ticket reader 114. The ticket leader 114 reads an electronic ticket presented by an operator. The electronic ticket is a graphic code such as a QR code (registered trademarks) or a barcode, a contact/contactless IC card, or the like. In the following, it is assumed that the electronic ticket is the QR code. The storage device 100 is connected to a server via the network and communicates with the server. In addition, the storage device 100 is equipped with a speaker 116 that emits operation guidance, a warning message, and a warning sound.

The storage device 100 stores a list of electronic tickets granted to an operator who is authorized to use the storage device 100, and controls to unlock and open the door 102 when the electronic ticket read by the ticket reader 114 matches any of the electronic tickets included in the ticket list. There are two types of electronic tickets, one that is allowed to be used only once, and the other that can be used repeatedly several times. Further, the storage device 100 has a computer 200 for control.

Note that the type, number, position, arrangement, additional function, and the like of the camera 110 can be appropriately set. As the additional function, a sensor (improving recognition accuracy after adding weight by a weight sensor) for improving accuracy or the like can be appropriately adopted. In addition, the camera includes a camera that can photograph not only a still image but also a moving image.

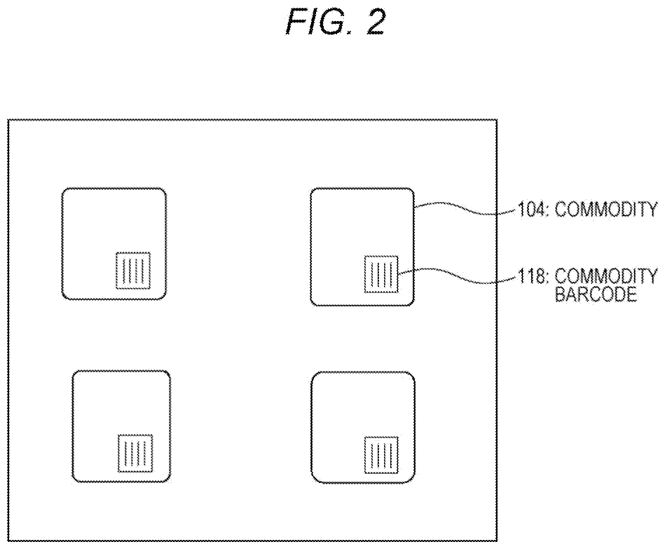

FIG. 2 is a diagram illustrating an example of the captured image of the storage device 100.

A label on which a commodity barcode 118 is printed is affixed to the surface of the commodity 104. By reading the commodity barcode 118 from the captured image, the housed commodity 104 can be identified. The commodity 104 in this example is assumed to be lunch boxes, sandwiches, side dish packs such as salads, beverages. However, the commodity 104 may be a type other than these.

Note that in this embodiment, the description will proceed on the premise that the commodity 104 is identified by the commodity barcode 118, but in the present invention, the commodity barcode 118 is not essential, and it may be possible to identify the housed commodity 104 by directly reading the shape of the commodity 104 from the captured image, and the like.

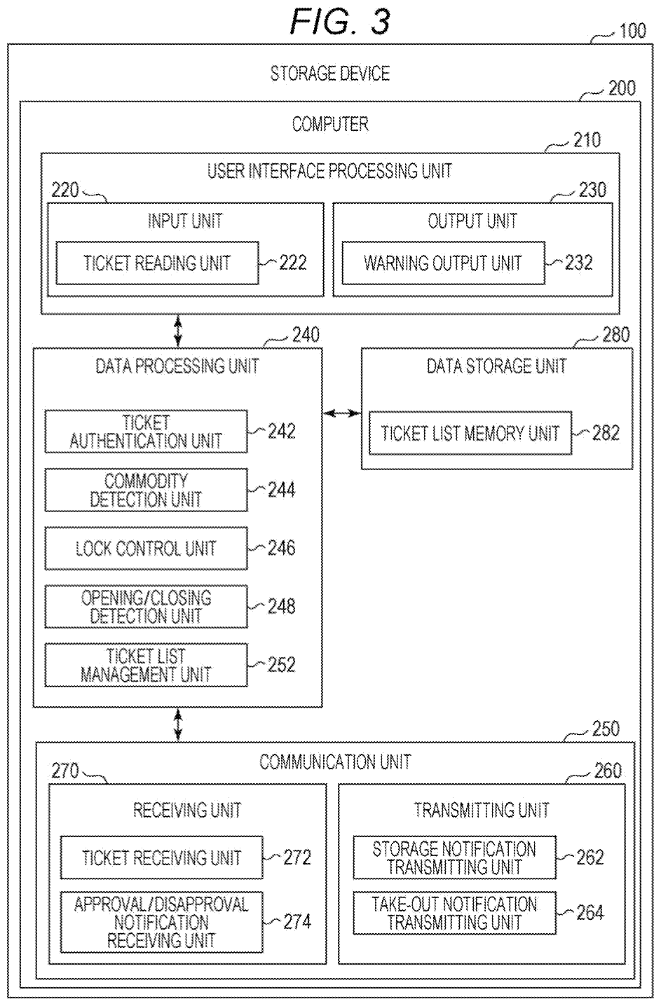

FIG. 3 is a functional block diagram of a computer 200 included in the storage device 100.

Each component of the computer 200 is implemented by hardware including an arithmetic unit such as a central processing unit (CPU) and various coprocessors, a memory device such as memory or storage, and a wired or wireless communication line connecting therebetween, and software that is stored in the memory device and supplies processing commands to the arithmetic unit. A computer program may be composed of a device driver, an operating system, various application programs located on upper layers thereof, and a library that provides common functions to these programs. Each of the illustrated blocks illustrates a block in a functional unit, not a configuration in a software unit. The same applies to a user terminal, a server, a clerk terminal, a store terminal, and a cash register to be described later.

The computer 200 includes a user interface processing unit 210, a data processing unit 240, a communication unit 250, and a data storage unit 280. The user interface processing unit 210 is in charge of user interface processing via the ticket reader 114, the speaker 116, or the like. The communication unit 250 is in charge of communication processing via a network. The data storage unit 280 stores various data. The data processing unit 240 executes various processing based on data acquired by the communication unit 250 and data stored in the data storage unit 280. The data processing unit 240 also functions as an interface for the user interface processing unit 210, the communication unit 250, and the data storage unit 280.

The user interface processing unit 210 includes an input unit 220 that receives an operation input by an operator and an output unit 230 that presents information to the operator.

The input unit 220 includes a ticket reading unit 222 that reads a ticket. The output unit 230 includes a warning output unit 232 that outputs a warning message or a warning sound from the speaker 116. Note that the operator mentioned herein corresponds to a user who purchases commodities or a store clerk who manages the storage device 100 in the example described later.

The data processing unit 240 includes a ticket authentication unit 242, a commodity detection unit 244, a lock control unit 246, an opening/closing detection unit 248, and a ticket list management unit 252. The ticket authentication unit 242 authenticates the read electronic ticket. The commodity detection unit 244 detects the commodity 104 stored or taken out during the opening/closing of the door 102. Specifically, it is determined that the commodity 104 that increases when the door 102 is closed is the stored commodity 104, and the commodity 104 that also decreases is the taken-out commodity 104. The lock control unit 246 controls the lock mechanism 108. The opening/closing detection unit 248 detects the opening/closing of the door 102 of the storage device 100 by using the opening/closing sensor 106. The ticket list management unit 252 manages the ticket list.

The communication unit 250 includes a transmitting unit 260 that transmits data and a receiving unit 270 that receives data.

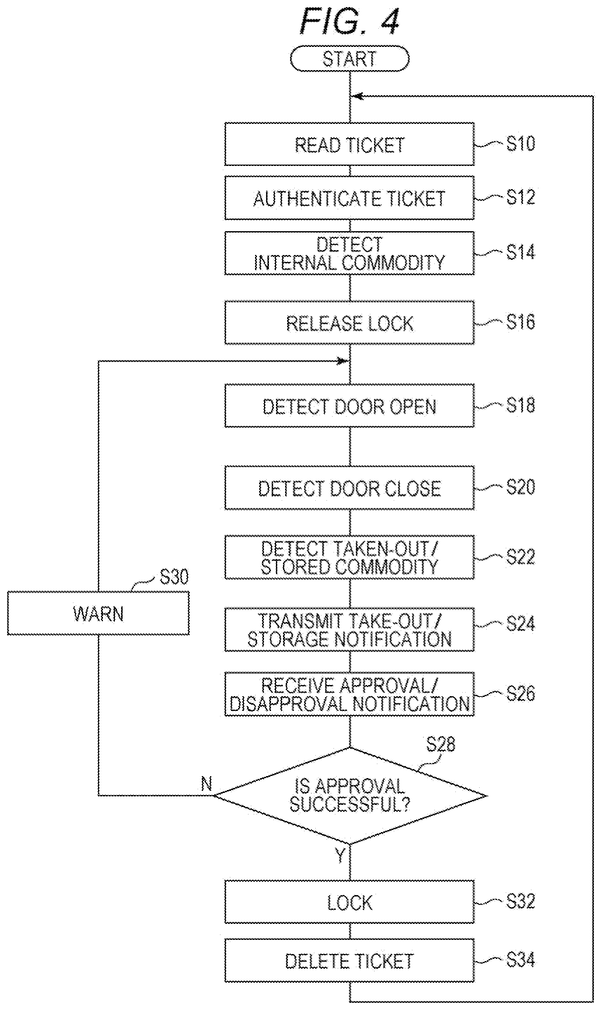

The transmitting unit 260 includes a storage notification transmitting unit 262 and a take-out notification transmitting unit 264 (e.g., a notification unit). The storage notification transmitting unit 262 transmits a storage notification. The storage notification will be described later in relation to FIG. 4. The take-out notification transmitting unit 264 transmits a take-out notification. The take-out notification will be described later in relation to FIG. 4. The receiving unit 270 includes a ticket receiving unit 272 and an approval/disapproval notification receiving unit 274. The ticket receiving unit 272 receives an electronic ticket. The approval/disapproval notification receiving unit 274 receives an approval/disapproval notification. The approval/disapproval notification will be described later with reference to FIG. 4.

The data storage unit 280 includes a ticket list memory unit 282. The ticket list memory unit 282 stores the ticket list. The electronic ticket data received from the server is registered in the ticket list. In the case of a Modification using a paper ticket, data (hereinafter referred to as “paper ticket data”) converted into the QR code is registered in the ticket list.

FIG. 4 is a flowchart illustrating an operation process of the storage device.

When the ticket reading unit 222 detects the reading of the electronic ticket by the ticket reader 114 (S10), the ticket authentication unit 242 authenticates the read ticket (S12). If the electronic ticket read by the ticket reader 114 matches any of the electronic tickets included in the ticket list, the authentication succeeds. On the other hand, when the electronic ticket read does not match any of the electronic tickets included in the ticket list, the authentication fails. When the authentication fails, no further processing is performed. When the authentication fails, the warning output unit 232 may output a warning message or a warning sound such as “This ticket cannot be used”.

When the authentication succeeds, the commodity detection unit 244 detects the commodity 104 housed inside at this time (S14). Then, the lock control unit 246 controls the lock mechanism 108 to unlock the door 102 (S16). This allows the operator to open the door 102 of the storage device 100.

When the door 102 of the storage device 100 is opened, the opening/closing detection unit 248 uses the opening/closing sensor 106 to detect the door opening (S18). If there is a user who purchases the commodity 104, the commodity 104 is taken out from the shelf. If a clerk visits to install the commodity 104, the commodity 104 is stored in the shelf. When an operator closes the door 102 of the storage device 100, the opening/closing detection unit 248 uses the opening/closing sensor 106 to detect the door closing (S20).

The commodity detection unit 244 detects the commodity 104 housed inside when the door 102 of the storage device 100 is closed. Then, the commodity detection unit 244 calculates a difference from the commodity 104 detected in S14. When the commodity 104 is taken out from the shelf, the commodity detection unit 244 determines that the reduced commodity 104 is the taken-out commodity 104. When the commodity 104 is stored in the shelf, the commodity detection unit 244 determines that the increased commodity 104 is the stored commodity 104 (S22).

When the commodity 104 is taken out, the take-out notification transmitting unit 264 transmits a take-out notification to the server 400. The take-out notification includes the data of the commodity barcode 118 of the taken-out commodity 104 and the used electronic ticket. When the commodity 104 is stored, the storage notification transmitting unit 262 transmits a storage notification to the server 400 (S24). The storage notification includes the data of the commodity barcode 118 of the stored commodity 104 and the used electronic ticket.

When the server 400 receives the take-out notification or the storage notification from the storage device 100, the server determines whether the taken-out commodity 104 or the stored commodity 104 is valid in relation to the operator specified by the electronic ticket. If it is determined that the taken-out commodity 104 or the stored commodity 104 is valid, the notification indicating approval is transmitted to the storage device 100. If it is determined that the taken-out commodity 104 or the stored commodity 104 is not valid, the notification indicating disapproval is transmitted to the storage device 100. For example, when a clerk stores an unscheduled commodity 104, the notification indicating disapproval is transmitted. Alternatively, when the user takes out the commodity 104 that has not been purchased, the notification indicating disapproval is transmitted. The notifications indicating approval or disapproval are called an approval/disapproval notification.

The approval/disapproval notification receiving unit 274 of the storage device 100 receives the approval/disapproval notification from the server 400 (S26). If the approval/disapproval notification indicates a disapproval, the warning output unit 232 outputs a warning (S30). When the taken-out commodity 104 is not valid, for example, a warning message or a warning sound called “Take out wrong commodity. Please try again.” is emitted. When the stored commodity 104 is not valid, for example, a warning message or a warning sound called “You don't enter correct commodity. Please enter again” is emitted. Then, the processing returns to S18.

On the other hand, when the received approval/disapproval notification indicates approval, the lock control unit 246 performs locking by the lock mechanism 108 (S32). In addition, when the type of electronic ticket is allowed to be used only once, the used electronic ticket is deleted from the ticket list (S34).

In the following, an example is considered in which a user working in an office district purchases lunch boxes, sandwiches, side dish packs such as salads, or beverages at lunch time. However, when other commodities 104 for other purposes are purchased, they can be operated in the same way. An example of arranging the storage device, which is a prerequisite, will be described.

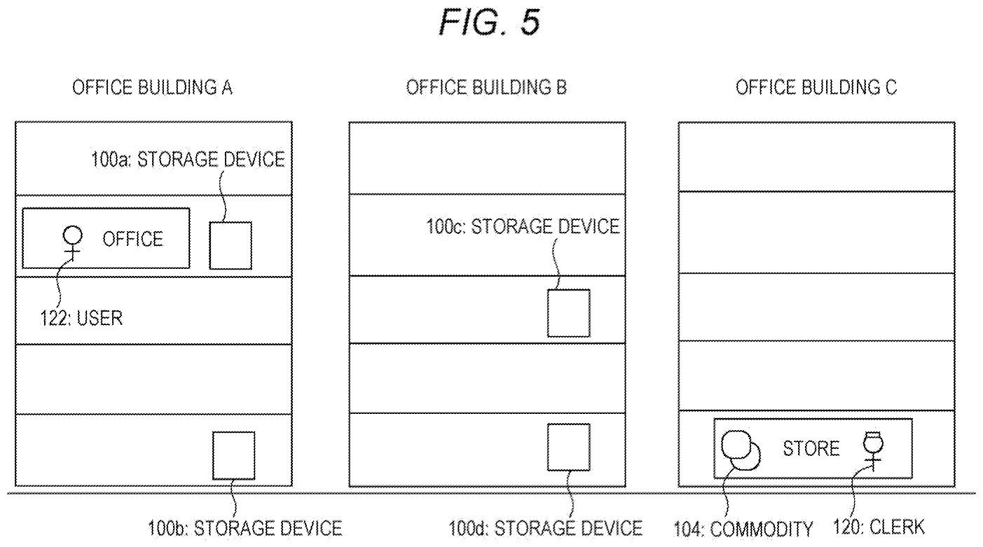

FIG. 5 is an arrangement diagram of the storage device.

A storage device 100a is installed on a fourth floor of office building A which is an office where a user 122 is working, and a storage device 100b is also installed on a first floor. In addition, a storage device 100c is installed on a third floor of office building B next to office building A, and a storage device 100d is also installed on a first floor.

Furthermore, there is a store on a first floor of office building C next to the office building B. This store sells lunch boxes, sandwiches, side dish packs such as salads, beverages, or the like. The storage devices 100a to 100d are managed by this store. That is, the commodity 104 housed in the storage devices 100a to 100d is supplied by this store. In addition to a selling area in the store, the commodity 104 can be sold even in the storage devices 100a to 100d, so the sales of the store are expected to increase. It can also be expected to eliminate unsold commodity 104

In the store, the storage devices 100a to 100d provides lunch boxes, sandwiches, side dish packs such as salads, or beverages to neighboring consumers as a target, and consumers purchase the lunch boxes, sandwiches, side dish packs, and beverages. By delivering commodities distributed in the storage devices 100a to 100d, a congestion in a store is eliminated and a purchase is performed smoothly. Note that a clerk 120 of a store patrols the storage devices 100a to 100d to replenish the commodity 104. In the following, it is assumed that the clerk 120 stores the commodity 104 in the storage devices 100a to 100d, and the user 122 purchases the housed commodity 104 in the storage devices 100a to 100d.

In this example, only one store is illustrated, but a plurality of stores may be in charge of the storage device 100 in the same way. The store may be a chain store such as a convenience store or a family restaurant, or may be a department store, a supermarket, a member's store belonging to a shopping district, a distribution center, a delivery center, or the like.

Note that the store itself may be eliminated and the commodity may be shipped directly from the manufacturer.

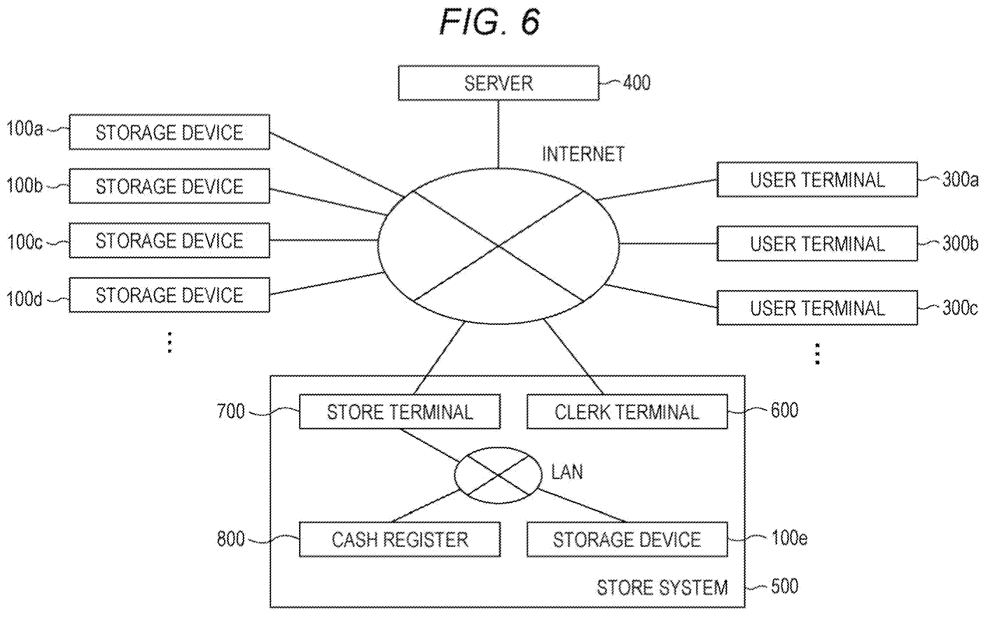

FIG. 6 is a network configuration diagram.

The storage devices 100a to 100d are connected to the server 400 via the network (for example, the Internet or a dedicated line). Further, user terminals 300a to 300c (for example, a smartphone, a mobile terminal, or a personal computer) used by the user 122 can be connected to the server 400 via the Internet. When the user terminals 300a to 300c and the like are collectively referred to, or when there is no particular distinction, they are collectively referred to as the “user terminal 300”.

The server 400 is connected to a store information system (hereinafter referred to as “store system”) via a network (for example, the Internet or a dedicated line). The store system 500 includes a clerk terminal 600 (for example, a smartphone, a mobile terminal, or a personal computer), a store terminal 700, a cash register 800, and a storage device 100e. In addition, the cash register 800 and the storage device 100e are connected to the store terminal 700 via, for example, a local area network (LAN). The cash register 800 and the storage device 100e are used in a Modification described later.

In a site of the server 400 provides information on the store, the storage device 100, and the commodity 104. The user terminal 300 has an application program that accesses the server 400 to download various data and display the data on a screen, or uploads various data input by a user operation to the server 400. That is, a negative application method of controlling the operation of the user terminal 300 with the application program of the user terminal 300 is assumed. However, a web application method of controlling the operation of the user terminal 300 with a script included in a web page may be adopted. In the web application method, the user terminal 300 performs the same processing as in the case of the native application by executing the script included in the web page in a browser.

In the present embodiment, the user 122 checks the housed commodity 104 housed in the storage devices 100a to 100d using the user terminal 300a, and purchases the favorite commodity 104 on the web. Then, later, the user 122 goes to the storage device 100a to 100d and receives the purchased commodity 104. This transaction mode called a “pre-purchase method of an in-storage commodity”.

The electronic ticket used in this embodiment is issued to the user 122 who has purchased the commodity 104. By the application program of the user terminal 300a, a function of saving the electronic ticket received from the server 400, and displaying the electronic ticket as a QR code on the display is realized.

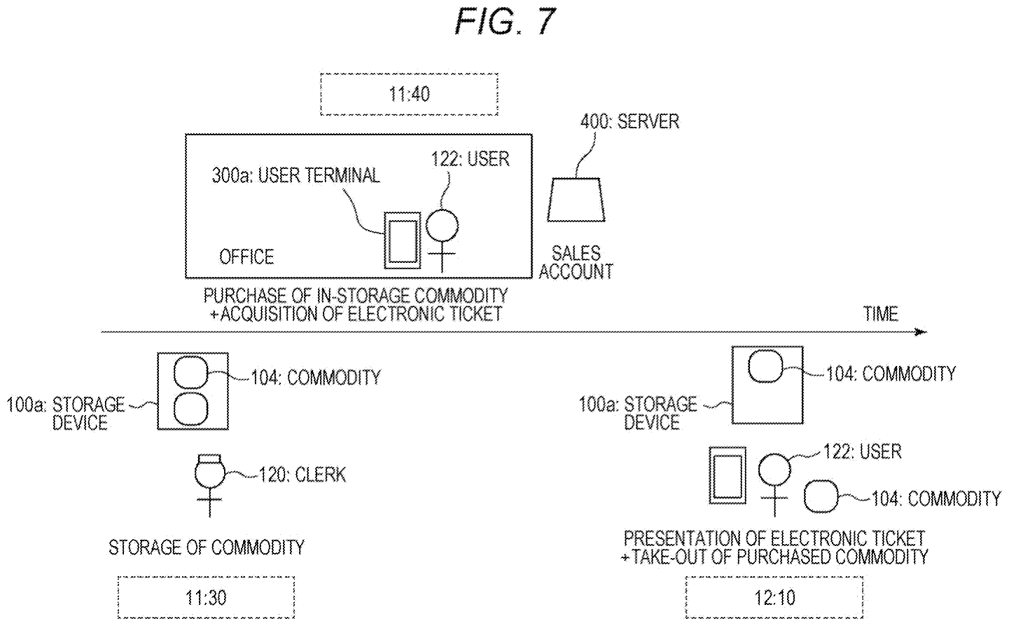

FIG. 7 is a schematic diagram illustrating a pre-purchase method of an in-storage commodity.

In this example, the clerk 120 stores the commodity 104 in the storage device 100a at 11:30 before lunch break. The commodity 104 in this example is a lunch box or the like. The stored commodity 104 is selected by the store. The information on the stored commodity 104 is notified to the server 400 and posted on the site of the server 400. As a result, the user terminal 300 can access the site of the server 400 and randomly browse the commodity 104 housed in the storage device 100a in real time.

After that, at 11:40, the user 122 browses the commodity 104 in the storage device 100a on the user terminal 300, and selects and purchases the commodity 104 he/she prefers. At this point, the transaction is established, and the server 400 counts sales. Then, the purchased commodity 104 is possessed by the user 122. However, this commodity 104 is still housed in the storage device 100a. Further, when the user 122 purchases the commodity 104, the server 400 transmits the electronic ticket to the user terminal 300. The user terminal 300 stores the received electronic ticket.

At 12:10 during the lunch break, the user 122 carries the user terminal 300 and moves to the installation location of the storage device 100a. The user 122 operates the user terminal 300 to display the QR code of the electronic ticket, and holds the QR code over the ticket reader 114 of the storage device 100a. When the ticket reader 114 reads the QR code of the electronic ticket, the door 102 is unlocked. Then, the user 122 opens the door 102 of the storage device 100a and takes out the commodity 104 that he/she purchases. When the user 122 closes the door 102 of the storage device 100a, the door 102 is locked. A warning is issued when the user 122 takes out the non-purchased commodity 104, and the user 122 takes the commodity 104 again. The electronic ticket in this example is valid only once, and thus, is deleted from the ticket list when the purchased commodity 104 is taken out. That is, the user 122 cannot open the door 102 of the storage device 100a again by using the same electronic ticket. As for payment, conventional methods such as prepaid or postpaid electronic settlement or cash payment may be used. Hereinafter, the processing in this method will be described in detail.

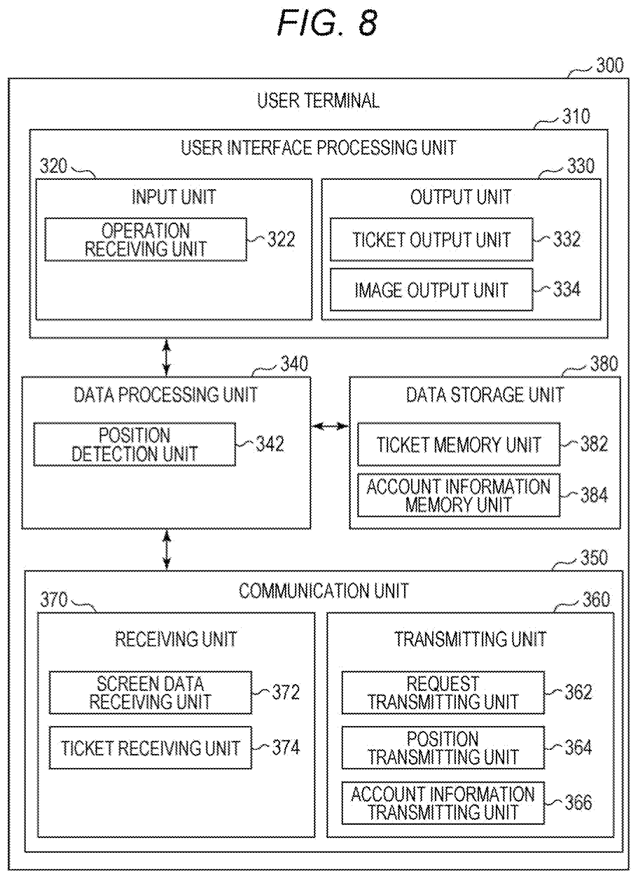

FIG. 8 is a functional block diagram of the user terminal 300.

The user terminal 300 includes a user interface processing unit 310, a data processing unit 340, a communication unit 350, and a data storage unit 380. The user interface processing unit 310 receives an operation from a user via a touch panel or the like, and is in charge of user interface processing such as image display or a voice output. The communication unit 350 is in charge of communication processing via a network. The data storage unit 380 stores various data. The data processing unit 340 executes various processing based on data acquired by the communication unit 350 and data stored in the data storage unit 380. The data processing unit 340 also functions as an interface for the user interface processing unit 310, the communication unit 350, and the data storage unit 380.

The user interface processing unit 310 includes an input unit 320 that receives an operation input by a user and an output unit 330 that presents information to the user. The input unit 320 includes an operation receiving unit 322 that receives the user operation. The output unit 330 includes a ticket output unit 332 and an image output unit 334. The ticket output unit 332 displays the electronic ticket with the QR code. The image output unit 334 displays various screens.

The data processing unit 340 includes a position detection unit 342 that detects a current position of the user terminal 300. The position detection unit 342 operates, for example, when the server 400 requests the current position.

The communication unit 350 includes a transmitting unit 360 that transmits data and a receiving unit 370 that receives data.

The transmitting unit 360 includes a request transmitting unit 362, a position transmitting unit 364, and an account information transmitting unit 366. The request transmitting unit 362 transmits various requests. The position transmitting unit 364 transmits the current position of the user terminal 300. The account information transmitting unit 366 transmits account information.

The receiving unit 370 includes a screen data receiving unit 372 and a ticket receiving unit 374. The screen data receiving unit 372 receives data or various screens. The ticket receiving unit 374 receives an electronic ticket.

The data storage unit 380 includes a ticket memory unit 382 that stores an electronic ticket provided by the server 400 and an account information memory unit 384 that stores the account information.

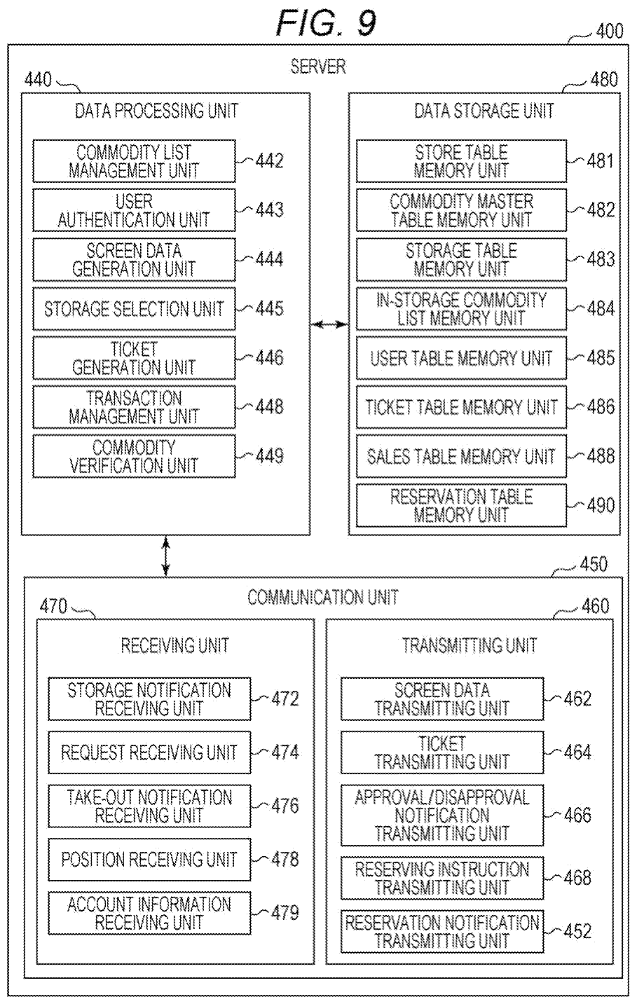

FIG. 9 is a functional block diagram of the server 400.

The server 400 includes a data processing unit 440, a communication unit 450, and a data storage unit 480. The communication unit 450 is in charge of communication processing via a network. The data storage unit 480 stores various data. The data processing unit 440 executes various processing based on data acquired by the communication unit 450 and data stored in the data storage unit 480. The data processing unit 440 also functions as an interface of the communication unit 450 and the data storage unit 480.

The data processing unit 440 includes a commodity list management unit 442, a user authentication unit 443, a screen data generation unit 444, a storage selection unit 445, a ticket generation unit 446, a transaction management unit 448 (e.g., a recording unit), and a commodity verification unit 449.

The commodity list management unit 442 manages a list (hereinafter, referred to as “in-storage commodity list”) of commodities 104 housed in the storage device 100. The user authentication unit 443 performs user authentication processing when the access is received from the user terminal 300. In the user authentication processing, an unauthorized access is excluded and a user ID is specified in an authorized access. The user authentication processing may be a conventional technique. The screen data generation unit 444 generates data of various screens displayed on the user terminal 300. The storage selection unit 445 selects the storage device 100. The ticket generation unit 446 generates an electronic ticket. Note that the ticket generation unit 446 may generate paper ticket data in a Modification described later. The transaction management unit 448 manages transactions such as sales or reservation of commodity 104. The commodity verification unit 449 determines whether the commodity 104 taken out from the storage device 100 or the commodity 104 stored in the storage device 100 is valid.

The communication unit 450 includes a transmitting unit 460 that transmits data and a receiving unit 470 that receives data.

The transmitting unit 460 includes a screen data transmitting unit 462 (e.g., a screen transmitting unit), a ticket transmitting unit 464, an approval/disapproval notification transmitting unit 466, a reserving instruction transmitting unit 468, and a reservation notification transmitting unit 452.

The screen data transmitting unit 462 transmits data of various screens displayed on the user terminal 300. The ticket transmitting unit 464 transmits an electronic ticket. The approval/disapproval notification transmitting unit 466 transmits an approval/disapproval notification. The reserving instruction transmitting unit 468 will be described in Modification 4 described later. The reservation notification transmitting unit 452 will be described in Modification 8 described later.

The receiving unit 470 includes a storage notification receiving unit 472, a request receiving unit 474, a take-out notification receiving unit 476, a position receiving unit 478, and an account information receiving unit 479.

The storage notification receiving unit 472 receives a storage notification. The request receiving unit 474 receives various requests. The take-out notification receiving unit 476 receives the take-out notification. The position receiving unit 478 receives the current position of the user terminal 300. The account information receiving unit 479 receives the account information.

The data storage unit 480 includes a store table memory unit 481, a commodity master table memory unit 482, a storage table memory unit 483, an in-storage commodity list memory unit 484, a user table memory unit 485, a ticket table memory unit 486, a sales table memory unit 488, and a reservation table memory unit 490.

The store table memory unit 481 stores a store table. The store table has records for each store. The record stores a store ID, a store name, a store location, and the like. The store ID is an identifier of a store used for information processing and does not have to be disclosed to the outside. The store name is, for example, “store in front of central station” or the like. The store location includes an address, a building name, the number of floors, a latitude and longitude, or the like.

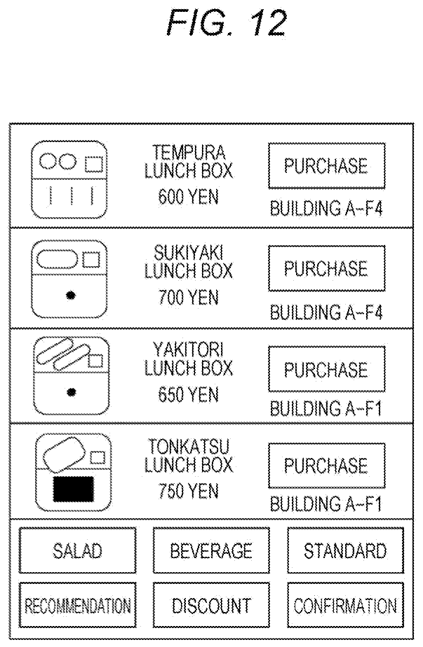

The commodity master table memory unit 482 stores a commodity master table. The commodity master table has records for each commodity 104 handled by the storage device 100. The record stores a commodity ID, a type of commodity, a commodity name, a commodity barcode 118 data, price and photo data, or the like. The commodity ID is an identifier of the commodity 104 used for information processing and does not have to be disclosed to the outside. The types of commodity include, for example, lunch boxes, salads, and beverages. The commodity name is, for example, “tempura lunch box”, “sukiyaki lunch box”, or the like. The photo data is used to include an appearance of the commodity 104 in the commodity purchase screen displayed on the user terminal 300. The commodity purchase screen will be described below with reference to FIG. 12.

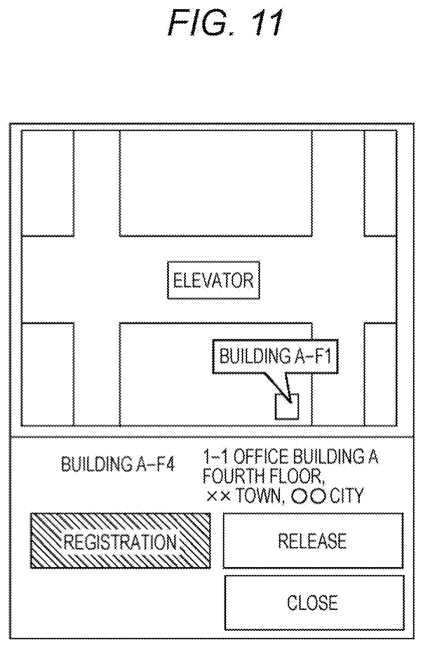

The storage table memory unit 483 stores a storage table. The storage table has records for each storage device 100. The record stores a storage ID, a storage name, an installation location, a management store ID, a floor sketch, or the like. The storage ID is an identifier of the storage device 100 used for the information processing and does not have to be disclosed to the outside. The storage name is, for example, “building A-F4”, “building A-F1”, or the like. The installation location includes an address, a building name, the number of floors, a latitude and longitude, or the like. The management store ID is the store ID of the store that manages the storage device 100. The floor sketch is included in a storage confirmation screen displayed on the user terminal 300. The floor sketch will be described below with reference to FIG. 11.

The in-storage commodity list memory unit 484 stores the in-storage commodity list. The in-storage commodity list will be described later with reference to FIG. 14.

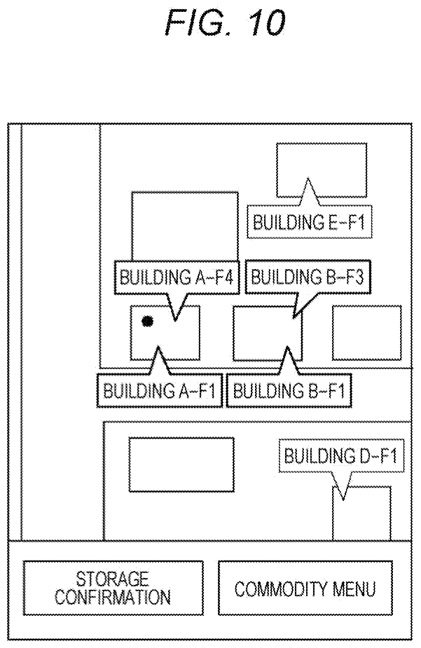

The user table memory unit 485 stores the user table. The user table has records for each pre-registered user, that is, each member. The record stores a user ID, a user name, account information, a storage device ID of the storage device 100 near a work location, a storage device ID of the storage device 100 near a home, information on electronic settlement means, and the like. The storage device 100 becomes a target of commodity introduction, assuming that a user is working. The storage device 100 near a home becomes a target of commodity introduction, assuming that a user is at home. Note that the condition that a user is assumed to be working may be a time zone or the current position of the user terminal 300. Similarly, it may be determined that the condition that a user is assumed to be at home is a time zone and a current position. The storage device 100 near a work location and the storage device 100 near a home may be operated and registered by a user. The registration of these storage devices 100 will be described below with reference to FIG. 10.

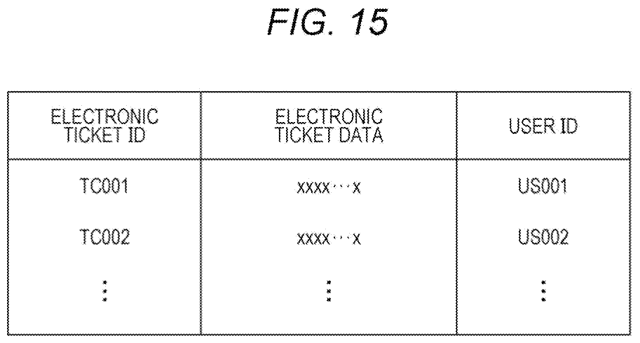

The ticket table memory unit 486 stores a ticket table. The ticket table will be described below with reference to FIG. 15.

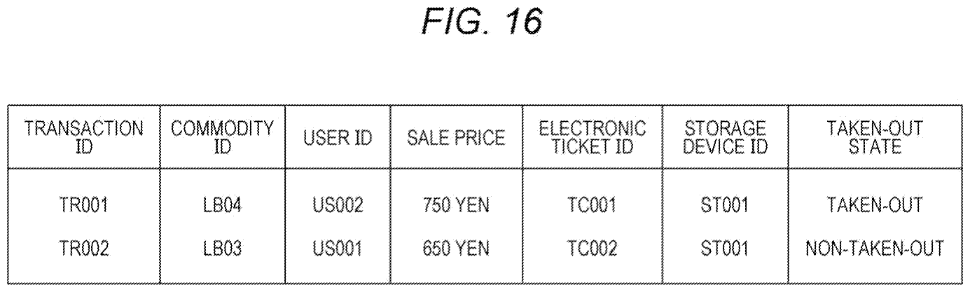

The sales table memory unit 488 stores a sales table. The sales table will be described below with reference to FIG. 16.

The reservation table memory unit 490 stores a reservation table. The reservation table will be described in Modification 1 described below.

FIG. 10 is a diagram illustrating an example of the storage arrangement screen.

When the server 400 is accessed from the user terminal 300, the storage arrangement screen is displayed. This example assumes the user is working. The installation location of the storage device 100 near the current position (black circle in the figure) is displayed on a map. In particular, the storage device 100 registered as the storage device 100 near the work location is highlighted. Then, these storage devices 100 are the targets of the commodity introduction. The storage device 100 near the work location may be set as a default within a predetermined range from the work location. When a storage confirmation button is touched, the storage confirmation screen (FIG. 11) is displayed. When a commodity menu button is touched, the commodity purchase screen (FIG. 12) is displayed.

FIG. 11 is a diagram illustrating an example of the storage confirmation screen.

The floor sketch is displayed on the storage confirmation screen. The floor sketch shows the position of the storage device 100 within the floor. The floor sketch is an example of data indicating a location within a building or a site where the storage device 100 is installed. In this example, since the storage device 100 near the work location is registered, a pattern is attached to the registration button. When the user touches a release button, the registration of the storage device 100 is released. On the contrary, if the storage device 100 near the work location is not registered, a pattern is attached to the release button, and when the registration button is touched, the storage device 100 is registered.

FIG. 12 is an example of a commodity purchase screen.

In this example, the commodity purchase screen displays the purchasable commodity 104 in the storage device 100 that becomes the target of the commodity introduction. The commodity purchase screen of FIG. 12 is displayed on the user terminal 300. Of the purchasable commodity 104, for example, a lunch box is collected and a commodity name, a price, a photo, and a storage device name thereof are displayed. In addition, a purchase button is also displayed to apply for purchase in response to the commodity 104. For example, when the user 122 touches the purchase button of the “tempura lunch box”, the user 122 purchases the “tempura lunch box” housed in the storage device 100a. The purchased commodity 104 is not displayed on the commodity purchase screen. In this example, if there is only one “tempura lunch box” from the beginning, the “tempura lunch box” is not displayed on the commodity purchase screen after the purchase of the user 122.

By touching a button that indicates another type of commodity 104, such as a salad button or a beverage button, switching to a list of the type of commodity 104 is made.

By touching the recommendation button, the combination of the recommended commodities 104 is displayed. For example, a combination of “tempura lunch box”, “radish salad” and “green tea” is displayed. The combination of the recommended commodities 104 is stored on the server 400. The combination of recommended commodities 104 may be set by the operator of the server 400 or by the store manager. The combination of commodities 104 may be determined according to the time. A total calorie of the recommended combination of commodities 104 and calories to be consumed by exercise according to the total calorie may be displayed. In addition, a distance to walk and the number of stairs to climb may be calculated and displayed based on the calories to be consumed.

By touching a standard button, switching to the list of most frequently purchased commodities 104 is made. The commodity 104 may be determined based on the individual purchase history of the user, or the commodity 104 may be determined based on the purchase history of the user group having the same user attributes (for example, gender, age, and the like). In addition, the commodity 104 may be determined based on the purchase history of all users. In addition, a purchase history or the like at unmanned stores may also be referenced.

By touching a discount button, a list of discounted commodities 104 is displayed. The server 400 may automatically set a discount according to an expiration date. A discount may be set automatically according to the number of unsold commodities. The discount may be given preferentially to users near the storage device 100. The discount may be set according to the amount of consumption by a user.

When the user touches a confirmation button, the commodity purchase screen is closed and the route navigation screen is displayed.

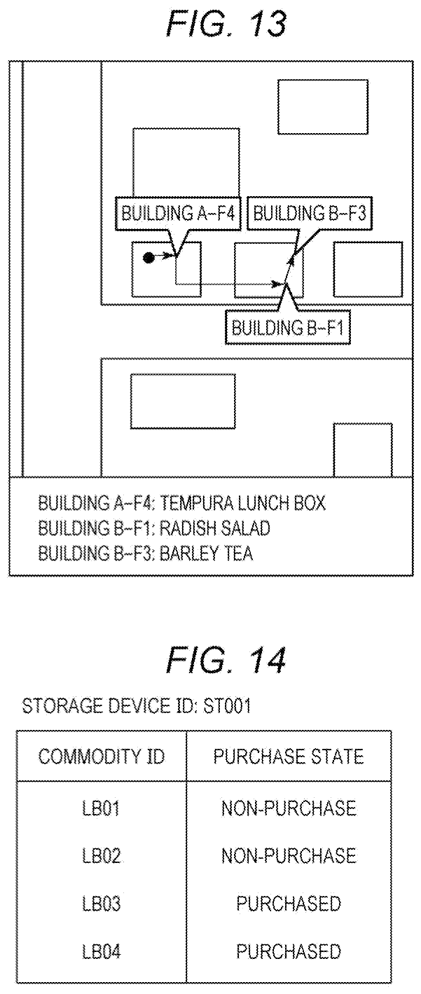

FIG. 13 is a diagram illustrating an example of a route navigation screen.

The route navigation screen displays a route connecting the storage device 100 that houses the commodities purchased by the user. A method of determining a route is not limited. A route of a shortest distance may be shown. Alternatively, the exercise may be promoted by indicating a route that is equal to or greater than a reference distance. In addition, the route may be recalculated and displayed when the pre-purchased or pre-reserved commodities are out of in the storage device 100, delivered to a closer storage device 100, or the like.

FIG. 14 is a data structure diagram of the in-storage commodity list.

The in-storage commodity list is used to grasp commodities housed in each storage device 100. The in-storage commodity list is provided for each storage device 100. The in-storage commodity list stores the commodity IDs and the purchase states of each commodity housed in the storage device 100. The purchase state indicates either non-purchased or purchased. This example shows that four types of lunch boxes with commodity IDs LB01, LB02, LB03, and LB04 are housed in storage device 100a with storage device ID ST001. It is indicated that the commodities 104 of the LB01 and LB02 are not yet purchased and thus can be currently purchased, and it is indicated that the commodities 104 of the LB03 and LB04 have been purchased and thus cannot be currently purchased.

FIG. 15 is a data structure diagram of a ticket table.

The ticket table is used to manage the electronic tickets issued by the server 400. The ticket table has records for each electronic ticket issued by the server 400. The record stores an electronic ticket ID, electronic ticket data, a user ID, and the like. The electronic ticket ID is an identifier of the electronic ticket used for information processing and does not have to be disclosed to the outside. The electronic ticket data is a unique code string that is converted into a QR code figure. The user ID identifies the user to whom this electronic ticket is granted. The electronic ticket data may include the user ID, or the data of the commodity ID or the commodity barcode of the purchased commodity 104. The electronic ticket data may be the electronic ticket ID.

FIG. 16 is a data structure diagram of a sales table.

It is a table for managing sales established by a sales transaction. The sales table has records for each sales transaction. The record stores a transaction ID, a commodity ID, a user ID, a selling price, an electronic ticket ID, a storage device ID, a take-out state, and the like. The transaction ID is assigned to each sales transaction. The commodity ID identifies the sold commodity 104. The user ID specifies the purchasing user 122. The electronic ticket ID specifies the electronic ticket used in this sale. The storage device ID specifies the storage device 100 used in this sale. The take-out state indicates whether or not the commodity 104 is taken out from the storage device 100, that is, is not taken out or is taken out.

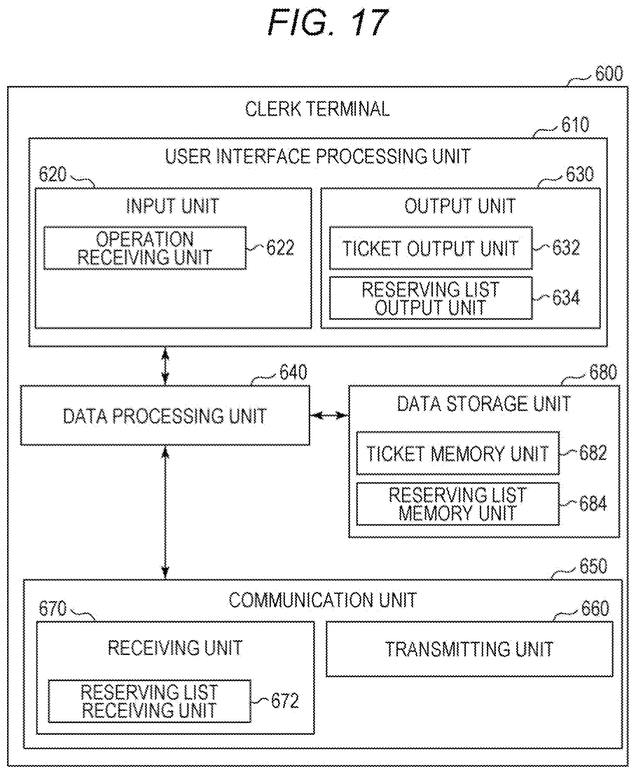

FIG. 17 is a functional block diagram of a clerk terminal 600.

The clerk terminal 600 includes a user interface processing unit 610, a data processing unit 640, a communication unit 650, and a data storage unit 680. The user interface processing unit 610 receives an operation from a clerk via a touch panel or the like, and is in charge of user interface processing such as image display or a voice output. The communication unit 650 is in charge of communication processing via a network. The data storage unit 680 stores various data. The data processing unit 640 executes various processing based on data acquired by the communication unit 650 and data stored in the data storage unit 680. The data processing unit 640 also functions as an interface for the user interface processing unit 610, the communication unit 650, and the data storage unit 680.

The user interface processing unit 610 includes an input unit 620 that receives an operation input by a clerk and an output unit 630 that presents information to the clerk. The input unit 620 includes an operation receiving unit 622 that receives the clerk operation.

The output unit 630 includes a ticket output unit 632 and a reserving list output unit 634. The ticket output unit 632 displays the clerk ticket as a QR code on the display. The clerk 120 is assigned the clerk ticket to open the door 102 of the storage device 100 as a business. The clerk ticket is displayed as the QR code on the clerk terminal 600 in the same way as the electronic ticket assigned to the user 122. The clerk ticket is a type of ticket that can be used over and over again. The reserving list output unit 634 will be described in Modification 4 described later.

The communication unit 650 includes a transmitting unit 660 that transmits data and a receiving unit 670 that receives data. The transmitting unit 660 includes a reserving list request unit 662 that requests a reserving list from the clerk terminal 600. The receiving unit 670 includes a reserving list receiving unit 672. The reserving list request unit 662 and the reserving list receiving unit 672 will be described Modification 4 described later.

The data storage unit 680 includes a ticket memory unit 682 and a reserving list memory unit 684. The ticket memory unit 682 stores the clerk ticket. The reserving list memory unit 684 will be described in Modification 4 described later.

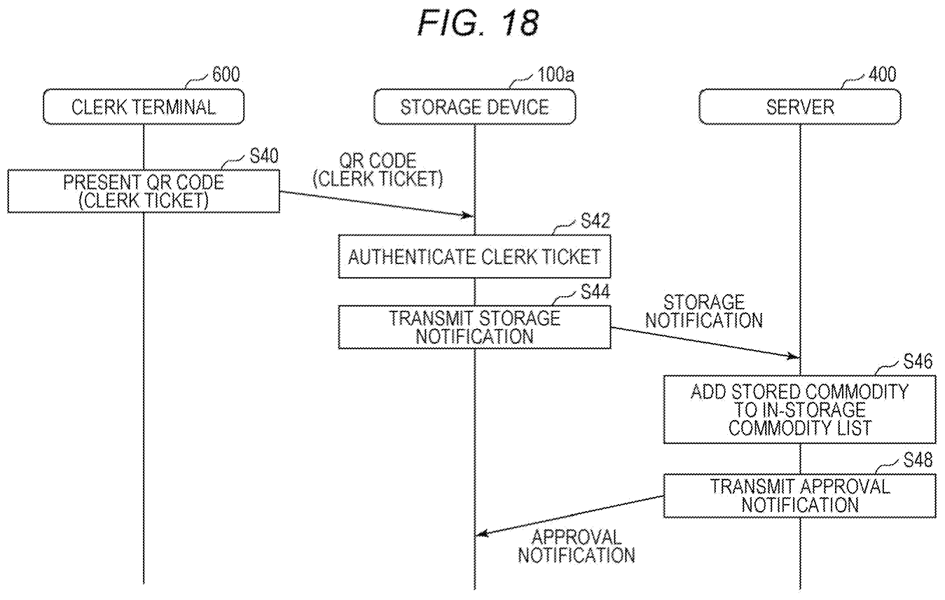

FIG. 18 is a sequence diagram when the clerk 120 stores the commodity 104 in the storage device 100a.

When the clerk 120 tries to store the commodity taken out from the store in the storage device 100a, the clerk 120 operates the clerk terminal 600 to display the electronic ticket and holds the QR code over the ticket reader 114 of the storage device 100a (S40).

The basic operation of the storage device 100a is as described in FIG. 4. Here, only a part of the basic operations will be described.

When the clerk ticket obtained by the ticket reading unit 222 of the storage device 100a is successfully authenticated (S42) and the clerk 120 finishes storing the commodity 104, the storage notification transmitting unit 262 transmits a storage notification to the server 400 (344). The storage notification includes the data of the commodity barcode 118 of the stored commodity 104 and the used clerk ticket.

When the storage notification receiving unit 472 of the server 400 receives the storage notification, the commodity list management unit 442 adds the commodity ID corresponding to the commodity barcode 118 of the stored commodity 104 to the in-storage commodity list (S46). Non-purchase is set in the corresponding purchase state. Then, the approval/disapproval notification transmitting unit 466 transmits a notification indicating approval to the storage device 100a.

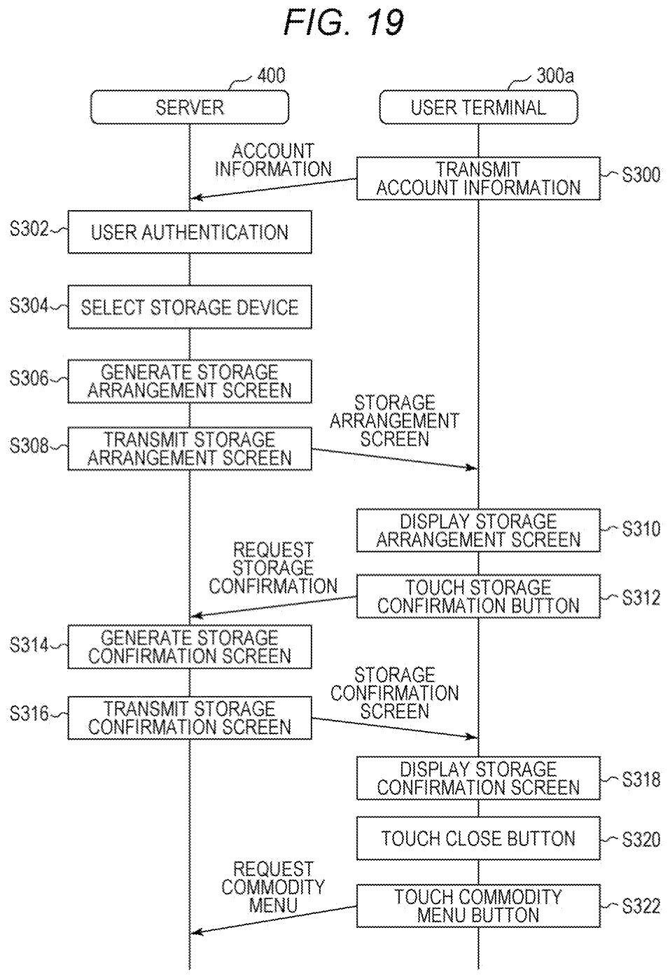

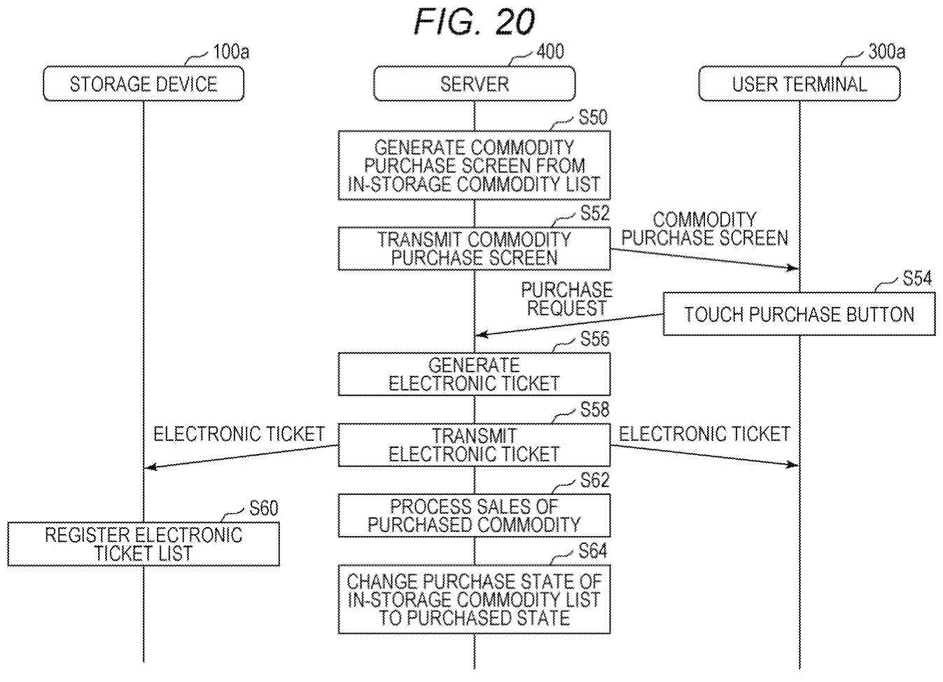

FIGS. 19 and 20 are sequence diagrams when the user 122 accesses the of the server 400 from the user terminal 300a to purchase the commodity 104 present in the storage device 100a.

When the application program of the user terminal 300a is started, the account information transmitting unit 366 transmits the account information stored in the account information memory unit 384 to the server 400 (S300).

When the account information receiving unit 479 of the server 400 receives the account information, the user authentication unit 443 authenticates the user (S302). If the user authentication is successful, the storage selection unit 445 selects the storage device 100 to be displayed (S304). Specifically, one registered as the storage device 100 near the work location is selected. Alternatively, the current position of the user terminal 300a may be acquired, and the storage device 100 within a certain distance from the user terminal 300a may be taken out.

The screen data generation unit 444 of the server 400 refers to the storage table to generate a storage arrangement screen (S306). The screen data transmitting unit 462 transmits the data of the storage arrangement screen to the user terminal 300a (S308).

When the screen data receiving unit 372 of the user terminal 300a receives the data of the storage arrangement screen, the image output unit 334 displays the storage arrangement screen (S310). When the operation receiving unit 322 receives the touch of the storage confirmation button (S312), the request transmitting unit 362 transmits a storage confirmation request to the server 400.

When the request receiving unit 474 of the server 400 receives the storage confirmation request, the screen data generation unit 444 refers to the storage table to generate the storage confirmation screen (S314). The screen data transmitting unit 462 transmits the data of the storage confirmation screen to the user terminal 300a (S316).

When the screen data receiving unit 372 receives the data of the storage confirmation screen, the image output unit 334 displays the storage confirmation screen (S318). When the operation receiving unit 322 receives the touch of the close button (S320), the storage confirmation screen is closed and the storage arrangement screen is displayed again.

When the operation receiving unit 322 receives the touch of the commodity menu button on the storage arrangement screen, the request transmitting unit 362 transmits the commodity menu request to the server 400 (S322).

The process moves to FIG. 20. When the request receiving unit 474 of the server 400 receives the commodity menu request, the screen data generation unit 444 generates the commodity purchase screen based on the in-storage commodity list of the selected storage device 100 (S50). The screen data transmitting unit 462 transmits the data of the generated commodity purchase screen to the user terminal 300a (S52).

When the screen data receiving unit 372 of the user terminal 300a receives the data of the commodity purchase screen, the image output unit 334 displays the commodity purchase screen. When the user 122 selects the commodity 104 and touches the purchase button on the commodity purchase screen, the operation receiving unit 322 receives the touch of the purchase button and specifies the commodity ID and storage device ID corresponding to the commodity 104 to be purchased (S54). The request transmitting unit 362 transmits the purchase request including the commodity ID and storage device ID to the server 400. Since the pre-purchased commodity 104 is collected, the purchase request also means a collection request of the commodity 104.

When the request receiving unit 474 of the server 400 receives the purchase request, the ticket generation unit 446 generates the electronic ticket for the user 122 who has purchased the commodity 104 (S56). One electronic ticket is issued to one user 122, and the same electronic ticket is not issued to different users 122. The electronic ticket repeatedly issued to one user 122 may be different or common each time. When the same electronic ticket is reused like a member authentication code, the electronic ticket itself may not be transmitted, but only an instruction for activating the electronic ticket held by the user terminal 300 may be transmitted. The ticket generation unit 446 adds a record of a new electronic ticket to the ticket table memory unit 486. Then, the ticket transmitting unit 464 transmits the electronic ticket to the storage device 100a and the user terminal 300 (S58).

When the ticket receiving unit 272 of the storage device 100a receives the electronic ticket, the ticket list management unit 252 adds the received electronic ticket to the ticket list (S60). Further, when the ticket receiving unit 374 of the user terminal 300 receives the electronic ticket, the electronic ticket is stored in the ticket memory unit 382.

Following S58, the transaction management unit 448 of the server 400 adds a new record to the sales table as sales processing for the purchased commodity (S62). The commodity list management unit 442 changes the purchase state of the purchased commodity 104 to the purchased state in the in-storage commodity list of the storage device 100a (S64). The transaction management unit 448 may perform settlement processing together with sales processing. The settlement processing may be a conventional method such as prepaid or postpaid electronic payment or cash payment. For Modification which will be described later, the settlement processing may be performed together with sales processing in the same manner.

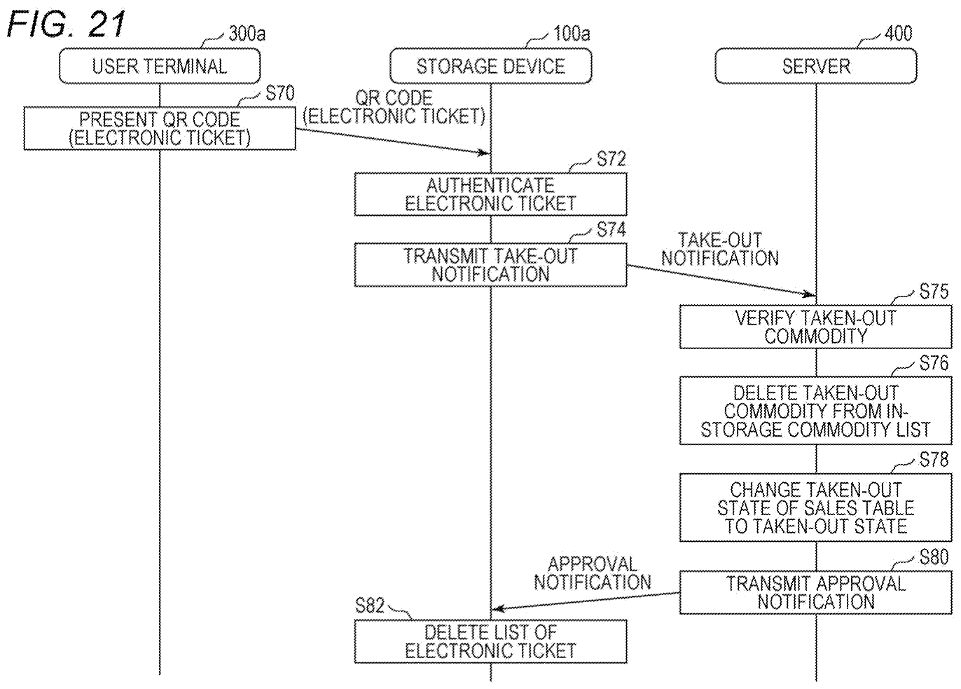

FIG. 21 is a sequence diagram when the user 122 takes out the purchased commodity 104 from the storage device 100a.

When the operation receiving unit 322 receives the operation of the display instruction of the QR code, the ticket output unit 332 converts the electronic ticket stored in the ticket memory unit 382 into the figure of the QR code and displays the converted electronic ticket on the display (S70). The user 122 holds the displayed QR code over the ticket reader 114 of the storage device 100a.

When the ticket reading unit 222 of the storage device 100a reads the QR code (electronic ticket), the ticket authentication unit 242 authenticates the read electronic ticket (S72). If the electronic ticket matches any of the electronic tickets in the ticket list, the authentication succeeds. If the electronic ticket matches any of the electronic tickets in the ticket list, the authentication fails. In this example, since the electronic ticket matches the electronic ticket stored in S60 of FIG. 20, the authentication succeeds. Thereafter, when the user 122 takes out the commodity 104 and closes the door 102, the take-out notification transmitting unit 264 (e.g., a notification unit that notifies the information processing device of link information of an article collected by a user and the user who has collected the article) transmits the take-out notification to the server 400 (S74). The take-out notification includes the data of the commodity barcode 118 of the taken-out commodity 104 and the used electronic ticket.

When the take-out notification receiving unit 476 of the server 400 receives the take-out notification, the commodity verification unit 449 determines whether the taken-out commodity 104 is valid from the storage device 100 (S75). Specifically, the commodity verification unit 449 refers to the commodity master table to identify the commodity ID corresponding to the commodity barcode 118. The commodity ID corresponds to the commodity taken out from the storage device 100a. Next, the commodity verification unit 449 refers to the ticket table to specify the user ID corresponding to the electronic ticket, and furthermore refers to the sales table to specify a commodity ID corresponding to a set of storage device ID and user ID corresponding to a transmission source of the take-out notification. The commodity ID corresponds to the commodity purchased by the user 122 in the storage device 100a. If both commodity IDs match, since the commodity purchased by the user 122 is taken out, the verification succeeds. On the other hand, if both commodity IDs match, since commodities other than the commodity purchased by the user 122 are taken out, the verification fails. If the verification fails, the approval/disapproval notification transmitting unit 466 transmits the notification indicating disapproval to the storage device 100a and returns to the processing of S74.

On the other hand, if the verification succeeds, the commodity list management unit 442 deletes the record of the commodity ID corresponding to the taken-out commodity from the storage device 100a in the in-storage commodity list (S76). In addition, the transaction management unit 448 (e.g., a recording unit that records that the user collects the article from the storage body based on the link information; e.g., a recording unit that records that the user collects the article from the stationary storage body and collects the article from the mobile storage body based on the link information) changes the take-out state corresponding to the commodity ID corresponding to the commodity purchased by the user to the taken out state in the sales table (S78). Then, the approval/disapproval notification transmitting unit 466 transmits a notification indicating approval to the storage device 100a (S80).

When the approval/disapproval notification receiving unit 274 of the storage device 100a receives the notification indicating approval, the ticket list management unit 252 deletes the used electronic ticket from the ticket list (S82).

The transaction management unit 448 may perform the settlement processing after confirming the taken state from the sales table.

[Modification 1]

In Modification 1, a reservation for commodity 104 from the user terminal 300 is performed. That is, the user 122 checks the commodity 104 housed in the storage device 100 using the user terminal 300, and reserves the favorite commodity 104 on the web. Then, later, the user 122 goes to the storage device 100, and takes out and purchases the reserved commodity 104. This transaction mode is called a “pre-reservation method of an in-storage commodity”. In modification 1, the electronic ticket used in this embodiment is issued to the user 122 who has reserved the commodity 104.

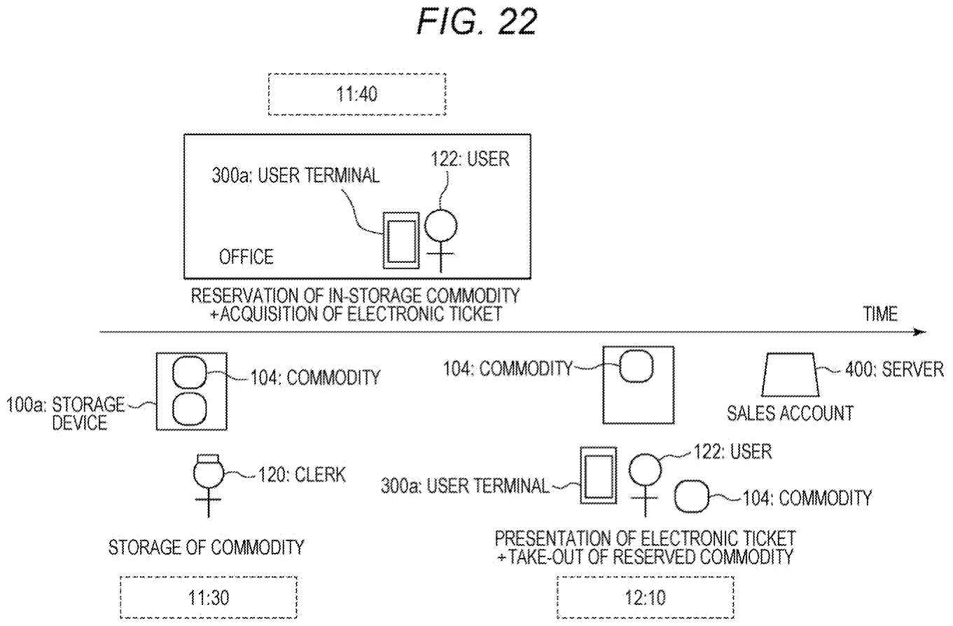

FIG. 22 is a schematic diagram illustrating the reservation purchase method of the in-storage commodity.

Similar to the case in FIG. 7, the clerk 120 stores the commodity 104 in the storage device 100a at 11:30 before lunch break.

After that, at 11:40, the user 122 browses the commodity 104 in the storage device 100a on the user terminal 300a, and selects and reserves the commodity 104 he/she prefers. At this point, the transaction has not yet been established. When the user 122 reserves the commodity 104, the server 400 transmits the electronic ticket to the user terminal 300a. The user terminal 300 stores the received electronic ticket.

At 12:10 during the lunch break, the user 122 carries the user terminal 300a and moves to the installation location of the storage device 100a. When the user 122 operates the user terminal 300a to display the QR code of the electronic ticket, and holds the QR code over the ticket reader 114 of the storage device 100a, the door 102 is unlocked. When the user 122 closes the door 102 of the storage device 100a, the door 102 is locked. A warning is issued when the user 122 takes out the unreserved commodity 104, and the user 122 takes the commodity 104 again. When the user 122 takes out the commodity 104 by himself/herself, the electronic ticket is deleted from the ticket list. The electronic ticket in this example valid only once. At this point, the transaction is established, and the server 400 counts sales.

The sequence when the clerk 120 stores the commodity 104 in the storage device 100a is as illustrated in FIG. 18.

In the case of Modification 1, the in-storage commodity list stores the commodity ID and reservation state of each commodity housed in the storage device 100. The reservation state indicates either unreserved or reserved. Commodities that nave already been reserved are not reserved in duplicate.

In the case of Modification 1, the commodity reservation screen is used instead of the commodity purchase screen. The reservation button is displayed on the commodity reservation screen, instead of the purchase button. In S54 of FIG. 20, the operation receiving unit 322 accepts the touch of the reservation button and specifies the commodity ID corresponding to the commodity 104 to be reserved. Then, the request transmitting unit 362 transmits the reservation request including the commodity ID and storage device ID to the server 400. Since the reserved commodity 104 is collected, the reservation request also means the collection request of the commodity 104.

In the case of Modification 1, in S62 of FIG. 20, instead of the sales processing of the purchased commodity, the transaction management unit 448 of the server 400 adds new reservation information to the reservation table.

In the case of Modification 1, the reservation table is used in addition to the sales table. The reservation table is a table for managing the purchase reservation. The reservation table has records for each purchase reservation. The record stores reservation information such as a reservation ID, a commodity ID, a user ID, a selling price, an electronic ticket ID, a storage device ID, and the like. The reservation ID is as to each purchase reservation. The commodity ID identifies the reserved commodity 104. The user ID specifies the reserved user 122. The electronic ticket ID specifies the electronic ticket used to deliver the reserved commodity. The storage device ID specifies the storage device 100 that houses the reserved commodity.

In the case of Modification 1, in S75 of FIG. 21, when the take-out notification receiving unit 476 of the server 400 receives the take-out notification, the commodity verification unit 449 determines whether the taken-out commodity 104a is valid from the storage device 100 (S75). Specifically, the commodity verification unit 449 refers to the commodity master table to identify the commodity ID corresponding to the commodity barcode 118. The commodity ID corresponds to the commodity taken out from the storage device 100. Next, the commodity verification unit 449 refers to the ticket table to specify the user ID corresponding to the electronic ticket, and furthermore refers to the reservation to specify a commodity ID corresponding to a set of storage device ID and user ID corresponding to a transmission source of the take-out notification. The commodity ID corresponds to the commodity reserved by the user 122 in the storage device 100. If both commodity IDs match, since the commodity reserved by the user 122 is taken out, the verification succeeds. On the other hand, if both commodity IDs match, since commodities other than the commodity reserved by the user 122 are taken out, the verification fails. If the verification fails, the approval/disapproval notification transmitting unit 466 transmits the disapproval notification to the storage device 100 and returns to the processing of S74.

In the case of Modification 1, after S78 in FIG. 21, the transaction management unit 448 on the server 400 adds a new record to the sales table as the sales processing for the purchased commodities. In the case of Modification 1, it is not necessary to manage the take-out state in the sales table. In addition, the transaction management unit 448 deletes the reservation information in the reservation table.

[Modification 2]

In Modification 2, no purchase or reservation is made only by browsing the commodity 104 from the user terminal 300. That is, the user 122 operates the user terminal 300 to check whether the storage device 100 has the commodity 104 that he/she prefers. If the user 122 wants to purchase one of the commodities 104 present in the storage device 100, he/she requests the issuance of the electronic ticket from the user terminal 300 and acquires the electronic ticket to open the storage device 100. In the case of Modification 2, on a first-come, first-served basis, a person who actually takes out a commodity from the storage device 100 purchases the commodity. Therefore, it may not be possible to purchase the commodity 104 browsed on the user terminal 300. This transaction mode is called an “arbitrary purchase method of an in-storage commodity”.

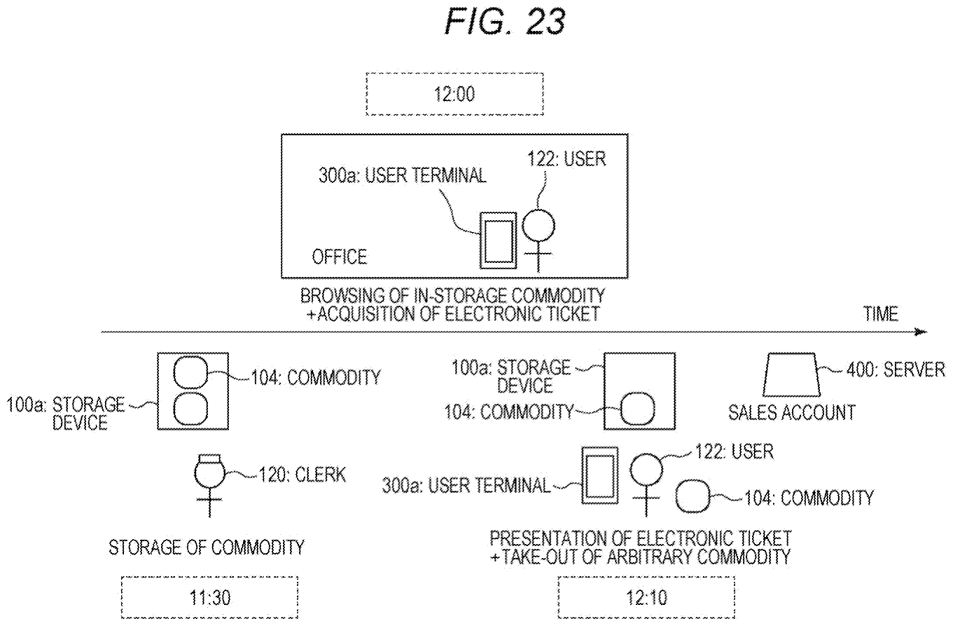

FIG. 23 is a schematic diagram illustrating the arbitrary purchase method of the in-storage commodity.

Similar to the case in FIG. 7, the clerk 120 stores the commodity 104 in the storage device 100a at 11:30 before lunch break.

Then, at 12:00, when the user 122 browses the commodity 104 of the storage device 100a on the user terminal 300 and tries to purchase the read commodity, he/she requests the issuance of the electronic ticket. In Modification 2, the electronic ticket is issued to the user 122 who has browsed the commodity 104 in the storage device 100a in advance. When the server 400 is requested to issue the electronic ticket, the server 400 transmits the electronic ticket to the user terminal 300. The user terminal 300 stores the received electronic ticket.

When the user 122 arrives at the installation location of the storage device 100a at 12:10, the user terminal 300 is operated to display the QR code of the electronic ticket, and the QR code is held over the ticket reader 114 of the storage device 100a. The user 122 opens the unlocked door 102 and takes out the commodity 104 he/she wants to purchase freely. All the commodities 104 housed in the storage device 100a can be purchased. When the user 122 closes the door 102 of the storage device 100a, the electronic ticket is deleted from the ticket list. The electronic ticket in this example is valid only once. However, the door 102 may be allowed to be opened and closed more than once. When any one of the doors 102 is taken out and the door 102 is closed, the transaction is established, and the server 400 counts sales.

The sequence when the clerk 120 stores the commodity 104 in the storage device 100a is as illustrated in FIG. 18.

In the case of Modification 2, the in-storage commodity list manages the commodity ID of each commodity housed in the storage device 100, but it is not necessary to manage the purchase state and the reservation state.

In the case of Modification 2, the commodity reservation screen is used instead of the commodity reading screen. One ticket issuance button is displayed on the commodity reading screen. In S54 of FIG. 20, when the operation receiving unit 322 receives the touch of the ticket issuance button, the request transmitting unit 362 transmits the ticket request to the server 400. By acquiring the electronic ticket, the user 122 is authorized to use the storage device 100 in which the commodity 104 is housed.

In the case of Modification 2, the commodity sales processing illustrated in S62 of FIG. 20 is not performed. In addition, the purchase state in the in-storage commodity list shown in S64 is not updated.

In the case of Modification 2, in S75 of FIG. 21, the commodity verification unit 449 determines that the commodity 104 taken out from the storage device 100 is valid in each case, and the verification succeeds.

In the case of Modification 2, after S78 in FIG. 21, the transaction management unit 448 on the server 400 adds a new record to the sales table as the sales processing for the purchased commodities. In the case of Modification 2, it is not necessary to manage the take-out state in the sales table.

[Modification 3]

In Modification 3, the same electronic ticket as a membership authentication code as a modification of the arbitrary purchase method of the in-storage commodity is used. That is, the issuance of the ticket is omitted. The user 122 may take out the commodity 104 directly from the storage device 100 without browsing the commodity 104 in the storage device 100.

In the case of Modification 3, the server 400 transmits the electronic ticket of the user 122 to the storage device 100 near the registered work location. The storage device 100 permanently holds the transmitted electronic ticket in the ticket list and does not delete the electronic ticket illustrated in S82 of FIG. 21.

Further, instead of the electronic ticket, a QR code printed on a card or paper may be used as a ticket.

[Modification 4]

In the above example, an example of purchasing the commodity 104 housed in the storage device 100 is shown. That is, the commodity 104 that is not in the storage device 100 cannot be purchased. On the other hand, in Modification 4, the commodity 104 is collected from the store. Specifically, the user 122 selects a desired commodity 104 from the purchasable commodity 104 as the store inventory and requests a predetermined storage device 100 to deliver the selected commodity 104. In this way, the transaction mode in which the commodity 104 of the store inventory is purchased in advance and then is delivered to the storage device 100 is called a “pre-purchase method of a store inventory commodity”.

As described above, Modification 4 can be applied when purchasing a lunch box at lunch, but an example in which the commodity 104 is delivered to the storage device 100 near a home will be described.

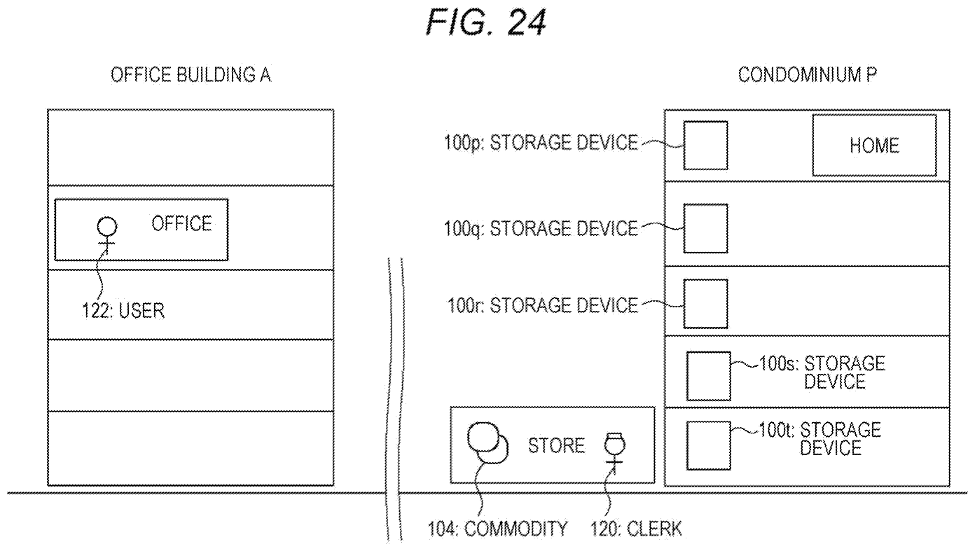

FIG. 24 is an arrangement diagram of the storage device 100.

A home of the user 122 is on the 5th floor of mansion P which is away from office building A. As illustrated, the storage devices 100p to 100t are installed on the 1st to 5th floors of the mansion P.

There is a store next to Mansion P, and the store sells lunch boxes, sandwiches, side dish packs such as salads, beverages, or the like. The storage devices 100p to 100t are managed by this store. That is, the commodity 104 housed in the storage devices 100p to 100t is supplied by this store.

The store sells lunch boxes, sandwiches, side dish packs such as salads, or beverages for residents of the mansion P at any time. The user 122 checks the commodity 104 in the store by operating the user terminal 300, and orders the favorite commodity 104 on the web. The clerk 120 of the store delivers the commodity 104 ordered by user 122 to the storage device 100 used by the user 122. Residents may purchase the commodity 104 without stopping by a store, which is convenient. In addition to a selling area in the store, the commodity 104 can be sold even in the storage devices 100p to 100t, so the sales of the store are expected to increase. It can also be expected to eliminate unsold commodity 104

The store manages a plurality of neighboring storage devices 100 in addition to the storage devices 100p to 100t, and the clerk periodically organizes and performs the delivery to these storage devices 100. For example, the delivery is performed every 30 minutes, such as 17:00, 17:30, 18:00, and 18:30. When the ordered commodity 104 is sold out between the time the order is received and the time the commodity is delivered, the clerk reserves the commodity 104.

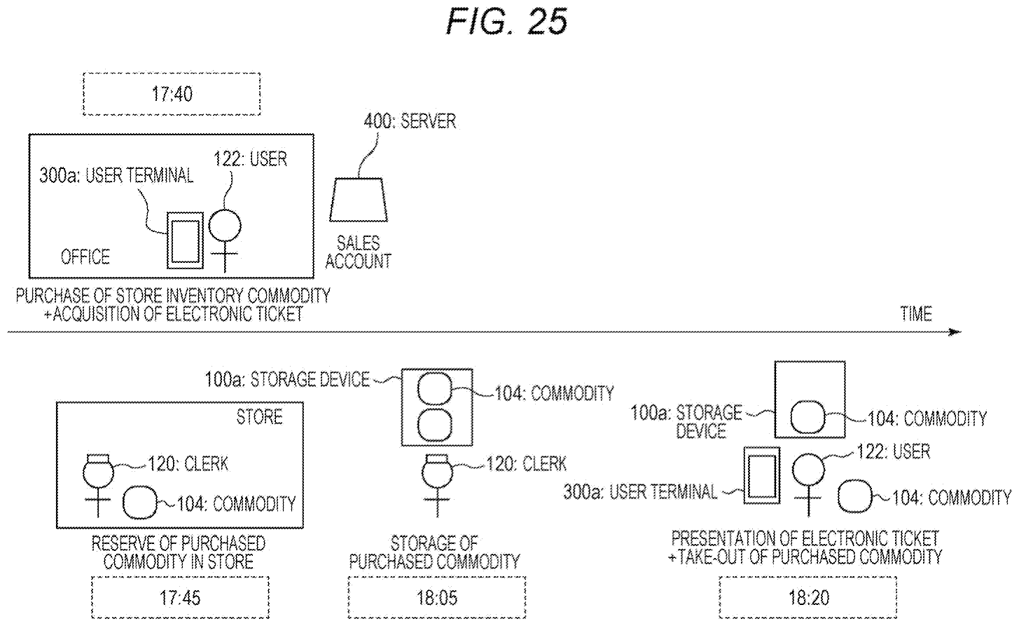

FIG. 25 is a schematic diagram illustrating a pre-purchase method of a store inventory commodity.

In this example, at 17:40 before leaving the office, the user 122 browses the commodity 104 in the store that manages the storage device loop near his/her home on the user terminal 300a, and selects and purchases the commodity 104 he/she prefers. At this point, the transaction is established, and the server 400 counts sales. When the user 122 purchases the commodity 104, the server 400 transmits the electronic ticket to the user terminal 300a. The user terminal 300a stores the received electronic ticket. However, at this stage, the commodity 104 is still in the store.

The information on the purchased commodity 104 is communicated to the store, and at 17:45, a clerk reserves the commodity 104.

At 18:00, the delivery time, a clerk heads for the delivery of the reserved commodity 104. At 18:05, a clerk arrives on the 5th floor of Mansion P and stores the commodity 104 is stored in the storage device 100p.

At 18:20, the user 122 returns to the mansion P, and operates the user terminal 300 to display the QR code of the electronic ticket, and holds the QR code over the ticket reader 114 of the storage device 100p. Then, the unlocked door 102 is opened and the purchased commodity 104 is taken out. The electronic ticket in this example is valid only once, and thus, is deleted from the ticket list when the purchased commodity 104 is taken out. However, when a type of electronic ticket that can be used repeatedly multiple times is used, it is not necessary to delete the electronic ticket from the ticket list. Similarly, when the QR code printed on the card or paper is used as a ticket that can be used repeatedly, the ticket data does not have to be deleted.

Note that the store terminal 700 constantly manages the commodity 104, which is the inventory of the store, as a list. This list is called the store inventory list. Further, it is assumed that the server 400 performs data synchronization with the store terminal 700 and holds the same store inventory list. The server 400 has a store inventory list memory unit (not illustrated) that stores a store inventory list in association with the store ID.

The commodity 104, which is inventory and may be sold, will be posted on the site of the server 400. As a result, the user terminal 300 can access the site of the server 400 and randomly browse the commodity 104 deliverable to the storage device 100p in real time. Hereinafter, the processing in this method will be described.

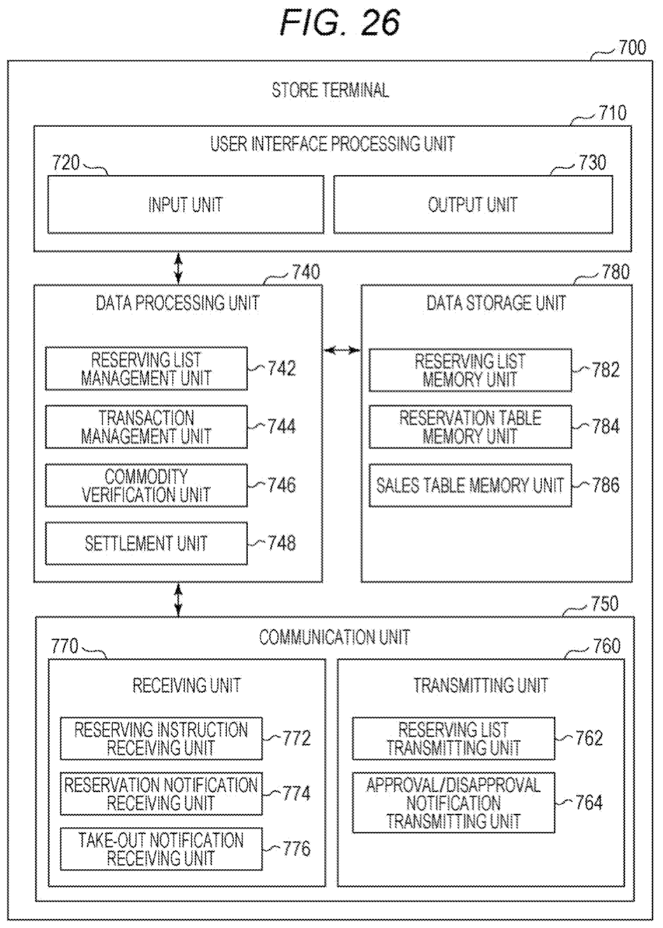

FIG. 26 is a functional block diagram of the store terminal 700.

The store terminal 700 includes a user interface processing unit 710, a data processing unit 740, a communication unit 750, and a data storage unit 780. The user interface processing unit 710 receives an operation from a clerk manager via a touch panel or the like, and is in charge of user interface processing such as image display or a voice output. The communication unit 750 is in charge of communication processing via a network. The data storage unit 780 stores various data. The data processing unit 740 executes various processing based on data acquired by the communication unit 750 and data stored in the data storage unit 780. The data processing unit 740 also functions as an interface for the user interface processing unit 710, the communication unit 750, and the data storage unit 780.

The user interface processing unit 710 includes an input unit 720 that receives an operation input by a clerk manager and an output unit 730 that presents information to the clerk manager.

The data processing unit 740 includes a reserving list management unit 742, a transaction management unit 744, a commodity verification unit 746, and a settlement unit 748. The reserving list management unit 742 manages the reserving list. The transaction management unit 744 manages transactions such as sales or reservation of the commodity 104. The commodity verification unit 746 verifies the taken-out commodity. The settlement unit 748 performs the settlement processing. Note that the transaction management unit 744, the commodity verification unit 746, and the settlement unit 748 are used in Modification 9 described later.

The communication unit 750 includes a transmitting unit 760 that transmits data and a receiving unit 770 that receives data.

The transmitting unit 760 includes a reserving list transmitting unit 762 and an approval/disapproval notification transmitting unit 764. The reserving list transmitting unit 762 transmits the reserving list. The approval/disapproval notification transmitting unit 764 transmits an approval/disapproval notification. Note that the approval/disapproval notification transmitting unit 764 is used in Modification 8 described later.

The receiving unit 770 includes a reserving instruction receiving unit 772, a reservation notification receiving unit 774, and a take-out notification receiving unit 776. The reserving instruction receiving unit 772 receives the reserving instruction. The reservation notification receiving unit 774 receives reservation notification. The take-out notification receiving unit 776 receives the take-out notification. Note that the reservation notification receiving unit 774 and the take-out notification receiving unit 776 are used in Modification 8 described later.

The data storage unit 780 includes a reserving list memory unit 782, a reservation table memory unit 784, and a sales table memory unit 786. The reserving list memory unit 782 stores the reserving list. The reserving list has records for each commodity 104 to be reserved. The record stores the commodity ID and the storage device ID. The commodity ID specifies the commodity to be delivered. The storage device ID specifies the storage device of a delivery destination.

The reservation table memory unit 784 stores a reservation table. The sales table memory unit 786 stores a sales table. Note that the reservation table memory unit 784 and the sales table memory unit 786 are used in Modification 8 described later.

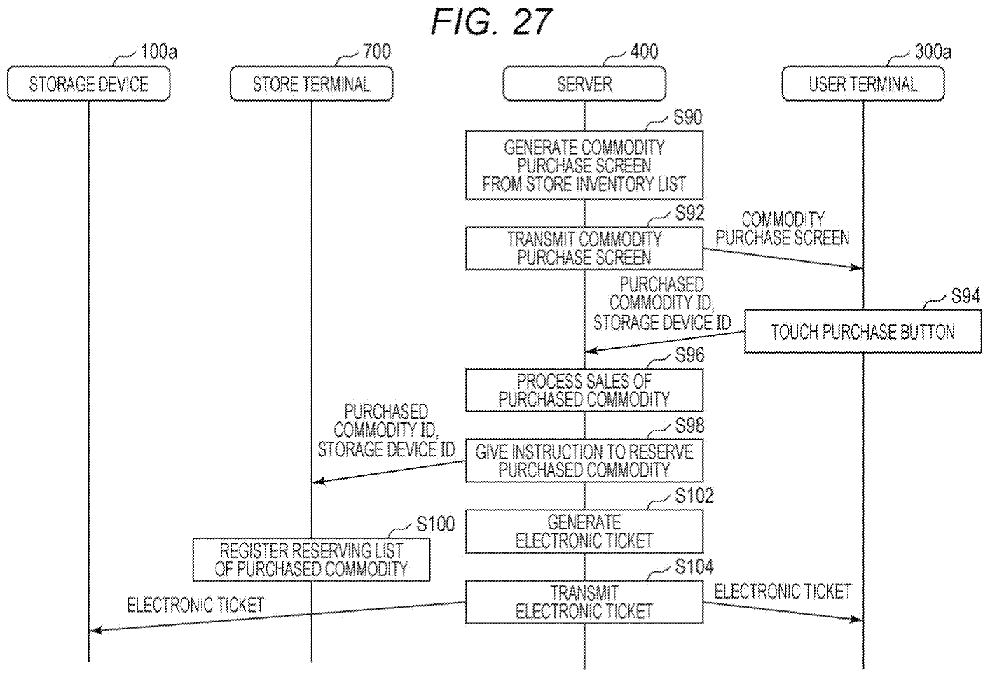

FIG. 27 is a sequence diagram when the user 122 accesses the site of the server 400 from the user terminal 300a and purchases the commodity 104 present in the store.

In this example, it is assumed that the storage device 100p near the home previously registered by the user 122 is automatically selected.

The screen data generation unit 444 of the server 400 reads the management store ID corresponding to the storage device 100p from the storage table, and generates the commodity purchase screen based on the store inventory list specified by the management store ID (S90). The screen data transmitting unit 462 transmits the data of the generated storage arrangement screen to the user terminal 300a (S97).

The image output unit 334 of the user terminal 300a displays the commodity purchase screen. When the user 122 selects the commodity 104 and touches the purchase button on the commodity purchase screen, the operation receiving unit 322 specifies the commodity ID corresponding to the commodity 104 to be purchased (S94). The request transmitting unit 362 transmits the purchase request including the commodity ID to the server 400.

When the request receiving unit 474 of the server 400 receives the purchase request, the transaction management unit 448 of the server 400 adds a new record to the sales table as sales processing for the purchased commodity (S96). Then, the reserving instruction transmitting unit 468 transmits the reserving instruction of the purchased commodity to the store terminal 700 (S98). The reserving instruction includes a commodity ID that specifies the commodity to be delivered and a storage device ID that specifies the storage device 100p (a storage device near a home) of the delivery destination.

When the reserving instruction receiving unit 772 of the store terminal 700 receives the reserving instruction, the commodity ID and the storage device ID are registered in the reserving list (S100).

The ticket generation unit 446 generates the electronic ticket for the user 122 who has purchased the commodity 104 (S102). Then, the screen data transmitting unit 462 transmits the electronic ticket to the storage device 100p and the user terminal 300a (S104).

When the ticket receiving unit 272 of the storage device 100p receives the electronic ticket, the ticket list management unit 252 adds the received electronic ticket to the ticket list. Further, when the ticket receiving unit 374 of the user terminal 300 receives the electronic ticket, the electronic ticket is stored in the ticket memory unit 382.

When the receiving unit 770 of the store terminal 700 receives the request for the reserving list, the reserving list transmitting unit 762 transmits the reserving list to the clerk terminal 600. At this time, the reserving list transmitting unit 762 converts the commodity ID included in the reserving list into the commodity name and converts the storage device ID into the storage device name. Note that the store terminal 700 has the storage table memory unit and the commodity master table memory unit similar to the server 400.

When the reserving list receiving unit 672 of the clerk terminal 600 receives the reserving list, the reserving list memory unit 684 stores the reserving list, and the reserving list output unit 634 displays the reserving list. The reserving list request unit 662 of the clerk terminal 600 may request the reserving list by the operation of the clerk.

The sequence when the clerk 120 stores the commodity 104 in the storage device 100p is as illustrated in FIG. 18.

The sequence when the user 122 takes out the commodity 104 purchased from the storage device 100p is the same as the case of FIG. 21.

[Modification 5]

In Modification 4, the commodity 104 being delivered without being purchased on the web may be reserved. This transaction mode is called “reservation purchase method of store inventory commodity”.

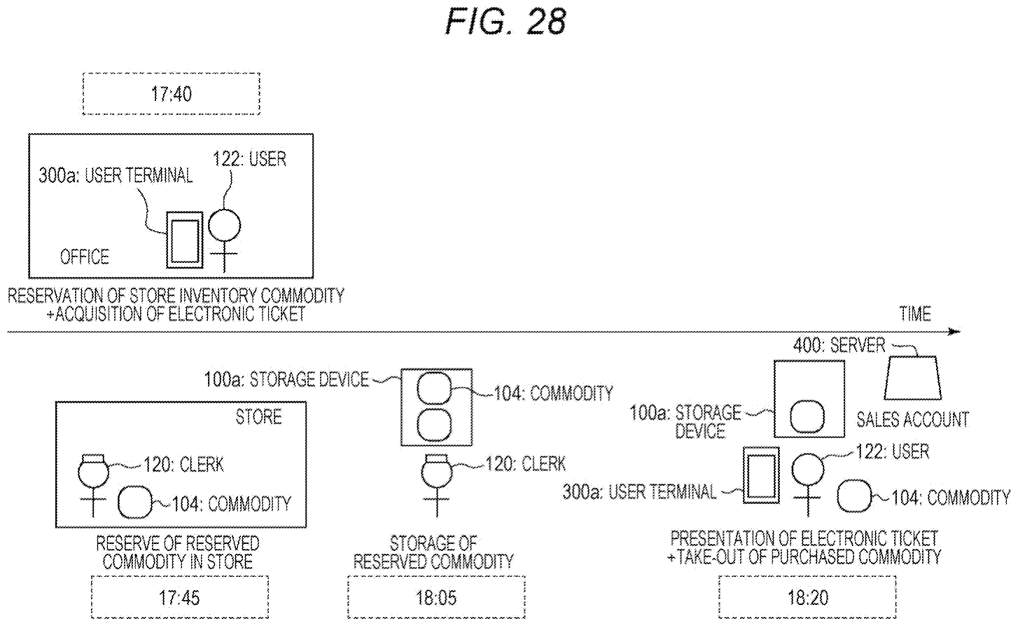

FIG. 28 is a schematic diagram illustrating a reservation purchase method of a store inventory commodity.

At 17:40, the user 122 reserves the commodity 104. At this point, no sales are counted. The work of the clerk 120 at 17:45 and 18:05 is the same as the case of FIG. 25. At 18:20, when the user 122 takes out the commodity 104, sales are counted.

In Modification 5, the commodity reservation screen is used instead of the commodity purchase screen of Modification 4. The reserved commodities 104 are reserved and delivered in the same way as purchase commodities in Modification 4.

The processing for the in-storage commodity list, the reservation table, and the sales table is the same as the case of the reservation purchase method of the in-storage commodity.

[Modification 6]

In the above examples, it is assumed that the storage device 100 is installed outside the store, but the storage device 100e may be installed inside the store. In this example, the sale of hot snack at the cash register installation location (hereinafter abbreviated as “cash register”) is supported. The hot snack is a light meal or a side dish that are eaten warm, like French fries, croquettes, and fries.

There is a problem in that it is troublesome for a cashier clerk 120 of the cash register to take out hot snack from a case, pack the hot snack, and deliver the hot snack to the user 122, and it is difficult for customers in the back to purchase the hot snack when customers are in line. In Modification 6, the cashier work is reduced by leaving the take-out of the hot snack to the user 122. As the exchange near the cash register is faster, the customers who refrain from purchasing hot snack more easily purchases the hot snack.

The storage device 100e houses hot snack as a commodity. The hot snack is packed in a bag or container in advance, and the commodity barcode attached to the bag or container is recognized to detect the commodity. Alternatively, an installation range may be set for each type of hot snack, the number of commodities that range may be detected, and the type and quantity of taken out commodities may be specified.

In Modification 6, the user terminal 300 is not used. A paper ticket with a QR code printed thereon is issued in a cash register 800, and the storage device 100e is allowed to be used by the paper ticket. This transaction mode is called a “pre-settlement method using a paper ticket”.

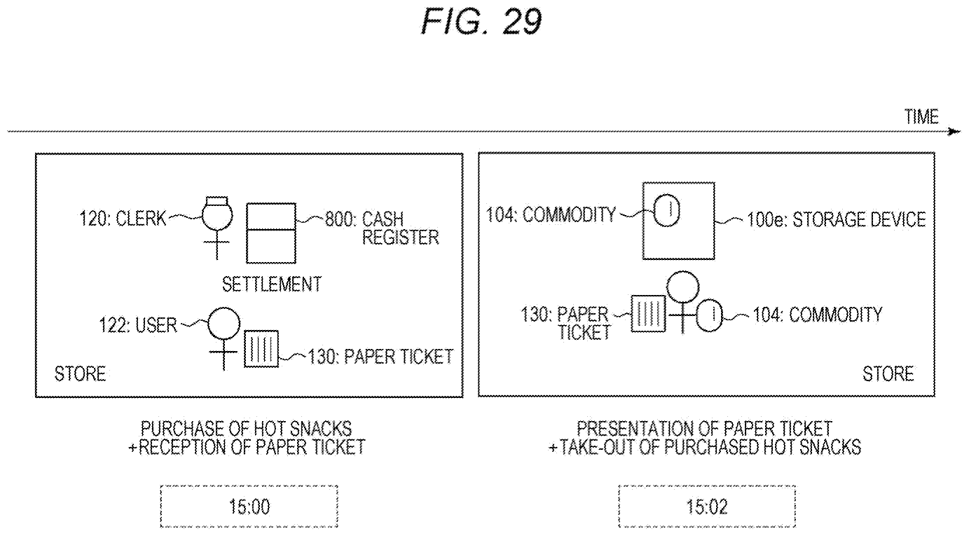

FIG. 29 is a schematic diagram indicating the pre-settlement method using the paper ticket.

At 15:00, the user 122 notifies the cashier clerk 120 of the type and quantity of hot snacks he/she wants to purchase and pays a fee. At that time, the paper ticket is output from the cash register 800. A unique QR code is printed on the paper ticket. The paper ticket is handed to the user 122.

At 15:02, the user 122 reads the paper ticket with the ticket reader 114 of the storage device 100e to take out the purchased hot snack. At this time, if the taken out hot snack does not match the purchased hot snack, a warning is issued. This prevents the commodity 104 from being mistaken.

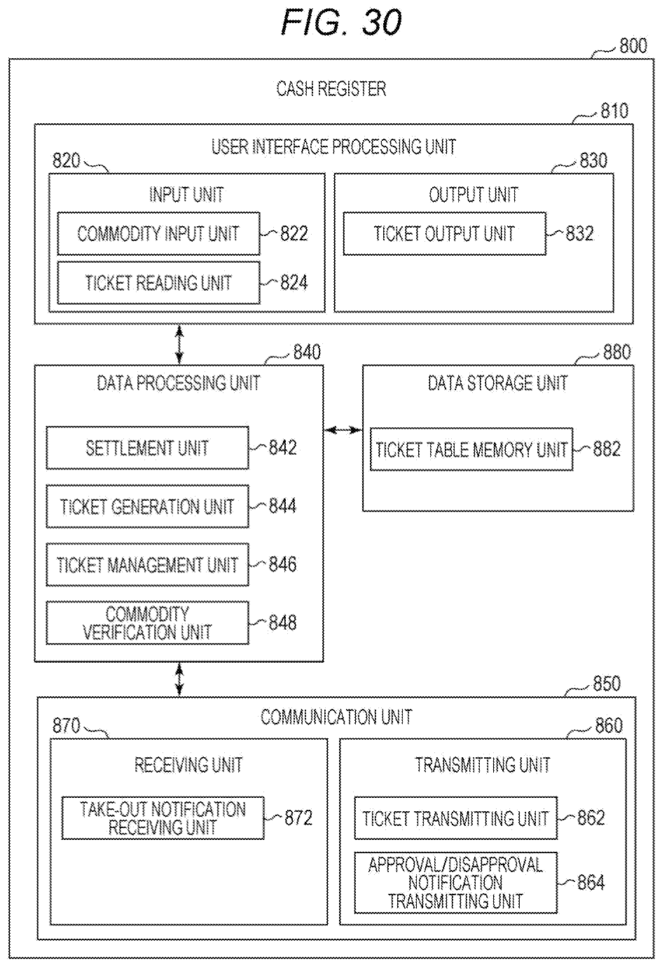

FIG. 30 is a functional block diagram of the cash register 800.

The cash register 800 includes a user interface processing unit 810, a data processing unit 840, a communication unit 850, and a data storage unit 880. The user interface processing unit 810 receives an operation from a person in charge of a register via a touch panel or the like, and is in charge of user interface processing such as image display or a voice output. The communication unit 850 is in charge of communication processing via a network. The data storage unit 880 stores various data. The data processing unit 840 executes various processing based on data acquired by the communication unit 850 and data stored in the data storage unit 880. The data processing unit 840 also functions as an interface for the user interface processing unit 810, the communication unit 850, and the data storage unit 880.

The user interface processing unit 810 includes an input unit 820 that receives operation input by the cashier clerk 120 and an output unit 830 that presents information to the cashier clerk 120.

The input unit 820 includes a commodity input unit 822 and a ticket reading unit 824. The commodity input unit 822 inputs the type and quantity of purchased commodities (hot snacks). The ticket reading unit 824 reads a paper ticket and an electronic ticket. Note that the ticket reading unit 824 is used in Modification 7, which will be described later. The output unit 830 includes a ticket output unit 832 that outputs a paper ticket.

The data processing unit 640 includes a settlement unit 842, a ticket generation unit 844, a ticket management unit 846, and a commodity verification unit 848. The settlement unit 842 performs the settlement processing. The settlement processing may be the conventional cash settlement or electronic settlement. The ticket generation unit 844 generates paper ticket data. The ticket management unit 846 manages a ticket table. The commodity verification unit 848 verifies the purchased commodity.

The communication unit 850 includes a transmitting unit 860 that transmits data and a receiving unit 870 that receives data. The transmitting unit 860 includes a ticket transmitting unit 862 and an approval/disapproval notification transmitting unit 864. The ticket transmitting unit 862 transmits an electronic ticket. The approval/disapproval notification transmitting unit 864 transmits an approval/disapproval notification. The receiving unit 870 includes a take-out notification receiving unit 872 that receives a take-out notification.

The data storage unit 880 includes a ticket table memory unit 882 that stores the ticket table. In Modification 6, the ticket table has records for each electronic ticket issued by the server 400. The record stores the type and quantity of purchased commodities in association with the paper ticket data.

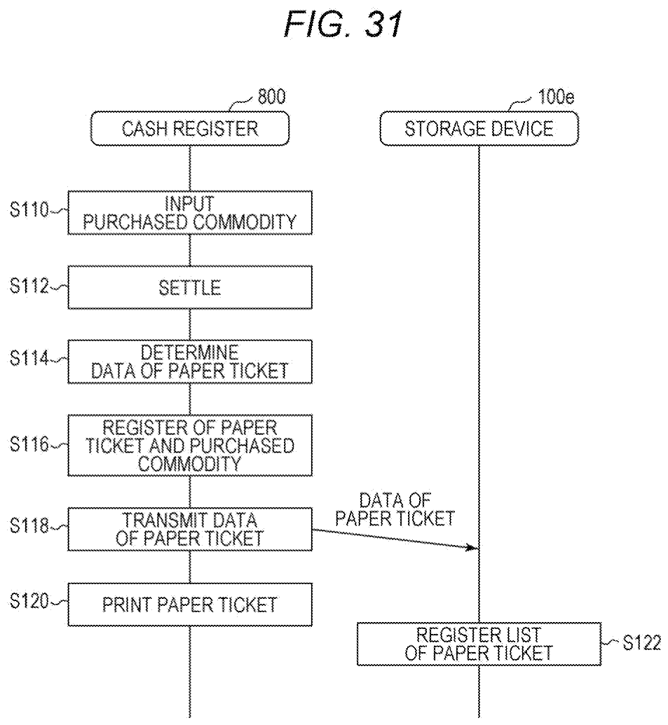

FIG. 31 is a sequence diagram about the exchange at the cash register.

The commodity input unit 822 of the cash register 800 inputs the type and quantity of purchased commodities (hot snacks) (S110). The settlement unit 842 performs the same settlement processing as before (S112).

The ticket generation unit 844 determines paper ticket data (S114). Since it is sufficient that the data converted into the QR code is unique, it may be a simple serial number. The ticket management unit 846 registers the paper ticket data in the ticket table by being associated with the type and quantity of purchased commodities (S116). The ticket transmitting unit 862 transmits the data of the paper ticket to the storage device 100e (S118). Then, the ticket output unit 832 prints and outputs the paper ticket (S120). The paper ticket is handed from the cashier clerk 120 to the user.

When the ticket receiving unit 272 of the storage device 100e receives the paper ticket data, the ticket list management unit 252 registers the paper ticket data in the ticket list (S122).

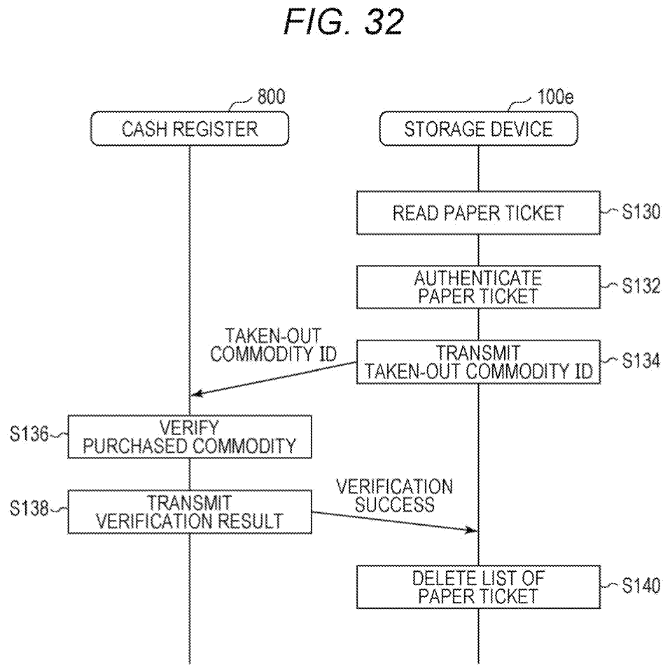

FIG. 32 is a sequence diagram of a take-out of the commodity 104.

When the ticket reading unit 222 reads the paper ticket (S130), the ticket authentication unit 242 authenticates the paper ticket (S132). If the read paper ticket data does not match the paper ticket data stored in the ticket list, the authentication fails and the lock is not released. On the other hand, if the read paper ticket data matches the paper ticket data stored in the ticket list, the authentication succeeds and the lock is released.

When the user takes out the commodity 104 (hot snack) and closes the door 102, the take-out notification transmitting unit 264 transmits the take-out notification to the server 400 (S134). The take-out notification includes the type and number of taken-out commodity 104 and the electronic ticket data used.

When the take-out notification receiving unit 872 of the cash register 800 receives the take-out notification, the commodity verification unit 848 verifies the purchased commodity (S136). Specifically, the commodity verification unit 848 reads from the ticket table the type and quantity of purchased commodities that correspond to the paper ticket data included in the take-out notification. Then, when the type and quantity of taken-out commodities 104 match the type and quantity of purchased commodities, the verification succeeds. If the verification succeeds, the approval/disapproval notification transmitting unit 864 transmits a notification indicating approval to the storage device 100e (S138).

When the approval/disapproval notification receiving unit 274 of the storage device 100e receives the notification indicating approval, the ticket list management unit 252 deletes the used paper ticket from the ticket list (S140).

When the type and quantity of taken-out commodities 104 do not match the type and quantity of purchased commodities and the commodity verification unit 848 of the cash register 800 determines that the verification has failed, the approval/disapproval notification transmitting unit 864 stores the notification indicating disapproval to the storage device 100e. Then, the warning output unit 232 of the storage device 100e outputs a warning.

[Modification 7]

In Modification 6, settlement is completed before the commodity 104 (hot snack) is taken out, but settlement may be made after the commodity 104 is taken out. This transaction mode is called a “post-settlement method using a paper ticket”.

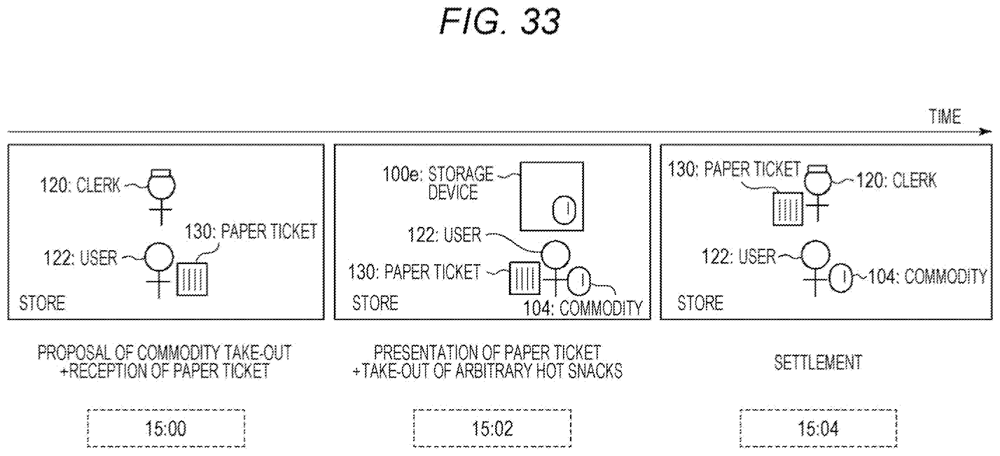

FIG. 33 is a schematic diagram indicating the post-settlement method using the paper ticket.

At 15:00, the user 122 requests the cashier clerk 120 to purchase the hot snack. At this time, there is no need to notify the type and quantity of hot snacks. That is, the user 122 may freely select the hot snack he/she wants to purchase. At that time, the paper ticket is output from the cash register 800. A unique QR code is printed on the paper ticket. The paper ticket is handed to the user 122.

At 15:02, the user 122 reads the paper ticket with the ticket reader 114 of the storage device 100e to take out the hot snack he/she wants to purchase. When the user 122 closes the door 102, the type and quantity of taken out hot snacks are transmitted from the storage device 100e to the cash register 800.

At 15:04, the user 122 who finished taking out the hot snack returns the paper ticket to the cashier clerk 120. Then, settlement is made according to the type and quantity of taken out hot snacks.

In Modification 7, the ticket table has a record for each electronic ticket issued by the server 400. However, the record stores the settlement state in addition to the type and quantity of purchased commodities in association with the paper ticket data. The settlement state indicates either non-settled or settled.

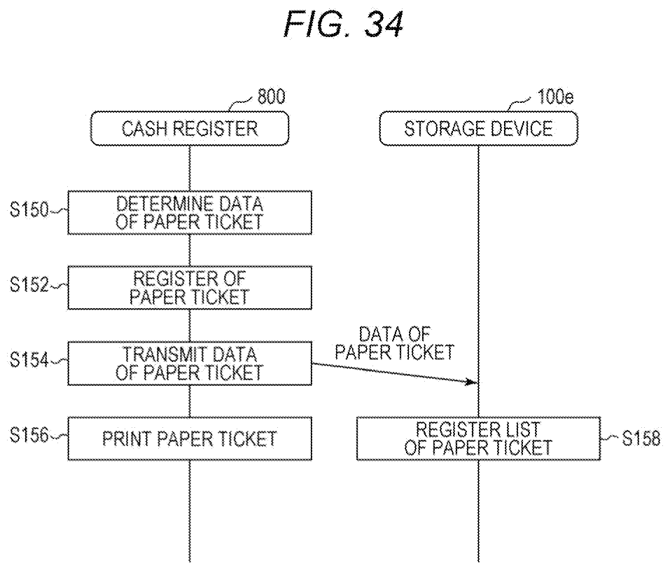

FIG. 34 is a sequence diagram of the issuance of the paper ticket.

Similar to Modification 6, the ticket generation unit 844 determines the data of the paper ticket (S150). The ticket management unit 846 registers the paper ticket data in the ticket table (S152). At this stage, the type and quantity of hot snacks are not determined. The ticket transmitting unit 862 transmits the data of the paper ticket to the storage device 100e (S154). Then, the ticket output unit 832 prints and outputs the paper ticket (S156). The paper ticket is handed from the cashier clerk 120 to the user.

When the ticket receiving unit 272 of the storage device 100e receives the paper ticket data, the ticket list management unit 252 adds the paper ticket data in the ticket list (S158).

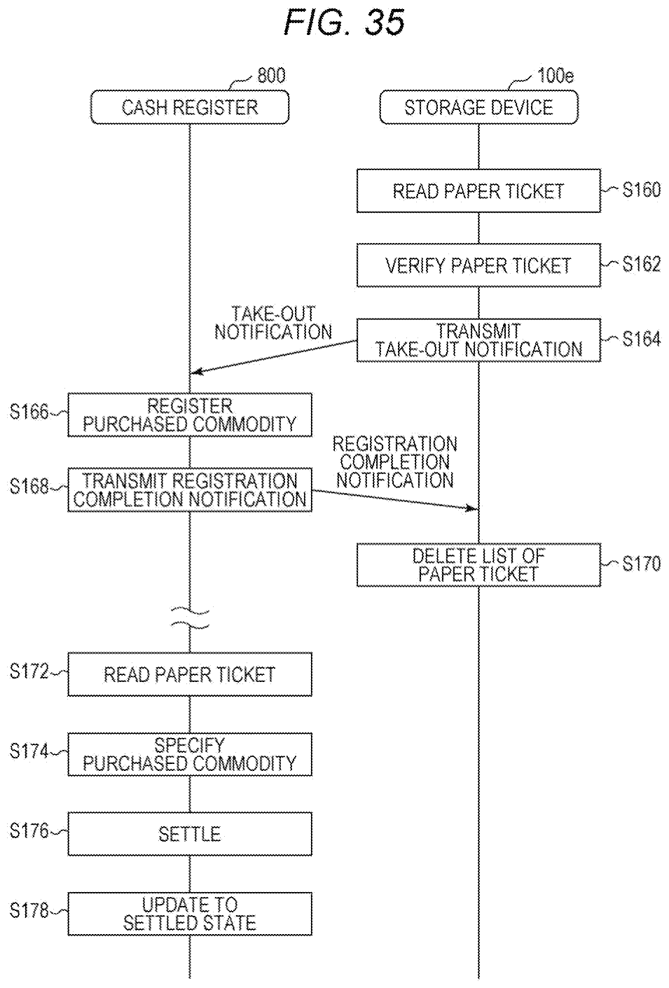

FIG. 35 is a sequence diagram of a take-out and a settlement of the commodity 104.

When the ticket reading unit 222 reads the paper ticket (S160), the ticket authentication unit 242 authenticates the paper ticket (S162).

If the authentication succeeds, the lock will be released. When the user takes out the commodity (hot snack) 104 and closes the door 102, the take-out notification transmitting unit 264 transmits the take-out notification to the server 400 (S164). The take-out notification includes the type and number of taken-out commodity 104 and the electronic ticket data used.

When the take-out notification receiving unit 872 of the cash register 800 receives the take-out notification, the ticket management unit 846 registers the type and quantity of taken-out commodities 104 in the ticket table as the type and quantity of purchased commodities corresponding to the data of the used paper ticket (S166). At this point, the settlement state indicates non-settled. Then, the approval/disapproval notification transmitting unit 864 transmits a notification indicating approval to the storage device 100e (S168).

When the approval/disapproval notification receiving unit 274 of the storage device 100e receives the notification indicating approval, the ticket list management unit 252 deletes the used paper ticket from the ticket list (S170).

When the user hands over the paper ticket to the cashier clerk 120, the ticket reading unit 824 of the cash register 800 reads the paper ticket (S172). Then, the settlement unit 842 refers to the ticket table to specify the type and quantity of purchased commodities corresponding to the read paper ticket (S174). The settlement unit 842 performs settlement processing according to the type and quantity of purchased commodities (S176). When the settlement processing is completed, the settlement state changes to settled (S178).

[Modification 8]

For the purchase of the store commodities such as the hot snack, the electronic ticket may be used instead of the paper ticket. In Modification 8, the commodity 104 (hot snack) is reserved from the user terminal 300. This transaction mode is called “reservation purchase method of store commodity”.

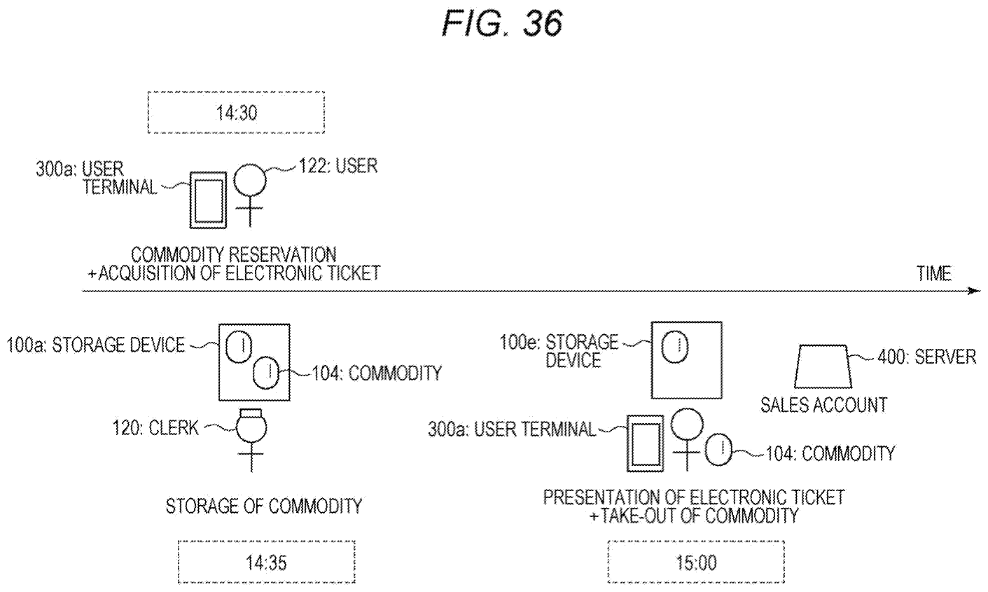

FIG. 36 is a schematic diagram illustrating a reservation purchase method of a store commodity.

At 14:30 before the user 122 goes to a store, the user 122 browses the commodity (hot snack) in the store on the user terminal 300a, and determines the type and quality of commodities (hot snacks), and makes a reservation therefor. When the user 122 reserves the commodity 104, the server 400 transmits the electronic ticket to the user terminal 300a. The user terminal 300a stores the received electronic ticket.

At 14:35, the information on the reserved commodity is transmitted to the store, the clerk checks the ready state of the commodity 104, and if the commodity 104 is not ready, the commodity (hot snack) is cooked and replenished.

When the user 122 arrives at the store, he/she goes straight to the storage device 100e without stopping by the cash register. Then, the electronic ticket is presented and the reserved commodity is taken out from the storage device 100e. If the taken-out commodity is valid, the sales are counted as it is. As for payment, conventional methods such as prepaid or postpaid electronic settlement or cash payment may be used.

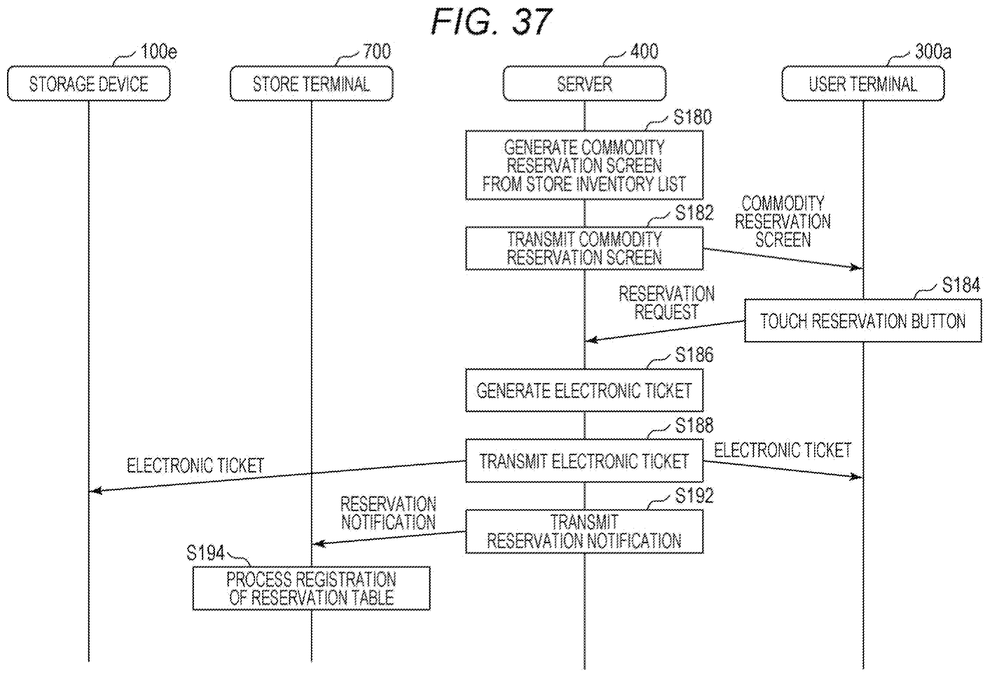

FIG. 37 is a sequence diagram when the user 122 accesses the site of the server 400 from the user terminal 300a and reserves the commodity 104 (hot snack) present in the store.

The screen data generation unit 444 of the server 400 generates the commodity purchase screen based on the store inventory list specified by the store ID (S180). Then, the screen data transmitting unit 462 transmits the data of the generated storage arrangement screen to the user terminal 300a (S182).

The image output unit 334 displays the commodity purchase screen. The purchasable commodity 104 (hot snack) is displayed on the commodity purchase screen. When the user 122 selects the commodity 104 and touches the reservation button on the commodity purchase screen, the operation receiving unit 322 specifies the commodity ID corresponding to the commodity 104 to be reserved (S184). The request transmitting unit 362 transmits the reservation request including the commodity ID and storage device ID to the server 400.

When the request receiving unit 474 of the server 400 receives the reservation request, the ticket generation unit 446 generates the electronic ticket for the user 122 who has reserved the commodity 104 (S186). Then, the ticket transmitting unit 464 transmits the electronic ticket to the storage device 100e and the user terminal 300a (S188).

When the ticket receiving unit 272 of the storage device 100e receives the electronic ticket, the ticket list management unit 252 adds the received electronic ticket to the ticket list. Further, when the ticket receiving unit 374 of the user terminal 300a receives the electronic ticket, the electronic ticket is stored in the ticket memory unit 382.

After the processing of S188, the reservation notification transmitting unit 452 transmits the reservation notification to the store terminal 700 (S192). The reservation notification includes the type and quantity of electronic tickets and reserved commodities (hot snacks).

When the reservation notification receiving unit 774 of the store terminal 700 receives the reservation notification, the transaction management unit 744 registers the reservation information in the reservation table (S194). The reservation table has records for each purchase reservation. The record stores the reservation information such as the reservation ID, the type and quantity of commodities, the user ID, the selling price, the electronic ticket ID, the storage device ID, and the take-out state.

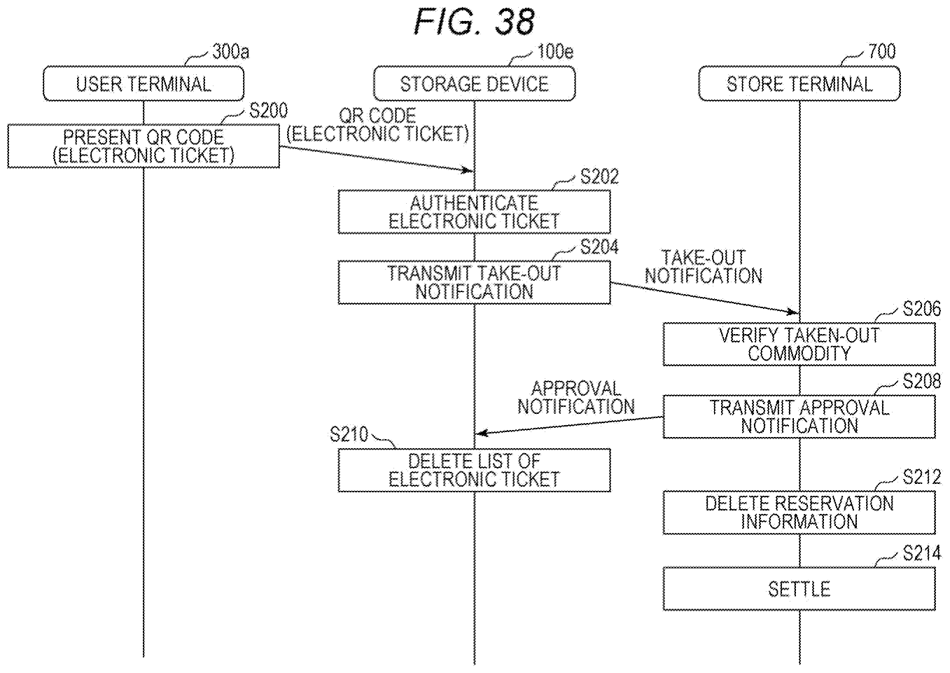

FIG. 38 is a sequence diagram when the user 122 takes out the purchased commodity 104 from the storage device 100e.

When the operation receiving unit 322 of the user terminal 300a receives the operation of the display instruction of the QR code, the ticket output unit 332 converts the electronic ticket stored in the ticket memory unit 382 into the figure of the QR code and displays the converted electronic ticket on the display (S200). The user 122 holds the displayed QR code over the ticket reader 114 of the storage device 100e.

When the ticket reading unit 222 of the storage device 100e reads the QR code (electronic ticket), the ticket authentication unit 242 authenticates the read electronic ticket (S202). When the authentication succeeds and the user 122 takes out the commodity 104 and closes the door 102, the take-out notification transmitting unit 264 transmits the take-out notification to the store terminal 700 (S204). The take-out notification includes the type and quantity of taken-out commodities 104 (hot snacks) and the used electronic ticket.

When the take-out notification receiving unit 776 of the store terminal 700 receives the take-out notification, the commodity verification unit 746 determines whether the type and quantity of taken-out commodities 104 (hot snacks) are valid from the storage device 100e (S208). Specifically, the commodity verification unit 746 refers to the ticket table to specify the user ID corresponding to the electronic ticket, and furthermore refers to the reservation table to specify the type and quantity of commodities corresponding to a set of storage device ID and user ID corresponding to a transmission source of the take-out notification. This commodity ID corresponds to the type and quantity of commodities reserved by user 122. If the type and quantity of commodities match, the commodity reserved by the user 122 is taken out, and therefore the verification succeeds. On the other hand, if the type and quantity of commodities do not match, it means that the reserved commodity is not taken out correctly, and therefore the verification fails. If the verification fails, the approval/disapproval notification transmitting unit 764 transmits the disapproval notification to the storage device 100e and returns to the processing of S204.

On the other hand, if the verification succeeds, the approval/disapproval notification transmitting unit 764 of the store terminal 700 transmits a notification indicating approval to the storage device 100e (S208).

When the approval/disapproval notification receiving unit 274 of the storage device 100e receives the notification indicating approval, the ticket list management unit 252 deletes the used electronic ticket from the ticket list (S210).

Following the processing of S208, the reservation notification receiving unit 774 of the store terminal 700 deletes the reservation information of the reservation table (S212). Then, the settlement unit 748 performs the settlement processing (S214).

[Modification 9]

The pre-purchase may be performed, instead of the reservation in Modification 8. This transaction mode is called a “pre-purchase method of a store commodity”.

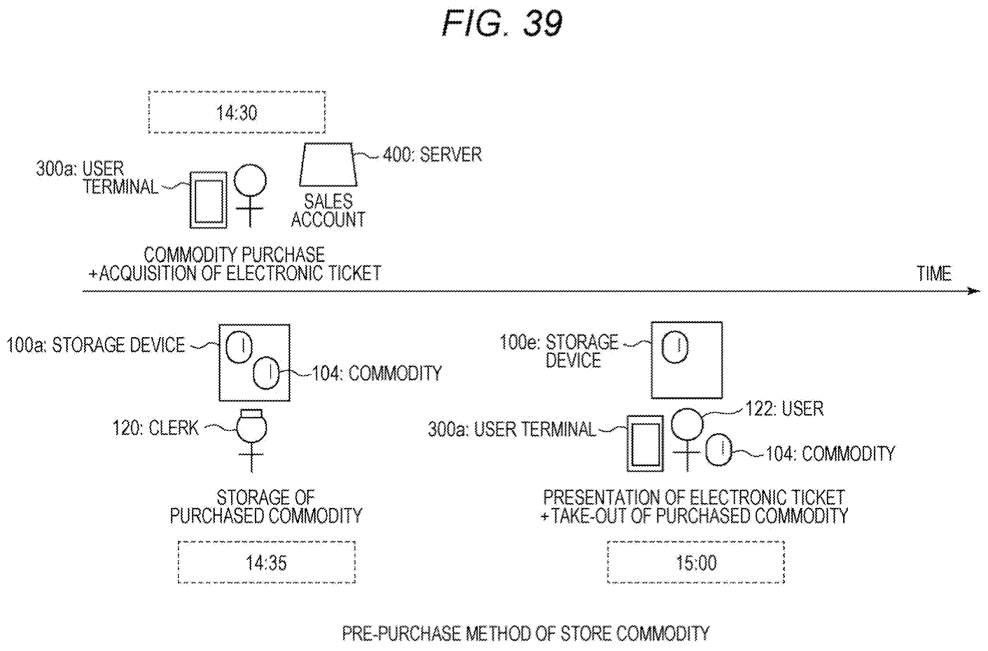

FIG. 39 is a schematic diagram illustrating a pre-purchase method of a store commodity.

At 14:30, the user 122 reserves the commodity 104. At this point, no sales are counted. The work at 14:35 is the same as the case of FIG. 36. At 15:00, when the user 122 takes out the commodity 104, sales are calculated.

In the case of Modification 8, instead of the process shown in S192 of FIG. 37, the purchase notification transmitting unit (not illustrated) of the server 400 transmits the purchase notification to the store terminal 700 (S192). The purchase notification includes the electronic ticket and the type and quantity of purchased commodities (hot snacks).

In the case of Modification 8, when the purchase notification receiving unit (not illustrated) of the store terminal 700 receives the purchase not instead of the processing shown in S194 of FIG. 37, the settlement unit 748 of the store terminal 700 performs the settlement processing.

In the case of Modification 8, the settlement processing shown in S214 of FIG. 38 is not performed.

### [Modification to Authenticate Ticket on Server 400]

In the embodiment and the above-mentioned Modification, an example of performing the ticket authentication in the storage device 100 is shown. Specifically, the ticket reading unit 222 of the storage device 100 reads the electronic ticket (S10 in FIG. 4), and the ticket authentication unit 242 of the storage device 100 authenticates the electronic ticket (S12 in FIG. 4). To authenticate the ticket, the storage device 100 has a ticket list memory unit 282 (FIG. 3).

However, it may be modified to perform the ticket authentication of the server 400, instead of the storage device 100. That is, the server 400 may manage the ticket list of each storage device 100 and centrally authenticate the electronic ticket.

In this modification, the ticket list memory unit 282 is omitted from the functional blocks of the computer 200 of the storage device 100 illustrated in FIG. 3. Instead, the server 400 has a ticket list memory unit (not illustrated) that stores ticket lists corresponding to each storage device 100.

Changes in the operation process of the storage device 100 illustrated in FIG. 4 will be described.

The ticket authentication (S12) illustrated in FIG. 4 is omitted, and instead, the transmission of the electronic ticket and the reception of the authentication result are added. The ticket deletion (S34) is also omitted.

In this Modification, the server 400 has the ticket list management unit (not illustrated) that manages the ticket list, the ticket receiving unit (not illustrated) that receives the electronic ticket, the ticket authentication unit (not illustrated) that authenticates the electronic ticket, and the authentication result transmitting unit (not illustrated) that transmits the authentication result of the electronic ticket. Further, the storage device 100 has the ticket transmitting unit (not illustrated) that transmits the electronic ticket and the authentication result receiving unit (not illustrated) that receives the authentication result of the electronic ticket.

Hereinafter, the process of adding the electronic ticket to the ticket list of the server 400, the process of performing the ticket authentication of the server 400, and the process of deleting the electronic ticket of the ticket list of the server 400 will be described in order. Here, changes will be described based on the embodiment, but the ticket authentication may be performed of the server 400 in Modifications 1 to 5 described above, or the like.

Changes related to the addition of the electronic ticket be described with reference to the sequence when the user terminal 300a is operated to make the pre-purchase (FIG. 20).

The transmission of the electronic ticket of the server 400 (S58) will be omitted. Also, the registration of the electronic ticket list in the storage device 100a (S60) will also be omitted. Instead, after the generation of the electronic ticket (S56), the ticket list management unit (not illustrated) of the server 400 registers the electronic ticket list. That is, the ticket list management unit adds the generated electronic ticket to the ticket list corresponding to the storage device 100a. The same applies to other Modifications such as the pre-reservation method.

Changes related to the ticket authentication are described with reference to the sequence when the pre-purchased commodity 104 is taken out from the storage device 100a (FIG. 21).

The authentication of the electronic ticket in the storage device 100a (S72) will be omitted. Instead, after the storage device 100a receives the electronic ticket from the user terminal 300a, the ticket transmitting unit (not illustrated) of the storage device 100a transmits the electronic ticket to the server 400. When the ticket receiving unit (not illustrated) of the server 400 receives the electronic ticket, the ticket authentication unit (not illustrated) of the server 400 authenticates the received electronic ticket. If any of the electronic tickets included in the ticket list corresponding to the storage device 100a, which is the transmission source of the electronic ticket, matches the received electronic ticket, the authentication succeeds. On the other hand, if the received electronic tickets do not match any of the electronic tickets included in the ticket list corresponding to the storage device 100a, the authentication fails. The authentication result transmitting unit (not illustrated) of the server 400 transmits the authentication result to the storage device 100a (transmission source of the electronic ticket). The authentication result receiving unit (not illustrated) of the storage device 100a receives the authentication result, and the storage device 100a performs the processing after S74 based on the received authentication result. The same applies to other Modifications such as the pre-reservation method.

Subsequently, changes related to the deletion of the electronic ticket will be described with reference to FIG. 21.

The deletion of the electronic ticket in the storage device 100a (S82) will be omitted. Then, after transmitting the approval notification from the server 400 to the storage device 100a, the ticket list management unit 252 of the server 400 deletes the successfully authenticated electronic ticket from the ticket list corresponding to the storage device 100a (transmission source of the electronic ticket). The same apples to other Modifications such as the pre-reservation method.

[Composite Method 1]

As composite method 1, the “pre-purchase method of the in-storage commodity” (embodiment) and the “arbitrary purchase method of the in-storage commodity” (Modification 2 or Modification 3) may be realized together.

When the user 122 takes out the commodity 104 that he/she has pre-purchased, it is processed by the “pre-purchase method of the in-storage commodity”. When the user 122 takes out the commodity 104 that no one has pre-purchased, it is processed by the “arbitrary purchase method of the in-storage commodity”. Also, when the user 122 takes out the commodity 104 pre-purchased by another person, a warning message or a warning sound is emitted.

[Composite Method 2]

As composite method 2, the “pre-reservation method of the in-storage commodity” (Modification 1) and the “arbitrary purchase method of the in-storage commodity” (Modification 2 or Modification 3) may be realized together.

When the user 122 takes out the commodity 104 that he/she has pre-reserved, it is processed by the “pre-reservation method of the in-storage commodity”. When the user 122 takes out the commodity 104 that no one has pre-reserved, it is processed by the “arbitrary purchase method of the in-storage commodity”. Also, when the user 122 takes out the commodity 104 pre-reserved by another person, a warning message or a warning sound is emitted.

[Composite Method 3]

As composite method 3, the “pre-purchase method of the in-storage commodity” (embodiment) and the “pre-reservation method of the in-storage commodity” (Modification 1) and the “arbitrary purchase method of the in-storage commodity” (Modification 2 or Modification 3) may be realized together.

When the user 122 takes out the commodity 104 that he/she has pre-purchased, it is processed by the “pre-purchase method of the in-storage commodity”. When the user 122 takes out the commodity 104 that he/she has pre-reserved, it is processed by the “pre-reservation method of the in-storage commodity”. When the user 122 takes out the commodity 104 that no one has pre-purchased and pre-reserved, it is processed by the “arbitrary purchase method of the in-storage commodity”. Also, when the user 122 takes out the commodity 104 pre-purchased or pre-reserved by another person, a warning message or a warning sound is emitted.

[Storage Body]

The storage device 100 described in the embodiment and Modification described above is an example of the storage body that houses an article such as the commodity 104 and operates to deliver the article to the user. The storage body may be a device such as the storage device 100, an area in a building such as a room, or a facility such as a store. Hereinafter, an example of the storage body will be described.

[Multi-Door Storage Device 100]

Although FIG. 1 illustrates a form in which there is one door 102, the storage device 100 may have a plurality of doors 102. A housing space having a shelf and a camera 110 may be formed in the back of each door 102 as in FIG. 1 The boundary of the housing space may be separated by a wall material with a vent, and a single temperature adjusting device 112 may be able to adjust the temperature and humidity of all housing spaces.

The ticket reader 114, the opening/closing sensor 106, and the lock mechanism 108 are provided for each door 102, but the computer 200 and the speaker 116 may be one each.

[Storage Room]

The storage body may be a room having the function of storing the commodity 104 and delivering the commodity 104 to the user 122. This room is called a “storage room”. The storage room can serve as an alternative to, for example, a stall in a school, a retail store in a station, or a vending machine corner in a building.

As in the case of the embodiment and the above-mentioned Modification, the user 122 browses the commodity 104 in the storage room, makes a pre-purchase, pre-reservation, or the like by using the user terminal 300. The user 122 can take out the pre-purchased or pre-reserved commodity 104, the optionally selected commodity 104, and the like from the storage room in place of the storage device 100. However, it is assumed that one person enters a room to take out the commodity 104.

A plurality of shelves for placing commodity 104 are provided inside the storage room. As in the case of the storage device 100, the commodity 104 provided on the shelf is photographed by the camera installed above the shelf. The space in the storage room is adjusted by the temperature adjusting device 112, and as in the case of the storage device 100, the computer 200 controls the operation. The computer 200 has an automatic door control unit (not illustrated) as a functional module.

The operation of the storage room will be described with reference to FIG. 4, which illustrates the operation of the storage device 100.

It is assumed that operations such as the pre-purchase or the pre-reservation have been completed as in the case of the embodiment and the above-mentioned Modification. The user 122 who comes to the storage room holds the QR code of the electronic ticket over the ticket reader 114 installed outside the automatic door. As a result, the ticket reading unit 222 detects the reading of the electronic ticket by the ticket reader 114 (S10), and the ticket authentication unit 242 authenticates the read ticket (S12).

As in the case of the storage device 100, the internal commodity detection (S14) illustrated in FIG. 4 is performed. Then, instead of the unlocking (S16), the automatic door control unit (not illustrated) instructs the automatic door to open. When the user 104 enters the room, the automatic door closes as a normal operation. At this time, instead of the door opening detection (S18), the entry/exit, sensor (not illustrated) detects the entry of the user 122, and the automatic door control unit (not illustrated) instructs the automatic door to lock the door.

In the storage room, a user 104 seeks out the pre-purchased or pre-reserved commodity 104 and picks the commodity 104 up. In the case of the arbitrary purchase method, the user 104 selects the desired commodity 104 and picks the commodity 104 up. Then, the user 104 goes straight to the inside of the automatic door as it is.

When the entry/exit sensor detects a person (user 104) inside the automatic door instead of the door closing detection (120), the commodity detection unit 244 detects the housed commodity 104 inside the storage room at that time. Then, the commodity detection unit 244 calculates a difference from the commodity 104 detected in S14.

As in the case of the storage device 100, the take-out notification transmitting unit 264 transmits the take-out notification to the server 400 (S24), and the approval/disapproval notification receiving unit 274 receives the approval/disapproval notification from the server 400 (S26). If the approval/disapproval notification indicates a disapproval, the warning output unit 232 outputs a warning (S30).

On the other hand, when the received approval/disapproval notification indicates approval, the automatic door control unit (not illustrated) instructs the automatic door to unlock and open the door instead of the locking (S32). When the user 104 enters the room, the automatic door closes as a normal operation. At this time, when the entry/exit sensor (not illustrated) detects the exit of a person (user 104), the ticket is deleted as in the case of the storage device 100 (S34).

[Unmanned Store (Commodity Check Machine Type)]

An unmanned store has the function of storing the commodity 104 and delivering the commodity 104 to the user 122, and can be regarded as a kind of storage body. As in the case of the embodiment and the above-mentioned Modification, the user 122 browses the commodity 104 in the unmanned store, makes a pre-purchase, pre-reservation, or the like by using the user terminal 300. However, the user 122 can take out the pre-purchased or pre-reserved commodity 104, the optionally selected commodity 104, and the like from the unmanned store in place of the storage device 100.

The unmanned store in the commodity check machine type is provided with the commodity check machine that checks the taken-out commodity 104 by the user 122. The commodity check machine is installed near an entrance door, reads the barcode of the commodity 104 that the user 122 finally tries to take out, and is used to determine whether the taken-out commodity 104 is appropriate. The commodity check machine may also serve as a self-checkout or a semi-self-checkout.

The movement of the user 122 and the operation of the commodity check machine type in the unmanned store of the commodity check machine type will be described.

It is assumed that operations such as the pre-purchase or the pre-reservation have been completed as in the case of the embodiment and the above-mentioned Modification. When the user 122 taking out the pre-purchased or the pre-reserved commodity 104 or an arbitrary commodity 104 enters the unmanned store, the entry check or the like is not performed. The user 122 who freely enters the store takes the pre-purchased or pre-reserved commodity 104, or an optionally selected commodity 104, and goes to the commodity check machine to operate the commodity check machine by himself/herself.

Similar to the storage device 100, the commodity check machine includes a ticket reader 114, a speaker 116, and a computer 200. The commodity check machine does not have a function of storing a commodity, and therefore does not have a door 102, a camera 110, an opening/closing sensor 106, a lock mechanism 108, and a temperature adjusting device 112. The commodity check machine includes a barcode reader (not illustrated) to detect the taken-out commodity 104. The barcode reader reads the commodity barcode 118 attached to the taken-out commodity 104 to specify the commodity ID. A graphic code such as a QR code may be read instead of the commodity barcode 118. In addition, a tag reader that receives the commodity ID transmitted from the IC tag attached to the commodity 104 may be used. The ticket reader 114 may also serve as a barcode reader, or the barcode reader may be provided separately from the ticket reader 114. The barcode reader may be built into the housing of the commodity check machine, or may be a handheld one connected by a cord. The commodity check machine also includes a display (for example, a liquid crystal display). Further, the computer 200 of the commodity check machine has an operation guide display processing unit (not illustrated) as a function module that performs a process of displaying a message that guides the operation method to the user.

The operation of the commodity check machine will be described with reference to FIG. 4, which illustrates the operation of the storage device 100.

The operation guide display processing unit (not illustrated) of the computer 200 of the commodity check machine displays, for example, a message, for example, “Please hold an electronic ticket of a smartphone over the ticket reader” on the display in the standby state.

The user 122 who comes to the commodity check machine with the commodity 104 operates the user terminal 300 to display the QR code of the electronic ticket and holds the QR code over the ticket reader 114 of the storage device 100. As a result, the ticket reading unit 222 detects the reading of the electronic ticket by the ticket reader 114 (S10), and the ticket authentication unit 242 authenticates the read ticket (S12). The ticket authentication method is the same as the case of the storage device 100. As described above, the server 400 may perform the ticket authentication. When the authentication fails, no further processing is performed. When the authentication fails, the warning output unit 232 may output a warning message or a warning sound. When the authentication succeeds, the operation guide display processing unit (not illustrated) may display a message such as “Hold the commodity barcode over the barcode reader.” or “Read the commodity barcode with the barcode reader.” on the display.

The commodity check machine does not perform the operations corresponding to the internal commodity detection (S14), the unlocking (S16), the door opening detection (S18), and the door closing detection (S20) illustrated in FIG. 4.

The commodity check machine detects the taken-out commodity in S22 in a different way than in the case of storage device 100. When the user 122 holds the commodity barcode 118 of the taken-out commodity 104 over the barcode reader, the commodity detection unit 244 detects the commodity barcode 118 read by the barcode reader and specifies the commodity ID.

Similar to the case of the storage device 100, the take-out notification transmitting unit 264 of the computer 200 in the storage device 100 transmits the take-out notification to the server 400 (S24). The take-out notification includes the data of the commodity barcode 118 of the taken-out commodity 104 and the used electronic ticket.

Similar to the case of the storage device 100, the approval/disapproval notification receiving unit 274 of computer 200 of the storage device 100 receives the approval/disapproval notification from the server 400 (S26). If the approval/disapproval notification indicates a disapproval, the warning output unit 232 outputs a warning (S30). When the taken-out commodity 104 is not appropriate, a warning message or a warning sound, for example, “This commodity cannot be taken out. Please put the commodity back on the shelf.” is emitted.

On the other hand, if the received approval/disapproval notification indicates approval, the ticket is deleted as in the case of the storage device 100 (S34). Note that in the commodity check machine, there is no operation corresponding to the unlocking (S32) illustrated in FIG. 4.

[Unmanned Store (Automatic Check Method)]

Instead of placing the commodity check machine in the unmanned store, the image photographed in the unmanned store may be analyzed to link the user 122 and the commodity 104. In this way, the commodity 104 can be checked automatically.

The automatic check method unmanned store is equipped with a large number of surveillance cameras that photographs pictures of the inside of the store from various angles. Each surveillance camera provides the photographed video to the computer 200. In addition, a gate equipped with a ticket reader 114 will be provided at the entrance of the unmanned store. The computer 200 has a tracking processing unit (not illustrated), an action detecting unit (not illustrated), and a commodity specification unit (not illustrated).

The movement of the user 122 and the movement of the computer 200 in the unmanned store of the automatic check method will be described with reference to FIG. 4 illustrating the movement of the storage device 100.

It is assumed that operations such as the pre-purchase or the pre-reservation have been completed as in the case of the embodiment and the above-mentioned Modification. The user 122 who comes to the automatic check method unmanned store first operates the user terminal 300 to display the QR code of the electronic ticket, and holds the QR code over the ticket reader 114 of the gate. As a result, the ticket reading unit 222 detects the reading of the electronic ticket by the ticket reader 114 (S10), and the ticket authentication unit 242 authenticates the read ticket (S12). The ticket authentication method is the same as the case of the storage device 100. As described above, the server 400 may perform the ticket authentication. When the authentication fails, no further processing is performed. When the authentication fails, the warning output unit 232 may output a warning message or a warning sound such as “This ticket cannot be used”.

The internal commodity detection (S14) and the door opening detection (S18) illustrated in FIG. 4 are omitted. Instead of the unlocking (S16), the gate opens. As a result, the user 122 can enter the store. Further, at this point, the user ID of the user 122 who entered the store is specified in the computer 200.

The tracking processing unit tracks the user 122 based on the video photographed by the surveillance camera installed at the entrance, and specifies the position of the user 122 in the store at any time. When the user 122 moves to the photographing range of another surveillance camera, the tracking of the user 122 is continued based on the video photographed by the surveillance camera, and the position of the user 122 in the store is continuously specified. This process continues until the user 122 goes out of the store.

The action detection unit detects that the commodity take-out action has been performed from the behavior of the user 122 taken in the video. The action detection unit (not illustrated) determines, for example, that a commodity take-out action has been taken if a hand of the user 122 reaches the shelf and then something is held in the hand.

When the commodity take-out action is performed, the commodity specification unit performs the process of specifying the taken-out commodity by the user 122. The commodity specification unit determines which commodity 104 is taken out by matching, for example, the object in the hand of the user 122 in the video with the sample image of each commodity 104 in the store. Alternatively, the commodity specification unit may determine that the commodity 104 present in the position where the user 122 has reached out has been taken out because the commodity 104 has disappeared from the video. Then, the taken-out commodity ID is stored as a commodity list corresponding to the user ID.

In this way, the user 104 seeks out the pre-purchased or pre-reserved commodity 104 and picks the commodity 104 up. In the case of the arbitrary purchase method, the user 104 selects the desired commodity 104 and picks the commodity 104 up. Similarly, the commodity ID of any of the commodities 104 is added to the commodity list as well. Then, the user 104 goes out of the unmanned store. The user 104 does not have to co through the gate when he/she exits. At this time, the tracking processing unit detects the exit of the user 104 instead of the door closing detection (S20) illustrated in FIG. 4.

As in the case of the storage device 100, the take-out notification transmitting unit. 264 transmits the take-out notification to the server 400 (S24), and the approval/disapproval notification receiving unit 274 receives the approval/disapproval notification from the server 400 (S26). In the automatic check method unmanned store, it is assumed that at least the arbitrary purchase method will be adopted, so the approval will not be denied. As a general rule, as an acknowledgment from the server 400, the approval/disapproval notification indicating approval arrives. However, when the user 104 does not take out the pre-purchased commodity or does not take out the pre-reserved commodity, a notification (for example, including a message such as “Please bring the pre-purchased XX (commodity name) “or” Please bring the pre-booked XX (commodity name)”) of caution may be transmitted from the server 400 to the user terminal 300.

The locking (S32) illustrated in FIG. 4 is omitted. When the user 104 exits, the ticket is deleted as in the case of the storage device 100 (S34).

When the plurality of users 104 visit the store, each user 104 is processed in parallel.

That is, for each user 104, the tracking processing, the action detection processing, the commodity identification processing, and the like are performed at the same time.

[Manned Store]

Similar to the unmanned store, a manned store has the function of storing the commodity 104 and delivering the commodity 104 to the user 122, and therefore, can be regarded as a kind of storage body. Similar to the unmanned store, the manned store may be a commodity check machine type or an automatic check method.

In the case of the manned store, the clerk may perform the operation of reading the commodity barcode 118 of the commodity 104 on the commodity check machine. The clerk may reserve the commodity 104 pre-purchased or pre-reserved by user 122. In addition, the clerk may also deliver the commodity 104, which is not placed in the shelf, to the user 122. In addition to self-checkout and semi-self-checkout, the commodity check machine may also serve as a point of sale (POS) checkout.

[Reservation Type that does not Limit Storage Device 100]

A group to which a plurality of storage devices 100 belong may be regarded as a virtual store, and the reserved commodity may be taken out from any storage device 100 belonging to the virtual store.

For example, a user may have reserved the commodity 104 present in a neighboring storage device 100 (ST-A), but it is considered that situations change and a user wants to take the commodity 104 from another storage device 100 (ST-B). According to this method, in such a case, the reserved commodity may be taken out from other than the reserved storage device 100 (ST-A).

Specifically, when a reservation is received for the commodity 104 of the storage device 100 (ST-A), the ticket transmitting unit 464 of the server 400 transmits the electronic ticket not only to the storage device 100 (ST-A) but also to other storage devices 100 (ST-B) and storage devices 100 (ST-C) in the group. The information on the storage device 100 belonging to the same group is stored in the group memory unit (not illustrated) of the server 400.

When the ticket receiving unit 272 of the storage device 100 (ST-B) receives the electronic ticket, the ticket list management unit 252 adds the received electronic ticket to the ticket list. The same applies to the storage device 100 (ST-C).

If the reserved commodity is taken out on a storage device 100 (ST-B) other than an initially reserved storage device 100 (ST-A), the reserved commodity is processed as the pre-purchase. Also, when the take-out notification receiving unit 476 of the server 400 receives the take-out notification transmitted from the storage device 100 (ST-B) from which the reserved commodity was taken out, the cancellation notification transmitting unit (not illustrated) of the server 400 transmits the cancellation notification for the electronic ticket included in the take-out notification to other storage device 100 (ST-A) and storage device 100 (ST-C) that belongs to the same group as the storage device 100 (ST-B) that is the transmission source of the take-out notification. The cancellation notification includes the electronic ticket to be canceled.

When the cancellation notification receiving unit (not illustrated) of the storage device 100 (ST-A) receives the cancellation notification, the ticket list management unit 252 deletes the same electronic ticket as the electronic ticket included in the cancellation notification from the ticket list. The same applies to the storage device 100 (ST-C).

As described above, the server 400 may perform the ticket authentication. In that case, the ticket list of the originally reserved storage device 100 (ST-A) is updated in the server 400, and the ticket lists of the storage device 100 (ST-B) and storage device 100 (ST-C) in the same group are also updated.

The storage device 100 within a geographically close range may be grouped, or the storage device 100 storing the same kind of commodity 104 may be grouped. Also, all the storage devices 100 operated by the same operator may be grouped together.

For the initially reserved storage device 100 (ST-A), the take-out of the reserved commodity by anyone other than a reservation person is restricted, and for the other storage device 100 (ST-B) and storage device 100 (ST-C), the reserved commodity may be handled as a tentative reservation, and thus a person other than the reservation person can freely take out the reserved commodity.

[Modification 10]

A user 122 may pay for the commodity 104 stored in the storage device 100 for another user 122. In the following, the user 122 who is a paying side is referred to as a payer, and the user 122 who is a side requesting to pay is referred to as a payee. In this example, the payer is “Taro Yamada” and uses the user terminal 300a. The payee is “Hanako Nomura” and uses a user terminal 300b. The payer operates the user terminal 300a to specify the payee and sets a payment amount. The payee can get the commodity 104 housed in the storage device 100 within the range of the set payment amount.

In Modifications 10 to 12, a payment mechanism using the storage device 100 will be described. The payment mechanism diversifies the usage patterns of the storage device 100 and activates the commodity transaction using the storage device 100.

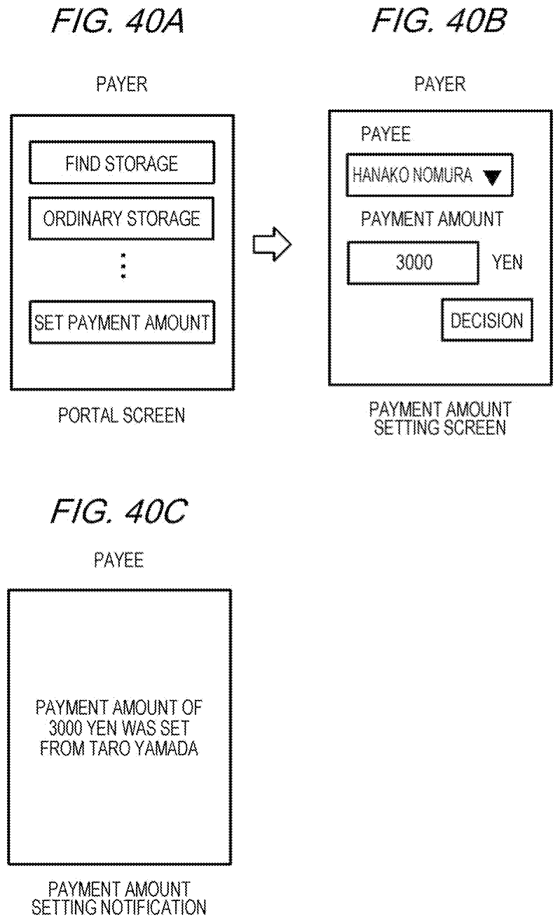

FIG. 40A is an example of a portal screen.

When accessing the server 400 from the user terminal 300a of the payer, a portal screen including a payment amount setting button is displayed. When the payer touches the payment amount setting button, the switching to the payment amount setting screen is made.

FIG. 40B is a diagram illustrating an example of a payment amount setting screen.

The payment amount setting screen includes a selection area of a payee selection area and an input area of a payment amount. The payer selects a payee from among the users 122 who are registered as a friend in advance, and inputs the payment amount. When the payer touches a determination button, payment amount setting information that specifies the payee and the payment amount is confirmed. Then, the payment amount setting screen is transmitted to the user terminal 300b of the payee. The notification method includes a push notification, a social networking service (SNS) message transmitting function, e-mail, and the like.

FIG. 40C is a diagram illustrating an example of a payment amount setting notification.

The message “payment amount of 3000 yen has been set by Mr. Taro Yamada” is displayed on the user terminal 300b of the payee by the payment amount setting screen.

As a module configuration, the user terminal 300 has an event transmitting unit (not illustrated), a payment setting information transmitting unit (not illustrated), a notification receiving unit (not illustrated), and a message display unit (not illustrated).

The event transmitting unit transmits various events to the server 400. The payment setting information transmitting unit transmits the payment amount setting information to the server 400. The notification receiving unit receives various notifications from the server 400. The message display unit displays various messages.

The server 400 includes an event receiving unit (not illustrated), a payment setting information receiving unit (not illustrated) (e.g., a payment amount setting information receiving unit that receives the user who is a payee and payment amount setting information including payment amount from a terminal of the payer), a notification transmitting unit (not illustrated), a payment setting information registration unit (not illustrated), a payment amount setting table memory unit (not illustrated), and a settlement unit (not illustrated) (e.g., a settlement unit that executes settlement processing of allowing a payer linked with the user to pay for the article).

The event receiving unit receives various events from the user terminal 300. The payment setting information receiving unit receives payment setting information from the user terminal 300. The notification transmitting unit transmits various notifications to the user terminal 300. The payment setting information registration unit registers the received payment amount setting information in the payment amount setting table. The payment amount setting table memory unit stores the payment amount setting table. The settlement unit performs the settlement processing.

A specific processing operation will be described. The account information transmitting unit 366 of the user terminal 300a of the payer transmits the account information (user ID and password) to the server 400.

When the account information receiving unit 479 of the server 400 receives the account information, the user authentication unit 443 of the server 400 performs the user authentication. If the user authentication succeeds, the screen data transmitting unit 462 of the server 400 transmits data of the portal screen to the user terminal 300a.

When the screen data receiving unit 372 of the user terminal 300a of the payer receives the data or the portal screen, the screen output unit 334 of the user terminal 300a displays the portal screen. When the operation receiving unit 322 of the user terminal 300a receives the touch of the payment amount setting button, the event transmitting unit of the user terminal 300a transmits a request event of the payment amount setting screen to the server 400.

When the event receiving unit of the server 400 receives the request event of the payment amount setting screen, the screen data transmitting unit 462 of the server 400 transmits the data of the payment amount setting screen to the user terminal 300a. The data of the payment amount setting screen includes the name and user ID of the user 122 who is registered as a friend.

When the screen data receiving unit 372 of the user terminal 300a of the payer receives the data of the payment amount setting screen, the screen output unit 334 of the user terminal 300a displays the payment amount setting screen. The operation receiving unit 322 of the user terminal 300a displays the name of the user 122 registered as a friend as a candidate and receives the selection of the payee. Further, the operation receiving unit 322 of the user terminal 300a receives the input of the payment amount. Then, when the operation receiving unit 322 of the user terminal 300a receives the touch of the payment amount setting button, the payment setting information transmitting unit of the user terminal 300a transmits the payment amount setting information including the payee user ID (hereinafter referred to as “payee ID”) and the payment amount to the server 400.

When the payment setting information receiving unit (e.g., a payment amount setting information receiving unit that receives the user who is a payee and payment amount setting information including payment amount from a terminal of the payer) of the server 400 receives the payment amount setting information, the payment setting information registration unit of the server 400 registers the received payment amount setting information in the payment amount setting table.

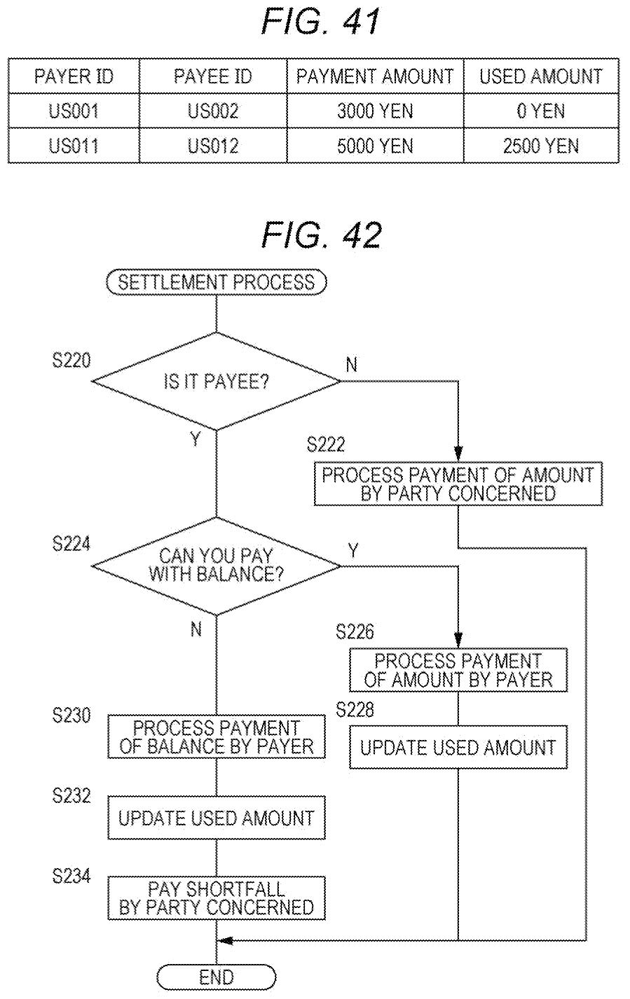

FIG. 41 is a data structure diagram of the payment amount setting table.

The payment amount setting table has a record for each received payment amount setting information. The record associates a payer ID, a payee ID, a payment amount, and a usage amount. US001 of the payer ID of the first record is a user ID of “Taro Yamada”, and the US002 of the payee ID is a user ID of “Hanako Nomura”. The usage amount indicates the total amount of money paid instead by using payment.

Subsequently, the notification transmitting unit of the server 400 transmits the payment amount setting screen to the user terminal 300b of the payee.

When the notification receiving unit of the user terminal 300b of the payee receives the payment amount setting screen, the message display unit of the user terminal 300b displays the message set in the payment amount setting screen.

FIG. 42 is a flowchart illustrating the process of settlement processing.

In Modification 10, the embodiment or Modifications 1 to 3 are applied as basic processing, and the settlement processing illustrated below is further performed. The settlement processing is performed for each record in a sales table (FIG. 16). The user ID in the sales table indicates the user 122 who collects the commodity. The settlement unit of the server 400 determines whether the user ID of the sales table corresponds to any of the payee IDs set in the payment amount setting table (S220).

If the user ID of the sales table does not correspond to any payee ID (N in S220), the settlement unit of the server 400 performs full payment processing by a person concerned (S222). Specifically, the settlement unit performs prepaid or postpaid electronic payment, cash payment, or the like based on the settlement information (for example, a user number of electronic money or a user number of a credit card) linked with the user ID of the sales table. In the case of prepaid payment, the user 122 is charged in advance. A method of coping with an insufficient charge amount in prepaid payment or a method of coping with account-withdrawal inability from a bank account may be the same as the conventional technology.

If the user ID of the sales table corresponds to the payee ID (Y in S220), the settlement unit of the server 400 determines whether a balance of an amount paid instead is equal to or greater than the selling price of the commodity (S224). The balance of the deposit is calculated as a difference obtained by subtracting the usage amount from the payment amount corresponding to the payee ID. The selling price of the commodity is read from the sales table.

If it determines that the balance of an amount paid instead is greater than or equal to the selling price of the commodity (Y in S224), the settlement unit of the server 400 performs full payment processing by a payer (S226) (e.g., a settlement unit that executes settlement processing of allowing a payer linked with the user to pay for the article). Specifically, the settlement unit performs prepaid or postpaid electronic settlement, cash payment, or the like as described above based on the settlement information linked with the payer ID corresponding to the payee ID. Then, the settlement unit adds the selling price to the usage amount corresponding to the payee ID (S228).

If it determines that the balance of the deposit is less than the selling price of the commodity (N in S224), the settlement unit of the server 400 processes the payer payment processing of the balance of the deposit (S230). Then, the settlement unit makes the usage amount the same as the payment amount and invalidates the payment amount setting information (S232). In addition, the settlement unit performs shortfall payment processing by a person concerned (S234). The shortfall is the difference obtained by subtracting the balance of the deposit from the selling price of the commodity.

Although the example of the storage device 100 is illustrated here, Modification 10 may be applied to other storage bodies (for example, a storage room, an unmanned store, a manned store, or the like).

[Modification 11]

A payee may first purchase the commodity 104 housed in the storage device 100, and then may request a user 122 who is registered as a friend to pay. Hereinafter, the user 122 who requests to pay is referred to as a person who requests to pay. The user 122 who request to pay is called a payer candidate. In this example, a person who requests to pay is “Hanako Nomura” and uses the user terminal 300b. The payer candidate is “Taro Yamada” and uses the user terminal 300a.

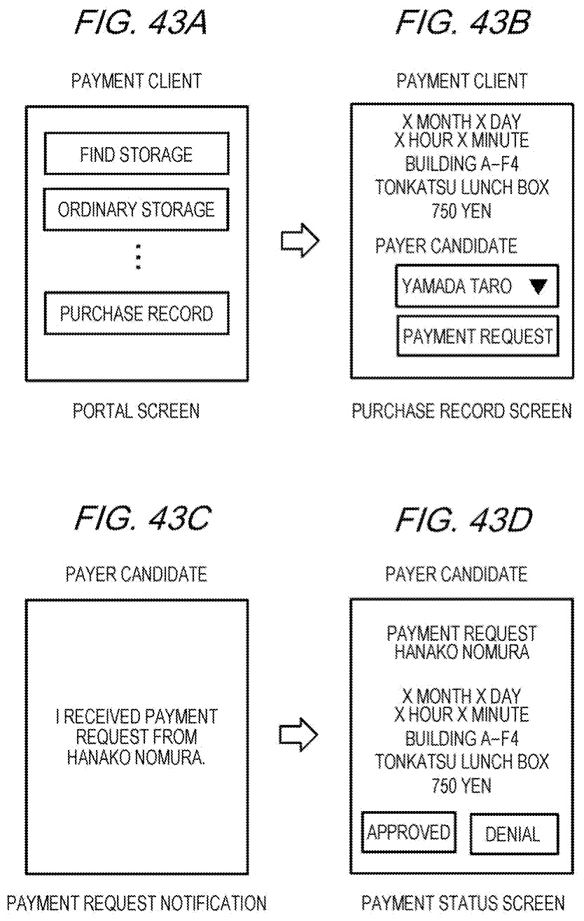

FIG. 43A is an example of a portal screen.

When the server 400 is accessed from the user terminal 300b of a person who requests to pay, a portal screen including a purchase record button is displayed. When the payer touches the purchase recording button, the switching to the purchase record screen is performed.

FIG. 43B is a diagram illustrating an example of a purchase record screen.

The purchase record screen displays the purchase record of commodities from the storage device 100 by the purchase client. In this example, the purchase date and time “x month x day x hour x minute”, the storage name “building A-F4”, the purchased commodity name “tonkatsu lunch box” and the purchase price “750 yen” are displayed. The purchase record screen includes a selection area of a payer candidate. The person who requests to pay selects a payer candidate from the user 122 who is registered as a friend in advance. When the payer touches a payment request button, a payment request notification is transmitted to the payer candidate user terminal 300a. The notification method includes a push notification, an SNS message transmitting function, e-mail, or the like.

FIG. 43C is a diagram illustrating an example of a payment request notification.

The message “a request to pay is received from Hanako Nomura” is displayed on the user terminal 300a of the payer candidate by the payment request notification.

FIG. 43D is a diagram illustrating an example of a payment approval/disapproval screen.

The payer candidate can access the server 400 from the user terminal 300a and answer the approval or disapproval of the payment request. The payment approval/disapproval screen shows the details of the payment request. Specifically, the person who requests to pay “Hanako Nomura”, the date and time of purchase, the storage name, the purchased commodity name, and the purchase price are displayed. When the payer candidate touches the approval button, the payment request is approved and the payer candidate becomes a payer. When the payer candidate touches the disapproval/approval button, the payment request is disapproved and the payer candidate is not a payer.

As a module configuration, the server 400 has a payer information registration unit (not illustrated) and an approval/disapproval information registration unit (not illustrated).

The payer information registration unit registers the payer candidate ID as the payer ID in the record corresponding to the purchase record in the sales table in an unapproved state. The approval/disapproval information registration unit switches an approval flag of the record corresponding to the purchase record in the sales table.

A specific processing operation will be described. The account information transmitting unit 366 of the user terminal 300b of the person who requests to pay transmits the account information (user ID and password) to the server 400.

When the account information receiving unit 479 of the server 400 receives the account information, the user authentication unit 443 of the server 400 performs the user authentication. If the user authentication succeeds, the screen data transmitting unit 462 of the server 400 transmits the data of the portal screen to the user terminal 300b.

When the screen data receiving unit 372 of the user terminal 300b of the person who requests to pay receives the data of the portal screen, the screen output unit 334 of the user terminal 300b displays the portal screen. When the operation receiving unit 322 of the user terminal 300b receives the touch of the purchase recording button, the event transmitting unit of the user terminal 300a transmits the request event of the payment amount screen to the server 400.

When the event receiving unit of the server 400 receives the request event of the purchase record screen, the screen data transmitting unit 462 of the server 400 transmits the data of the purchase record screen to the user terminal 300b. The data of the purchase record screen includes the name and user ID of the user 122 who is registered as a friend.

When the screen data receiving unit 372 of the user terminal 300b of the person who requests to pay receives the data of the purchase record screen, the screen output unit 334 of the user terminal 300b displays the purchase screen. The operation receiving unit 322 of the user terminal 300b displays the name of the user 122 registered as a friend as a candidate and receives the selection of the payer candidate. Then, when the operation receiving unit 322 of the user terminal 300b receives the touch of the payment request button, the event transmitting unit of the user terminal 300b transmits the event of the request to pay to which the user ID (payer candidate ID) of the payer candidate is added to the server 400.

When the event receiving unit of the server 400 receives the event of the payment request, the payer information registration unit of the server 400 registers the payer candidate ID as the payer ID in the record corresponding to the purchase record in the sales table in an unapproved state.

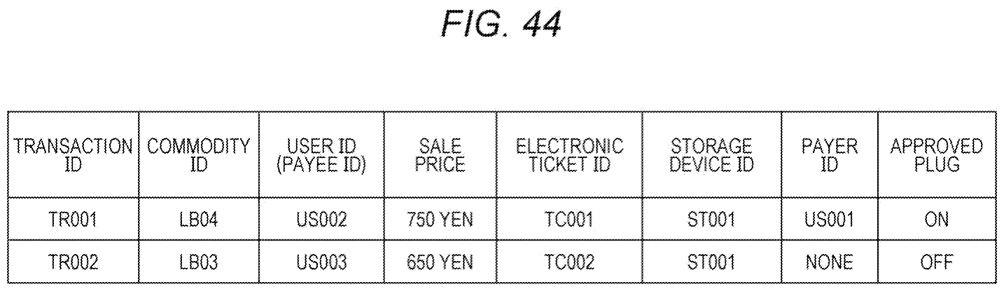

FIG. 44 is a data structure diagram of the sales table.

The sales table has records for each sales transaction. In addition to the above items such as a transaction ID, a commodity ID, a user ID, a selling price, an electronic ticket ID, and a storage device ID, the record stores the payer ID and the approval flag. The value of the approval flag is OFF. When the payment request is approved, the approval flag is turned ON. The user ID of the payer candidate is set in the payer ID. If the payment request is approved, the user ID corresponds to the payee ID.

Subsequently, the notification transmitting unit of the server 400 transmits the payment request notification to the user terminal 300a of the payer candidate.

When the notification receiving unit of the user terminal 300a of the payer candidate receives the payment request notification, the message display unit of the user terminal 300a displays the message set in the payment request notification.

After that, the account information transmitting unit 366 of the user terminal 300a transmits the account information (user ID and password) to the server 400 by the operation of the payer candidate who answers the approval or disapproval of the payment request.

When the account information receiving unit 479 of the server 400 receives the account information, the user authentication unit 443 of the server 400 performs the user authentication. If the user authentication succeeds, the screen data transmitting unit 462 of the server 400 transmits the data of the payment approval/disapproval screen to the user terminal 300a.

When the screen data receiving unit 372 of the user terminal 300a receives the data of the payment approval/disapproval screen, the screen output unit 334 of the user terminal 300a displays the payment approval disapproval screen. When the operation receiving unit 322 of the user terminal 300a receives the touch of the approval button, the event transmitting unit of the user terminal 300a transmits the approval event to the server 400. On the other hand, when the operation receiving unit 322 of the user terminal 300a receives the touch of the disapproval button, the event transmitting unit of the user terminal 300a transmits the disapproval event to the server 400.

When the event receiving unit of the server 400 receives the approval event, the approval/disapproval information registration unit of the server 400 turns on the approval flag of the record corresponding to the purchase record in the sales table. On the other hand, when the event receiving unit of the server 400 receives the disapproval event, the approval/disapproval information registration unit of the server 400 turns off the approval flag of the record corresponding to the purchase record in the sales table.

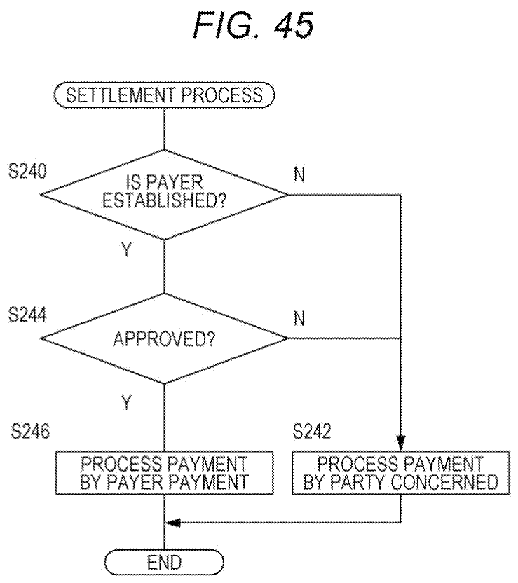

FIG. 45 is a flowchart illustrating the process of settlement processing.

In Modification 11, the embodiment or Modifications 1 to 3 are applied as basic processing, and the settlement processing illustrated below is further performed. The settlement processing is performed for each record in a sales table (FIG. 16). The user ID in the sales table indicates the user 122 who collects the commodity. If the user 122 requests a treat, this user ID indicates a person who requests to pay. That is, the user ID may correspond to the person ID who requests to pay

The settlement unit of the server 400 determines whether or not the payer ID is set in the record of the sales table (S240). If the payer ID is not set (N of S240), the settlement unit performs the payment processing of the person concerned of the selling price set in the record of the sales table (S242). Specifically, the settlement unit performs prepaid or postpaid electronic settlement, cash payment, or the like as described above based on the settlement information linked with the user ID of the sales table. This corresponds to the normal self-payment.

If the payer ID is set (Y in S240), the settlement unit of the server 400 determines whether or not the approval flag is ON (S244). If the approval flag is ON (Y in S244), the settlement unit performs the payer payment processing of the selling price (S246) (e.g., the settlement unit executes the settlement processing when the payer approves payment of a price of the article). Specifically, the settlement unit performs prepaid or postpaid electronic settlement, cash payment, or the like as described above based on the settlement information linked with the payer ID. When the approval flag is OFF (N in S244), the payment processing of the sales price by the person concerned is performed (S242).

Although the example of the storage device 100 is illustrated here, Modification 11 may be applied to other storage bodies (for example, a storage room, an unmanned store, a manned store, or the like).

[Modification 12]

When a user 122 likes a commodity that he or she has purchased from the storage device 100, he or she may recommend the same commodity 104 to another user 122. In the following, the user 122 who is a payer is referred to as a recommended payer, and the user 122 who is a payee is referred to as a recommended payee. In this example, the recommended payer is “Taro Yamada” and uses the user terminal 300a. The recommended payee is “Hanako Nomura” and uses the user terminal 300b. The recommended payer performs an operation to recommend the commodity 104 to the recommended payee in relation to his/her purchase history. The recommended payee can go out by himself/herself and take out the same commodity 104 present in the storage device 100 and get the commodity 104.

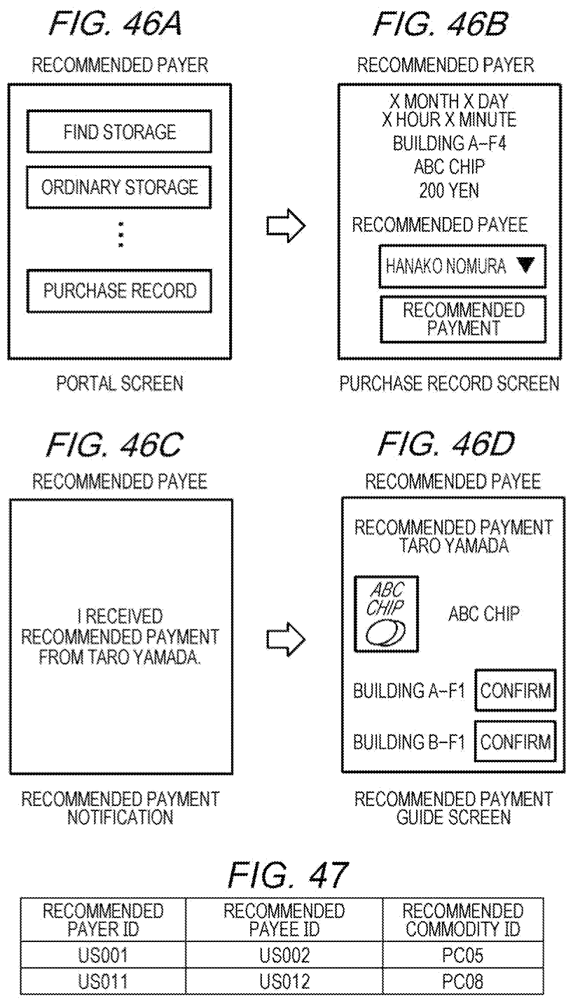

FIG. 46A is an example of the portal screen.

When accessing the server 400 from the user terminal 300a of the recommended payer, the portal screen including the purchase recording button is displayed. When the recommended payer touches the purchase recording button, the switching to the purchase record screen is performed.

FIG. 46B is a diagram illustrating an example of the purchase record screen.

The purchase record screen displays the purchase record of commodities from the storage device 100 by the recommended payer. In this example, the purchase date and time “x month x day x hour x minute”, the storage name “building A-F4”, the purchased commodity name “ABC chips”, and the purchase price “200 yen” are displayed. The purchase record screen includes a selection area of the recommended payee. The recommended payer selects the recommended payee from the user 122 who is registered as a friend in advance. When the recommended payer touches the recommended payment button, the recommended payment notification is transmitted to the user terminal 300b of the recommended payee. The notification method includes a push notification, an SNS message transmitting function, e-mail, or the like.

FIG. 46C is a diagram illustrating an example of a recommended payment notification.

On the user terminal 300b of the recommended payee, the message “recommended payment is received from Mr. Taro Yamada” is displayed on the user terminal 300b of the recommended payee by the recommended payment notification.

FIG. 46D is a diagram illustrating an example of a recommended payment guidance screen.

The recommended payee can access the server 400 from the user terminal 300b and check the recommended payment. The contents of the recommended payment are displayed on the recommended payment guidance screen. In this example, the recommended payer “Taro Yamada”, the recommended commodity name “ABC Chips” and the inventory storage name “Building A-F1” and “Building B-F1” are displayed. The inventory storage name indicates the storage device 100 near the recommended payee that houses the recommended commodities (e.g., a screen transmitting unit that transmits screen data including information on the storage body housing the article recommended by the payer to a user terminal). When the recommended payee touches the confirmation button corresponding to the inventory storage name, the storage confirmation screen illustrated in FIG. 11 is displayed.

When the recommended payee goes to the storage device 100 by referring to the recommended payment guidance screen and takes out the recommended commodity from the storage device 100, the price is paid by the recommended payer.

As the module configuration, the user terminal 300 has a recommended payment information transmitting unit (not illustrated).

The recommended payment information transmitting unit transmits recommended payment information including the user 113 (hereinafter referred to as “recommended payee ID”) of the recommended payee to the server 400.

The server 400 has a recommended payment information receiving unit (not illustrated), a recommended payment table memory unit (not illustrated), and a storage search unit (not illustrated).

The recommended payment information receiving unit receives the recommended payment information from the user terminal 300. The recommended payment table memory unit stores the recommended payment table. The storage search unit searches for the storage device 100 which is close to the position of the user 122 and houses the recommended commodity.

A specific processing operation will be described. The account information transmitting unit 366 of the user terminal 300a of the recommended payer transmits the account information (user ID and password) to the server 400.

When the account information receiving unit 479 of the server 400 receives the account information, the user authentication unit 443 of the server 400 performs the user authentication. If the user authentication succeeds, the screen data transmitting unit 462 of the server 400 transmits data of the portal screen to the user terminal 300a.

When the screen data receiving unit 372 of the payer user terminal 300a of the recommended payer receives the portal screen data, the screen output unit 334 of the user terminal 300a displays the portal screen. When the operation receiving unit 322 of the user terminal 300a receives the touch of the purchase recording button, the event transmitting unit of the user terminal 300a transmits the request event of the purchase record screen to the server 400.

When the event receiving unit of the server 400 receives the request event of the purchase record screen, the screen data transmitting unit 462 of the server 400 transmits the data of the purchase record screen to the user terminal 300a. The data of the purchase record screen includes the name and user ID of the user 122 who is registered as a friend.

When the screen data receiving unit 372 of the user terminal 300a of the recommended payer receives the data of the purchase record screen, the screen output unit 334 of the user terminal 300a displays the purchase record screen. The operation receiving unit 322 of the user terminal 300a displays the name of the user 122 registered as a friend as a candidate and receives the selection of the recommended payee. Then, when the operation receiving unit 322 of the user terminal 300a receives the touch of the recommended payment button, the recommended payment information transmitting unit of the user terminal 300a transmits the recommended payment information including the recommended payee ID to the server 400.

When the recommended payment information receiving unit of the server 400 receives the recommended payment information, the recommended payment information registration unit of the server 400 registers the received recommended payment information in the recommended payment table.

FIG. 47 is a data structure diagram of a recommended payment table.

The recommended payment table has records for each recommended payment information. The record is associated with a recommended payer ID, a recommended payee ID, and a recommended commodity ID. In this example, US001 of the recommended payer ID of the first record is the user ID of “Taro Yamada”. Similarly, US002 of the recommended payee ID is the user ID of “Tanaka Nomura”.

Subsequently, the notification transmitting unit of the server 400 transmits the recommended payment notification to the user terminal 300b of the recommended payee.

When the notification receiving unit of the user terminal 300b of the recommended payee receives the recommended payment notification, the message display unit of the user terminal 300b displays the message set in the recommended payment notification.

Thereafter, the account information transmitting unit 366 of the user terminal 300b transmits the account information (user ID and password) to the server 400 by the operation of the recommended payee confirming the recommended payment.

When the account information receiving unit 479 of the server 400 receives the account information, the user authentication unit 443 of the server 400 performs the user authentication. When the user authentication succeeds, the storage search unit of the server 400 searches for storage device 100, which is close to the location of user 122 and houses the recommended commodity. For example, the storage device 100 near a work location or near a home becomes a target. Alternatively, the current position measured by the user terminal may be acquired and the storage device 100 near the position may be selected. The screen data transmitting, unit 462 (e.g., a screen transmitting unit that transmits screen data including information on the storage body housing the article recommended by the payer to a user terminal) of the server 400 transmits the data of the recommended payment guidance screen to the user terminal 300b. The data of the storage confirmation screen is added to the data of the storage confirmation screen.

When the screen data receiving unit 372 of the user terminal 300b receives the data of the recommended payment guidance screen, the screen output unit 334 of the user terminal 300b displays the recommended payment guidance screen. When the operation receiving unit 322 of the user terminal 300b receives the touch of the confirmation button, the screen output unit 334 of the user terminal 300b displays the storage confirmation screen.

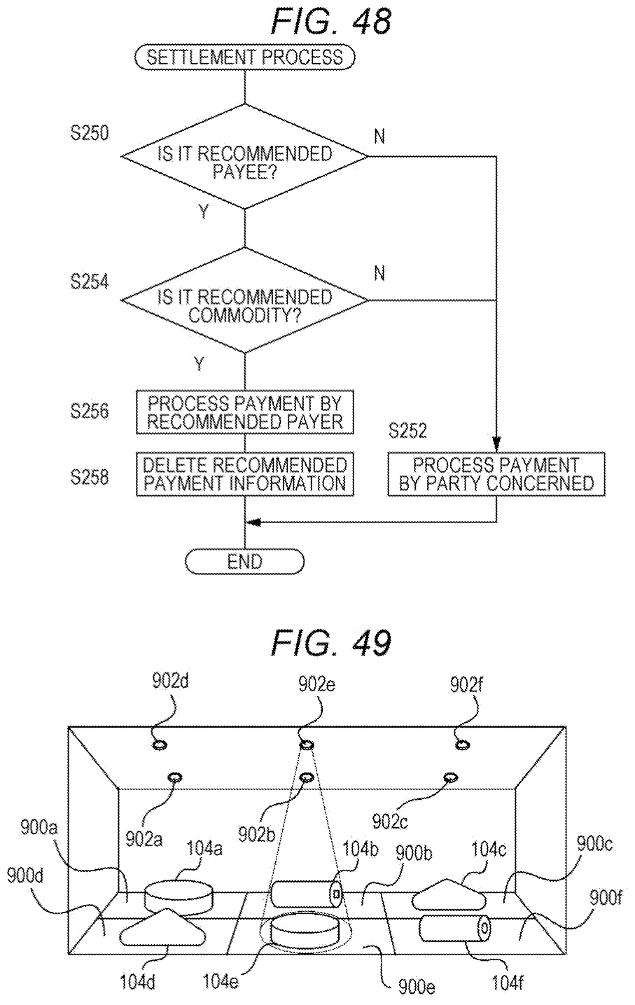

FIG. 48 is a flowchart illustrating the process of settlement processing.

In Modification 12, the embodiment or Modifications 1 to 3 are applied as basic processing, and the settlement processing illustrated below is further performed. The settlement processing is performed for each record in a sales table (FIG. 16). The user ID in the sales table indicates the user 122 who collects the commodity. When the user 122 receives the recommended payment, this user ID indicates the recommended payee. That is, the user ID may correspond to the recommended payee ID.

The settlement unit of the server 400 determines whether the user ID of the sales table corresponds to any of the recommended payee IDs set in the recommended payment table (S250).

If the user ID of the sales table does not correspond to any of the recommended payee IDs (N in S250), the settlement unit of the server 400 handles all payments by a person concerned (S252).

If the user ID of the sales table corresponds to the recommended payee ID (Y in S250), it is determined whether the commodity ID of the sales table matches the recommended commodity ID corresponding to the recommended payee ID (S254). If the commodity ID of the sales table does not match the recommended commodity ID (N in S254), the settlement unit of the server 400 performs full payment processing by a person concerned (S252).

On the other hand, if the commodity ID in the sales table matches the recommended commodity ID (Y in S254), the settlement unit of the server 400 perform the recommended payer payment processing (S256). Specifically, the settlement unit performs prepaid or postpaid electronic settlement, cash payment, or the like as described above based on the settlement information linked with the recommended payer ID. Then, the settlement unit deletes the record of the sales table and the recommended payment information that matches the recommended payee and the recommended commodity (S258).

In the example of the settlement processing illustrated in FIG. 48, the purchasing user 122 (person) pays for the commodity 104 other than the recommended commodity. In other words, in Modification 12, the commodity 104 other than the recommended commodity cannot be bought. However, the processing of Modification 10 that can be bought within the set amount is applied to Modification 12, and the commodity 104 other than the recommended commodity may be bought. For example, in the example described in FIG. 46, even it the user 122 purchases the commodity 104 other than “ABC chips”, he/she can pay for any commodity 104 up to a price “200 yen” of ABC chips.

A specific example of applying the processing of Modification 10 to Modification 12 will be described. As a user interface, the operation processing of the user terminal 300 described with reference to FIG. 46 of Modification 12 is performed. On the display, the “ABC chips” is recommended as the commodity 104, but as the payment condition, it means that the payment amount is set to the same amount as the price “200 yen” of “ABC chips”. Therefore, a record is added to the payment amount setting table described in FIG. 41 of Modification 10. In this example, the record in which the payer ID is US001 (“Taro Yamada”), the payee ID is US002 (“Hanako Nomura”), the payment amount is 200 yen (the price of “ABC Chips”), and the usage amount is 0 yen is set. Then, the settlement processing described in FIG. 42 of Modification 10 is performed. In this way, even if the payee (“Hanako Nomura”) purchases the commodity 104 other than the recommended commodity “ABC Chips”, the payer (“Taro Yamada”) pays within the same amount of 200 yen as “ABC Chip”.

Up to this point, an example has been shown in which the same commodity as the purchased commodity is the recommended commodity, but the commodity similar to the purchased commodity may be handled as the recommended commodity. It is assumed that the similarity relationship of the commodity is set in advance.

In addition, when the recommended commodity is not in the storage device 100 near the user 122, the server 400 may transmit to the user terminal 300 the notification that recommends commodities 104 (for example, the same or similar commodity 104 as or to the recommended commodity) other than the recommended commodities among the commodities 104 present in the storage device 100. At that time, the server 400 may select and recommend a commodity with a price equal to or less than the recommended commodity.

Although the example of the storage device 100 is illustrated here, Modification 12 may be applied to other storage bodies (for example, a storage room, an unmanned store, a manned store, or the like).

[Modification 13]

In the case of the “pre-purchase method of the in-storage commodity” described in the embodiment, the user 122 takes out the pre-purchased commodity 104 from among the plural types of commodities 104 housed in the storage device 100. In addition, in the case of the “pre-reservation method of the in-storage commodity” described in Modification 1, the user 122 takes out the pre-reserved commodity 104 from among the plural types of commodities 104 housed in the storage device 100. However, it is possible that the user 122 may make a mistake in determining which commodity 104 to take out.

Also, in the case of the “arbitrary purchase method of the in-storage commodity” described in Modification 2 and Modification 3, the user 122 can take out any commodity 104 from among the plural types of commodities 104 housed in the storage device 100. However, when realized in combination with the “pre-purchase method of the in-storage commodity” or the “pre-reservation method of the in-storage commodity”, it is assumed that the storage device 100 includes the commodity pre-purchased or pre-reserved by others. In such cases, the user 122 of the “arbitrary purchase method of the in-storage commodity” does not take out the commodity 104 pre-purchased or pre-reserved by others.

In Modification 13, the commodity pre-purchased by the user 122 in the “pre-purchase method of the in-storage commodities” can be easily discriminated in this way, and the commodity pre-reserved by the user 122 in the “pre-reservation method of the in-storage commodity” can be easily discriminated. The user 122 of the “arbitrary purchase method of the in-storage commodity” can easily discriminate the commodity 104 excluding the commodity pre-purchased or pre-reserved by others.

Specifically, the pre-purchased or pre-reserved commodity to be taken out by the user 122 is illuminated to be easily discriminated. In addition, the commodity 104 that may be taken out by the user 122 who purchases optionally can be illuminated to be easily discriminated.

FIG. 49 is a configuration diagram of a shelf of the storage device 100.

The lower plane (floor surface) of the shelf space is an installation surface of the commodity 104 and is divided into a plurality of areas 900. The clerk is operated to install one commodity 104 in one area 900.

In this example, each commodity 104a to 100f is installed in each of the six areas 900a to 900f. The correspondence between the areas 900a to 900f and the commodities 104a to 104f specified by analyzing an image of a lower part of the shelf space photographed by the camera 110. The image analysis reads, for example, a barcode or a two-dimensional barcode, or pattern matching based on the appearance of commodities, and the like.

A light 902 (e.g., a lighting device that separately illuminates the housed articles) is provided at positions facing each of the plurality of areas 900 on an upper plane (ceiling surface) of the shelf space. In this example, lights 902a to 900f are provided at positions facing the six areas 900a to 900f. Then, the lights 902a to 902f can irradiate visible light toward the opposite areas 900a to 900f, respectively. This will illuminate the desired commodity 104. All of the plurality of shelves has the same configuration.

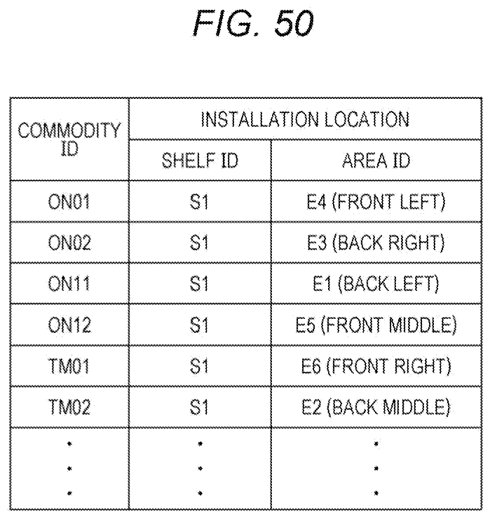

FIG. 50 is a data structure diagram of a commodity arrangement table.

The correspondence between the areas 900a to 900f and the commodities 104a to 104f specified by the image analysis is stored in the commodity arrangement table memory unit provided in the computer 200 of the storage device 100. The commodity arrangement table has records for each housed commodity 104. The record associates the commodity IDs, the shelf IDs, and the area IDs. The installation location of the commodity 104 is specified by the shelf ID and the area ID. In addition, the light 902 that illuminates the commodity is specified by the shelf ID and the area ID. In this example, the commodity of one shelf is focused, but the commodity of the other shelf is handled the same.

The information on the pre-purchased and pre-reserved commodities is managed by the server 400. The server 400 can transmit the information on the pre-purchased and pre-reserved commodities to the storage device 100 to determine which of the lights 902 on the storage devices 100 turns on (e.g., the lighting device illuminates an article pre-purchased or pre-reserved by the user).

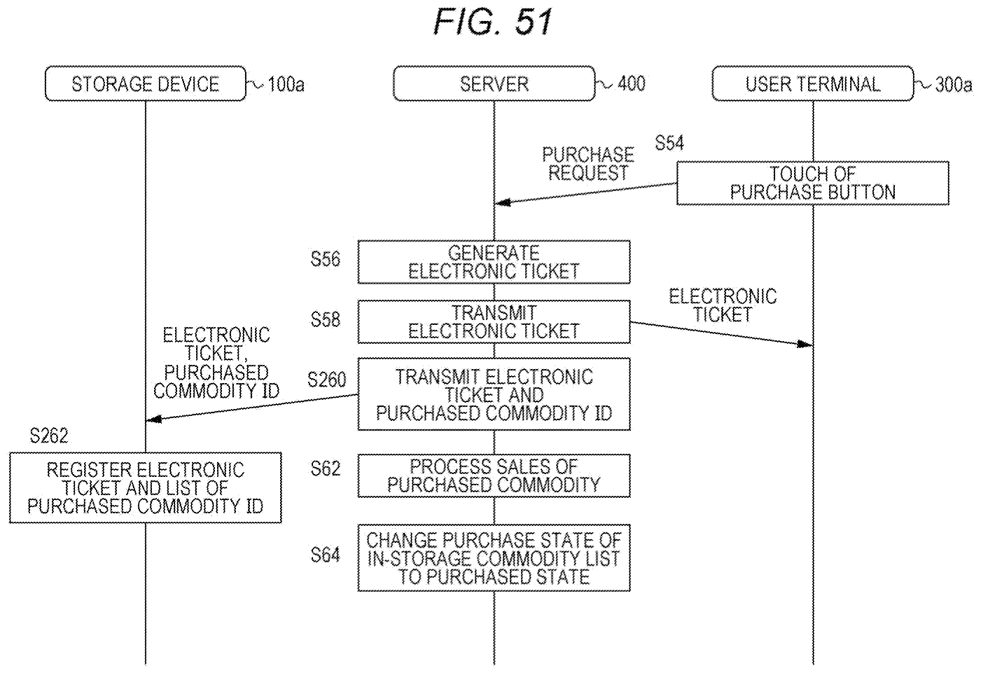

FIG. 51 is a sequence diagram including a step of transmitting the purchased commodity ID from the server 400 to the storage device 100.

FIG. 51 is based on FIG. 20 of the “Pre-purchase method of the in-storage commodity”. The difference from FIG. 20 will be described. The process up to S56 is the same as the case of FIG. 20. In S58, the ticket transmitting unit 464 transmits the electronic ticket to the user terminal 300.

The process of S260 is added. In the S260, the ticket transmitting unit 464 transmits the electronic ticket data and the purchased commodity ID to the storage device 100a. Instead of S60 in FIG. 20, in S262, the ticket list management unit 252 of the computer 200 of the storage device 100a adds the received electronic ticket data and the purchased commodity ID to the ticket list. The process after S62 is the same as the case of FIG. 20.

In the case of the “pre-reservation method of the in-storage commodity”, the ticket transmitting unit 464 transmits the electronic ticket data and the reserved commodity ID to the storage device 100a. The ticket list management unit 252 of the computer 200 of the storage device 100a adds the received electronic ticket data and the reserved commodity ID to the ticket list.

In the case of the “arbitrary purchase method of the in-storage commodity”, the ticket transmitting unit 464 transmits only the electronic ticket data to the storage device 100a. The ticket list management unit 252 of the computer 200 of the storage device 100a adds only the received electronic ticket data to the ticket list.

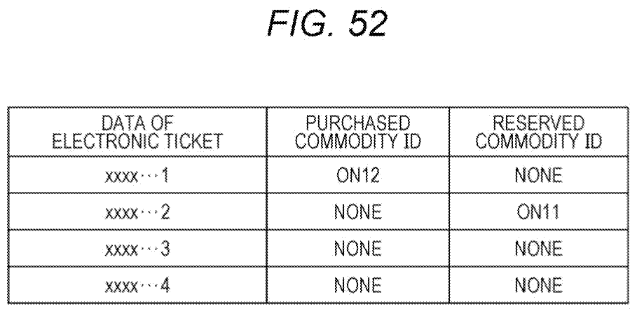

FIG. 52 is a data structure diagram of a ticket list in Modification 13.

The ticket list has records for each electronic ticket. The record associates the electronic ticket data, the purchased commodity ID, and the reserved commodity ID. In the case of the “pre-purchase method of the in-storage commodity”, the purchased commodity ID is set in association with the electronic ticket data. In the case of the “pre-purchase method of the in-storage commodity”, the reserved commodity ID is set in association with the electronic ticket data. In the case of the “arbitrary purchase method of the in-storage commodity”, the electronic ticket data is set, and the purchased commodity ID and the reserved commodity ID are not set.

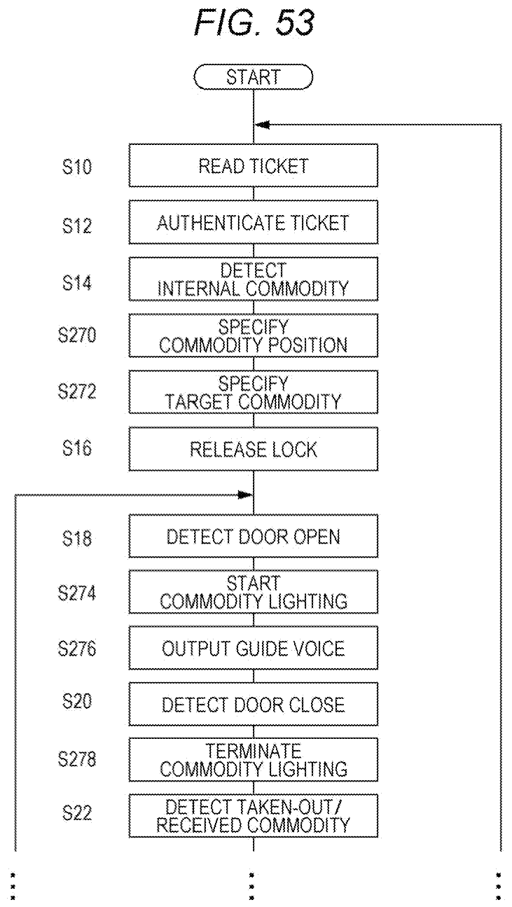

FIG. 53 is a flowchart illustrating an operation process of the storage device 100 in Modification 13.

As the module configuration, the computer 200 of the storage device 100 has a lighting control unit (not illustrated) and a guide audio output unit (not illustrated).

The lighting control unit controls the lighting and extinguishing of the light 902. The guide voice output unit outputs the guide voice.

FIG. 53 is based on FIG. 4. The difference from FIG. 4 will be described. The processing up to S14 is the same as the case of FIG. 4.

The processing of S270 is added. The commodity detection unit 244 specifies the arrangement location of the detected commodities. Specifically, the shelf ID and the area ID are specified. The specified shelf ID and area ID are set in the commodity arrangement table (FIG. 50).

The processing of S272 is added. The lighting control unit of the computer 200 of the storage device 100 specifies the commodity 104 to be illuminated. Specifically, when the purchased commodity ID is associated with the electronic ticket authenticated in S12, the lighting control unit specifies the lighting target by the purchased commodity ID. When the reserved commodity ID is associated with the electronic ticket authenticated in S12, the lighting control unit specifies the lighting target by the reserved commodity ID (e.g., the lighting device illuminates an article pre-purchased or pre-reserved by the user). When neither the purchased commodity ID nor the reserved commodity ID is associated with the electronic ticket authenticated in S12, the lighting control unit illuminates commodity IDs that correspond to neither the purchased commodity ID nor the reserved commodity ID included in the ticket list, among the commodity IDs in the in-storage commodity list (FIG. 14) (e.g., the lighting device illuminates an article pre-purchased or pre-reserved by a person other than the user).

When the door opening is detected in S18, the lighting control unit turns on the light 902 specified by the shelf ID and the area ID corresponding to the commodity ID to be illuminated. At this time, the guide audio output unit of the storage device 100 outputs the guide voice from the speaker 116 (S276). If the electronic ticket is associated with the purchased commodity ID or the reserved commodity ID, a guide voice such as “Please take the illuminated commodity” is output. If neither the purchased commodity ID nor the reserved commodity ID is associated with the electronic ticket, a guide voice such as “Please select from the illuminated commodities” is output.

When the door closing is detected in S20, the lighting control unit turns off the light 902 that had been turned on. The processing after S22 is the same as the case of FIG. 4.

The light 902 may have a function of changing a direction of irradiating light. The lighting control unit may direct the light 902 toward the area where the commodity 104 to be illuminated is located to irradiate the light.

Although the example of the storage device 100 is illustrated here, Modification 13 may be applied to other storage bodies (for example, a storage room, an unmanned store, a manned store, or the like).

[Modification 14]

The storage device 100 may be installed in a car to be moved. Further, in the server 400, the inventories of the stationary storage device 100 described above and the mobile storage device 100 described in Modification 14 may be collectively managed to be useful for dynamic commodity arrangement.

In addition, the commodity may be delivered to the user 122 by a storage-equipped vehicle 910 equipped with the mobile storage device 100, or the commodity may be delivered to the stationary storage device 100. The commodity 104 may be moved back and forth between the mobile storage devices 100.

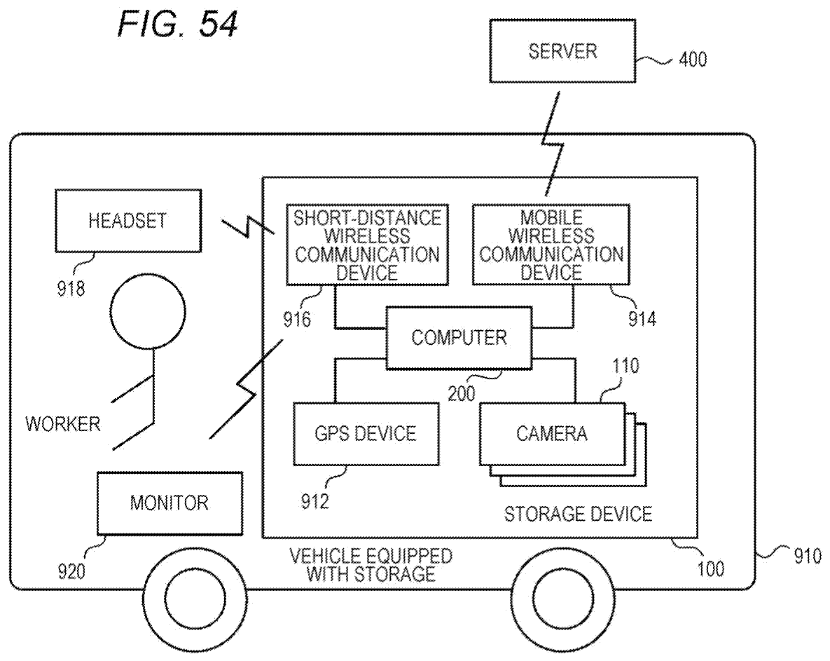

FIG. 54 is a configuration diagram of the storage-equipped vehicle 910 in Modification 14.

The storage-equipped vehicle 910 is equipped with the mobile storage device 100. In addition to the computer 200 and camera 110 described above, the mobile storage device 100 includes a global positioning system (GPS) device 912, a mobile wireless communication device 914, and a short-range wireless communication device 916. The GPS device 912 is an example of a current position measuring device used for measuring the current position of the mobile storage device 100. The mobile wireless communication device 914 is used for communication with the server 400. The short-range wireless communication device 916 is used for communication with a headset 918 and a monitor 920 used by a worker who also serves as a driver.

The computer 200 of the storage-equipped vehicle 910 has a position notification unit (not illustrated) and an inventory list transmitting unit (not illustrated).

The position notification unit notifies the server 400 of the current position measured by the GPS device 912. As described in the embodiment, the server 400 manages the in-storage commodity list, but the inventory list of commodities housed in the storage device 100 may be transmitted from the mobile storage device 100 to the server 400. To this end, the commodity detection unit 244 detects the housed commodity 104 internally at this time, and the inventory list transmitting unit transmits the commodity ID of the detected commodity 104 to the server 400. The inventory list transmitting unit may simultaneously transmit the inventory list to the server 400 along with the current position of the storage device 100. If transmitted at the same time, there is no time lag between the current position and the inventory list, so the location of the commodity 104 can be grasped more accurately. For the notification of the current position and the transmission of the inventory list, the stationary storage device 100 may also operate in the same manner with the same configuration.

The server 400 has an inventory management unit (not illustrated) (e.g., an inventory management unit that manages an inventory of the article housed in the stationary storage body and an inventory of the article housed in the mobile storage body). The inventory manager can grasp the inventory state of the stationary storage device 100 and the inventory state of the mobile storage device 100 based on the inventory list of each storage device 100 managed by the inventory management unit of the server 400. Then, when instructing the worker to move the commodity 104 or enter or exit the commodity 104 in the storage device 100, the server 400 may transmit the work instruction to the mobile storage device 100. The instructions received by the mobile storage device 100 are output from one or both of the headset 918 and the monitor 920 via the short-range wireless communication device 916. The instruction by the voice is output from the headset 918, and the instruction by the screen display is output to the monitor 920. The response of the worker is input to the headset 918 by the voice and transmuted to the server 400 via the mobile wireless communication device 914. According to this configuration, the storage-equipped vehicle 910 does not include a GPS device or a communication device. Therefore, a vehicle that can be used as the storage-equipped vehicle 910 is optional. In addition, it is not necessary for the server 400 to manage the association between the mobile storage device 100 and the storage-equipped vehicle 910. As a result, the cost of the system or management can be reduced.

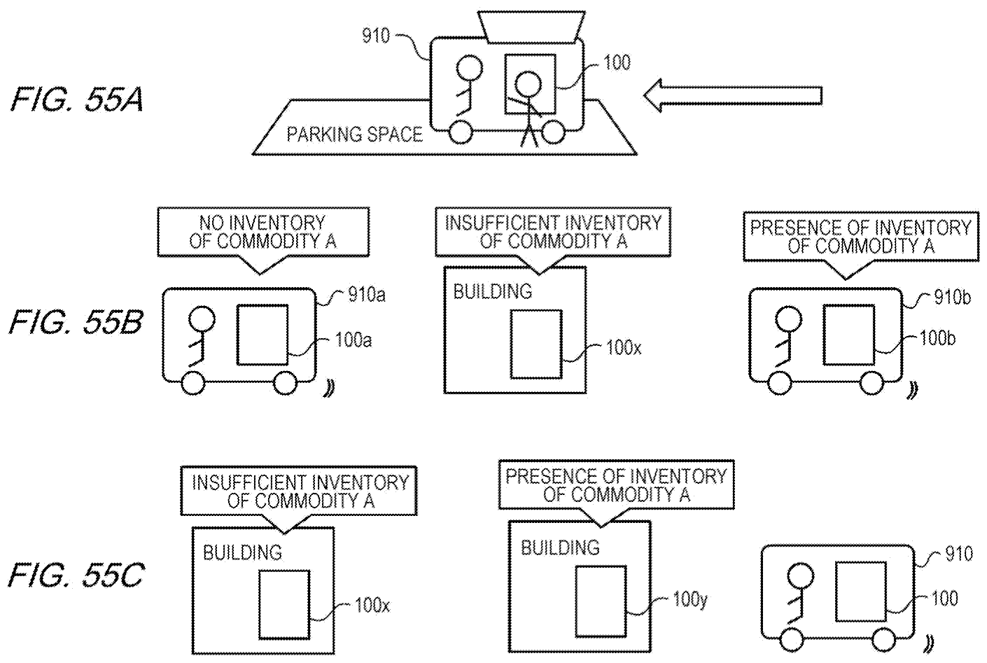

FIG. 55 is a diagram illustrating an example of utilization of the storage-equipped vehicle 910 in Modification 14. FIG. 55A is a diagram illustrating a state in which a vehicle stops and a commodity is delivered.

A worker can stop the storage-equipped vehicle 910 in a safe parking space and allows the user 122 to pull out the commodities in the storage device 100. At this time, since there is no work of delivering the commodity by the worker, the worker may remain sitting in the driver's seat. Therefore, the worker can pay attention to the surrounding traffic conditions or safety.

FIG. 55B is a diagram illustrating a state in which the commodity is supplied to a stationary storage device 100.

If the worker determines that an inventory of a commodity A is insufficient in a stationary storage device 100x installed in a certain building, or the inventory management unit of the server 400 is automatically determined, in the inventory management unit of the server 400, the inventory state of the insufficient commodity A is investigated. In this example, the inventory management unit determines that the mobile storage device 100b near the storage device 100x having the insufficient inventory has the commodity A. Then, the inventory management unit transmits an instruction to the mobile storage device 100b to go to the storage device 100x and replenish the commodity A. Note that the storage device 100a in the drawing does not have the insufficient commodity A, and therefore is not the target of the instruction.

FIG. 55C is a diagram illustrating a state in which the commodity 104 is moved between the stationary storage devices 100.

Similar to the case of FIG. 55B, if the worker determines that an inventory of a commodity A is insufficient in a stationary storage device 100x installed in a certain building, or if the inventory management unit of the server 400 is automatically determined, in the inventory management unit of the server 400, the inventory state of the insufficient commodity A is investigated. In this example, the inventory management unit determines that a stationary storage device 100y near the storage device 100x having the insufficient inventory has the commodity A. Then, the inventory management unit transmits an instruction to the mobile storage device 100 near the storage device 100y to go to the storage device 100y to collect the commodity A and go to the storage device 100x to replenish the commodity A.

In addition, the inventory shortage in the mobile storage device 100 may be determined, and the storage device 100 or another mobile storage device 100 may be instructed to take action.

In the storage arrangement screen illustrated in FIG. 10, the moving position of the mobile storage device 100 may be followed and displayed. In addition, for the mobile storage device 100, commodities may be purchased by the method described as the embodiment or Modification. For the mobile storage device 100, the commodity purchase screen illustrated in FIG. 12 may be displayed.

In this way, the inventory management unit may perform an instruction to manage the inventory of articles housed in the stationary and mobile storage device 100, determine the inventory shortage, and replenish the commodity. Focusing on the aspect of the inventory management, the storage-equipped vehicle 910 may be provided with a GPS device and a mobile wireless communication device.

Although the example of the storage device 100 is illustrated here, Modification 14 may be applied to other storage bodies (for example, a storage room, an unmanned store, a manned store, or the like).

[Modification 15]

The storage device 100 may be shared by a plurality of traders so that the commodity 104 handled by each trader can be installed in the same storage device 100. That is, the commodity housing space in the storage device 100 may be rented to a trader. In this example, it is assumed that rental reservations are accepted from each trader on a daily basis in a shelf unit. The trader that rents the space is not limited to a retail trader, but may be a wholesale trader, a manufacturing trader, or the like.

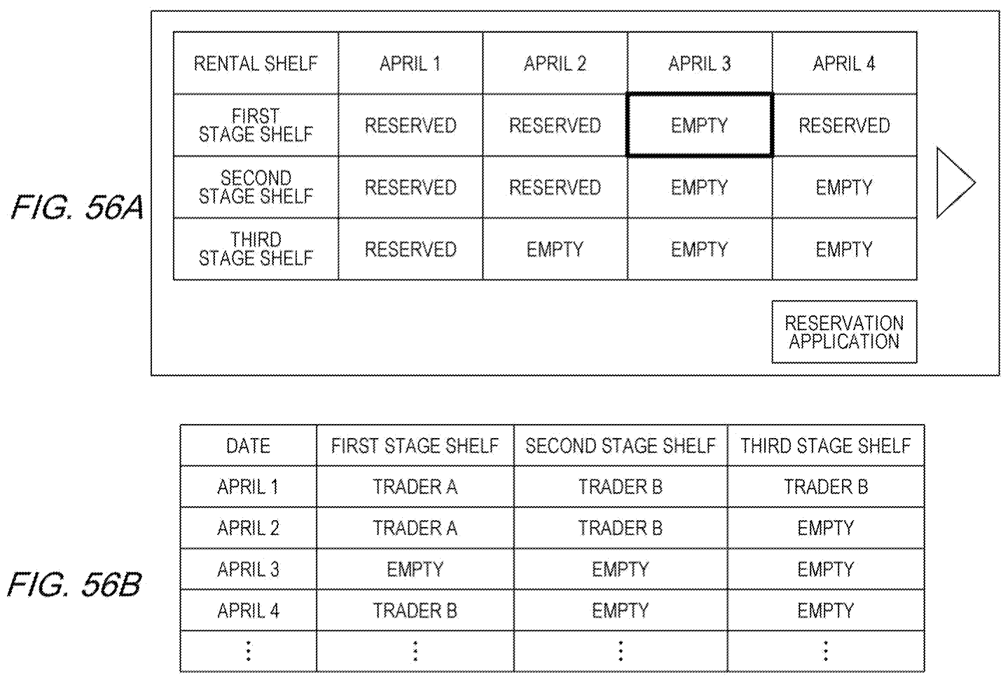

FIG. 56A is a diagram illustrating a reservation application screen of a rental shelf.

In this example, it is assumed that the space to be rented is a shelf unit. The reservation application screen displays a reservation frame specified by a combination of rental shelf and date. “Reserved” is displayed in a reservation frame for which reservation is determined by any of the traders. “Empty” is displayed in the reservation frame for which the reservation has not been determined yet. The operator of the trader himself accesses the server 400 from the terminal, displays the reservation application screen of the rental shelf, and touches the desired “empty” reservation frame. A thick line frame is displayed in the selected “empty” reservation frame. A plurality of “empty” reservation frames may be selected. In this state, when the operator of the trader touches the reservation application button, the rental of the selected “empty” reservation frame is reserved. The trader can use its shelf on the date of the reserved reservation frame.

FIG. 56B is a data structure diagram of a rental shelf reservation table.

The rental shelf reservation table has records for each date. The record has a field for setting the trader ID for each shelf to be rented. The initial value of the field is “empty”. When the reservation is accepted, the trader ID of the reserved trader is set in the field corresponding to the reservation frame.

The server 400 has a rental shelf reservation table memory unit that stores a rental shelf reservation table. In addition, the server 400 has the screen data transmitting unit 462 that transmits the data of the reservation application screen of the rental shelf to the terminal of the trader, and a reservation receiving unit that receives reservation application designating the reservation frame (date and rental shelf) from the trader terminal and sets the trader ID of the applied trader in the field corresponding to the reservation frame of the rental shelf reservation table, and a billing unit that calculates a rental fee according to the number of reserved reservation frames and charges a trader as a user. The rental fee is calculated by multiplying the reserved reservation frame by a rental unit price per frame, for example. Note that the reservation receiving unit and the unit are part of the rental management unit that manages the rental of the storage space of the storage device 100.

The rental unit price may be determined by an auction. In that case, the server 400 has a borrowing price receiving unit that accepts the presentation of a borrowing price from the terminal of the trader. Then, when the reservation receiving unit receives reservation applications from a plurality of traders for the same reservation frame, the reservation reception unit makes a reservation for the trader with the highest borrowed price offered. In addition, the billing unit charges the trader as the user, with the borrowing price presented by the trader.

Although the example of the storage device 100 is illustrated here, Modification 15 may be applied to other storage bodies (for example, a storage room, an unmanned store, a manned store, or the like).

[Modification 16]

As the mode in which the storage device 100 is shared by the plurality of traders, the vacant storage space at the time of applying for use may be rented out to the trader regardless of reservation.

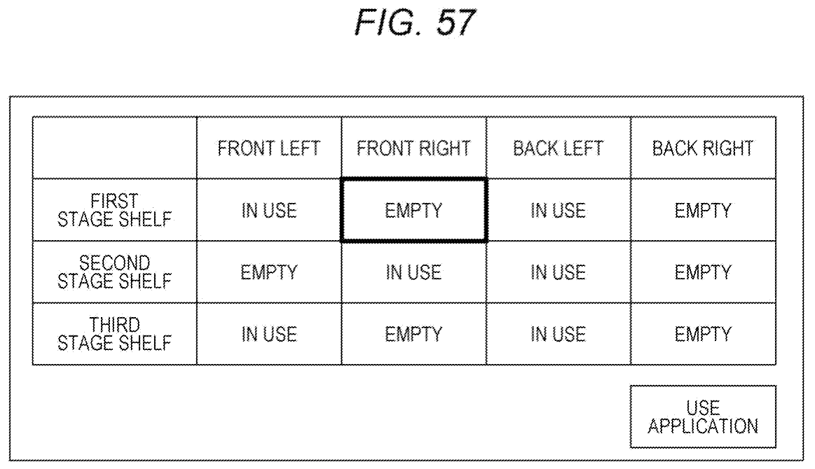

FIG. 57 is diagram illustrating a use application screen of a rental area.

In this example, it is assumed that the space to be rented is 900 units in each area of each shelf. This unit is called a rental area. In this example, it is assumed that one shelf has four rental areas. The reservation application screen displays a usage frame specified by the shelf and area 900. The usage frame used by one of the traders is displayed as “in use”. The usage frame not used by one of the traders is displayed as “empty”. The operator of the trader himself accesses the server 400 from the terminal, displays the use application screen of the rental area, and touches the desired “empty” usage frame. A thick line frame is displayed in the selected “empty” usage frame. A plurality of “empty” usage frames may be selected. In this state, when the operator of the trader touches the use application button, the rental area specified by the selected “empty” usage frame is started to be used. The trader can use this rental area from that point and can freely install commodities.

The rental fee is determined according to the usage time. For example, if a rental rate per minute is set, the rental fee is charged by multiplying the used fraction (usage time) by the rental rate. To calculate the usage time of the trader in each rental area, the server 400 records the use history of the rental area.

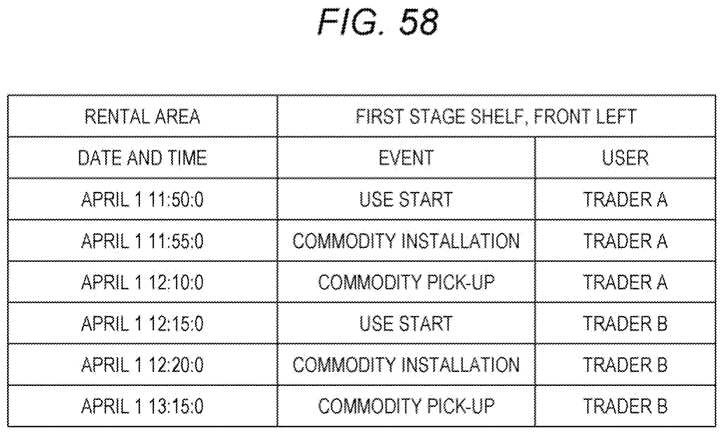

FIG. 58 is a data structure diagram of the use history of the rental area.

The use history is provided for each rental area. A record is provided each time an event occurs. The record associates the date and time, the event, and the user's trader ID.

The types of events are “use start”, “commodity installation”, and “commodity collection”. When the trader performs the use application, a record of the “use start” event is added, and the date and time when the use of the rental area is applied and the trader ID as the user are recorded.

When a commodity is installed in a rental area by trader, a record of the “commodity installation” event is added, and the date and time when the commodity was installed and the same trader ID as the “use start” are recorded as the user.

When a commodity is collected from the rental area by a user 122 or a trader, a record of the “commodity collection” event is added, and the date and time when the commodity was collected and the same trader ID as the “use start” are recorded as the user. If the user 122 takes over the commodity and purchases the commodity, then the use of the rental area ends at that point. Also, even if the trader suspends sales and collects the commodity itself, the use of the rental area ends at that point. That is, the usage time is calculated by subtracting the date and time of the “use start” from the date and time of the “commodity collection”.

The computer 200 has a commodity arrangement table memory unit that stores the commodity arrangement table (FIG. 50) described in Modification 11, an arrangement detection unit that specifies the arrangement (shelf ID and area ID) of the housed commodities, and an event transmitting unit that transmits the “commodity installation” event and the “commodity collection” event to the server 400.

The processing of the storage device 100 will be described. At the same timing as S270 illustrated in FIG. 3, the commodity detection unit 244 of the computer 200 sets the commodity arrangement detected in the storage device 100 to be the commodity arrangement table (FIG. 50). In S22, when the commodity 104 is installed, the commodity detection unit 244 also specifies the rental area (shelf ID and area ID) where the commodity 104 is installed, as well as the newly housed commodity 104. Then, the event transmitting unit transmits the “commodity installation” event to which the rental area (shelf ID and area ID) in which the commodity 104 is installed is added to the server 400. In addition, when the commodity 104 is collected, the commodity detection unit 244 also specifies the rental area (shelf ID and area ID) where the commodity was installed, along with the commodity 104 that was collected. Then, the event transmitting unit transmits the “commodity collection” event to which the rental area (shelf ID and area ID) in which the commodity 104 is installed is added to the server 400.

The processing of the server 400 will be described. The server 400 has the use history memory unit that stores the use history of the rental area. In addition, the server 400 includes the screen data transmitting unit 462 that transmits the use application screen data of the rental area to the terminal of the trader, a use application receiving unit that receives use application to which the rental area (shelf ID and area ID) corresponding to the usage frame is applied from the terminal of the trader and adds the record of the “use start” to the use history, an event receiving unit that adds the record of the “commodity collection” to the use history when the “commodity installation” event is received from the storage device 100, and adds the record of the “commodity collection” to the use history when the “commodity collection” event is received, and billing unit that calculates a rental fee according to the use time and charges a trader as a user Note that the use application receiving unit, the event receiving unit, and the billing unit are part of the rental management unit that manages the rental of the housing space of the storage device 100.

The rental rate may be determined by the auction. In that case, the server 400 has a borrowing rate receiving unit that accepts the presentation of the borrowing rate from the terminal of the trader. Then, when the use application receiving unit receives use applications from a plurality of traders for the same usage frame within a predetermined period, the use of the trader with the highest borrowing rate presented is approved. Then, when the trader to be used is determined, the “use start” event is generated. In addition, the billing unit charges the trader as the user the rental fee obtained by multiplying the borrowing rate presented by the trader by the usage time.

Although the example of the storage device 100 is illustrated here, Modification 16 may be applied to other storage bodies (for example, a storage room, an unmanned store, a manned store, or the like).

[Other Modifications]

For the authentication of the electronic ticket, the reservation or purchase may not be a condition. On the condition that the member is registered in advance, the lock may be unlocked when the electronic ticket that can specify the member is read.

A surveillance camera may be installed near the storage device 100 to perform recording. The recording may be analyzed to specify an illegal and illegal contents.

The storage device 100 may be used as a delivery box. A delivery man of the transport trader opens the storage device 100 with the delivery man's ticket to store luggage. A luggage recipient opens the storage device 100 with his/her ticket and pulls out the luggage. When the storage device 100 is shared by a plurality of people, a warning may be issued when luggage addressed to another person is taken out. Further, when the luggage recipient receives the notification of arrival of luggage from the server 100 and notifies the receipt is announced to the server 100, the ticket for receipt may be given.

In addition, a human may be allowed to enter the storage device 100.

The door 102 of the storage device 100 may be a sliding door type.

A display that displays an operation guidance and a warning message may be provided. The warning output unit 232 may display the warning message on the display.

An operation guidance unit may be provided to emit an operation guidance message from the speaker 116 or to display the operation guidance message on the display.

The electronic ticket may be electronic data transmitted by short-range radio. The ticket reader 114 may be a near field radio receiving device.

A commodity QR code may be used instead of the commodity barcode 118. Moreover, an IC tag may be used. When using the IC tag, the commodity tag code is read from the IC tag by the tag reader provided in the storage device 100.

The clerk ticket may be a paper ticket given to the clerk. Alternatively, the clerk ticket may be a QR code printed on a clerk ID card.

When it is determined that a shortage has occurred by referring to the in-storage commodity list or the store inventory list, the combination of the recommended commodity 104 or the commodity 104 stored in the storage device 100 may be automatically adjusted.

The present invention is not limited to the above-described embodiments or Modifications, and the components can be modified and embodied without departing from the gist. Various inventions may be formed by appropriately combining a plurality of components disclosed in the above-described embodiments or Modifications. In addition, some components may be deleted from all the components disclosed in the above-described embodiments or Modifications.

### REFERENCE SIGNS LIST

100 Storage device
102 Door
104 Commodity
106 Opening/closing sensor
108 Lock mechanism
110 Camera
112 Temperature adjusting device
114 Ticket reader
116 Speaker
118 Commodity barcode
120 Clerk
122 User
200 Computer
210 User interface processing unit
220 Input unit
222 Ticket reading unit
230 Output unit
232 Warning output unit
240 Data processing unit
242 Ticket authentication unit
244 Commodity detection unit
246 Lock control unit
248 Opening/closing detection unit
250 Communication unit
252 Ticket list management unit
260 Transmitting unit
262 Storage notification transmitting unit
264 Take-out notification transmitting unit
270 Receiving unit
272 Ticket receiving unit
274 Approval/disapproval notification receiving unit
280 Data storage unit
282 Ticket list memory unit
300 User terminal
310 User interface processing unit
320 Input unit
322 Operation receiving unit
330 Output unit
332 Ticket output unit
334 Image output unit
340 Data processing unit
342 Position detection unit
350 Communication unit
360 Transmitting unit
362 Request transmitting unit
364 Position transmitting unit
366 Account information transmitting unit
370 Receiving unit
372 Screen data receiving unit
374 Ticket receiving unit
380 Data storage unit
382 Ticket memory unit
384 Account information memory unit
400 Server
410 User interface processing unit
420 Input unit
430 Output unit
440 Data processing unit
442 Commodity list management unit
443 User authentication unit
444 Screen data generation unit
445 Storage selection unit
446 Ticket generation unit
448 Transaction management unit
449 Commodity verification unit
450 Communication unit
452 Reservation notification transmitting unit
460 Transmitting unit
462 Screen data transmitting unit
464 Ticket transmitting unit
466 Approval/disapproval notification transmitting unit
468 Reserving instruction transmitting unit
470 Receiving unit
472 Storage notification receiving unit
474 Request receiving unit
476 Take-out notification receiving unit
478 Position receiving unit
479 Account information receiving unit
480 Data storage unit
481 Store table memory unit
482 Commodity master table memory unit
483 Storage table memory unit
484 In-storage commodity list memory unit
485 User table memory unit
486 Ticket table memory unit
488 Sales table memory unit
490 Reservation table memory unit
500 Store system
600 Clerk terminal
610 User interface processing unit
620 Input unit
622 Operation receiving unit
630 Output unit
632 Ticket output unit
634 Reserving list output unit
640 Data processing unit
650 Communication unit
660 Transmitting unit
670 Receiving unit
672 Reserving list receiving unit
680 Data storage unit
682 Ticket memory unit
684 Reserving list memory unit
700 Store terminal
710 User interface processing unit
720 Input unit
730 Output unit
740 Data processing unit
742 Reserving list management unit
744 Transaction management unit
746 Commodity verification unit
748 Settlement unit
750 Communication unit
760 Transmitting unit
762 Reserving list transmitting unit
764 Approval/disapproval notification transmitting unit
770 Receiving unit
772 Reserving instruction receiving unit
774 Reservation notification receiving unit
776 Take-out notification receiving unit
780 Data storage unit
782 Reserving list memory unit
784 Reservation table memory unit
786 Sales table memory unit
800 Cash register
810 User interface processing unit
820 Input unit
822 Commodity input unit
824 Ticket reading unit
830 Output unit
832 Ticket output unit
840 Data processing unit
842 Settlement unit
844 Ticket generation unit
846 Ticket management unit
848 Commodity verification unit
850 Communication unit
860 Transmitting unit
862 Ticket transmitting unit
864 transmitting unit
870 Receiving unit
872 Take-out notification receiving unit
880 Data storage unit
882 Ticket table memory unit
900 Area
902 Light
910 Storage-equipped vehicle
912 GPS device
914 Mobile wireless communication device
916 Short-range wireless communication device
918 Headset
920 Monitor

1. An article housing system comprising: a storage body that houses articles and an information processing device that is connected to the storage body, wherein
the storage body includes
a notification unit that notifies the information processing device of link information of an article collected by a user and the user who has collected the article, and
the information processing device includes
a recording unit that records that the user collects the article from the storage body based on the link information and
a settlement unit that executes settlement processing of allowing a payer linked with the user to pay for the article.

2. The article housing system according to claim 1, wherein
the information processing device further includes a payment amount setting information receiving unit that receives the user who is a payee and payment amount setting information including payment amount from a terminal of the payer, and
the settlement unit executes the settlement processing within a range of the payment amount.

3. The article housing system according to claim 1, wherein
the information processing device further includes
a screen transmitting unit that transmits screen data including information on the storage body housing the article recommended by the payer to a user terminal.

4. The article housing system according to claim 1, wherein the settlement unit executes the settlement processing when the payer approves payment of a price of the article.

5. An article housing system comprising: a storage body that houses articles and an information processing device that is connected to the storage body, wherein
the storage body includes
a notification unit that notifies the information processing device of link information of an article collected by a user and the user who has collected the article, and
the information processing device includes
a recording unit that records that the user collects the article from the storage body based on the link information, and
the storage body further includes a lighting device that separately illuminates the housed articles.

6. The article housing system according to claim 5, wherein the lighting device illuminates an article pre-purchased or pre-reserved by the user.

7. The article housing system according to claim 5, wherein the lighting device illuminates an article pre-purchased or pre-reserved by a person other than the user.

8. An article housing system, comprising: a stationary storage body that houses articles, a mobile storage body that houses articles, and an information processing device that is connected to the stationary storage body and the mobile storage body, wherein
the stationary storage body and the mobile storage body include
a notification unit that notifies the information processing device of link information of an article collected by a user and the user who has collected the article, and
the information processing device includes
a recording unit that records that the user collects the article from the stationary storage body and collects the article from the mobile storage body based on the link information, and
an inventory management unit that manages an inventory of the article housed in the stationary storage body and an inventory of the article housed in the mobile storage body.

9. An article housing system comprising: a storage body that houses articles and an information processing device that is connected to the storage body, wherein
the storage body includes
a notification unit that notifies the information processing device of link information of an article collected by a user and the user who has collected the article, and
the information processing device includes
a recording unit that records that the user collects the article from the storage body based on the link information, and
a rental management unit that manages rental of an article housing space of the storage body.

10. The article housing system according to claim 2, wherein
the information processing device further includes
a screen transmitting unit that transmits screen data including information on the storage body housing the article recommended by the payer to a user terminal.
